(19) United States
(12) Patent Application Publication
(10) Pub. No.: US 2026/0289645 A1
(43) Pub. Date: Sep. 24, 2026

(54) Electronic Apparatus, Agent System, Program Thereof, Smart Glasses, Order Terminal, and Program Thereof

(71) Applicant: SOFTBANK GROUP CORP., Tokyo (JP)

(72) Inventor: Masayoshi Son, Minato-ku, Tokyo (JP)

(21) Appl. No.: 19/478,354

(22) PCT Filed: Apr. 22, 2024
(86) PCT No.: PCT/JP2024/015722

§ 371 Date: Oct. 24, 2025

(30) Foreign Application Priority Data
Apr. 27, 2023 (JP) 2023-073806
Aug. 24, 2023 (JP) 2023-136435
Sep. 20, 2023 (JP) 2023-152212
Sep. 27, 2023 (JP) 2023-165251
Oct. 6, 2023 (JP) 2023-174709
Oct. 12, 2023 (JP) 2023-176974
Oct. 13, 2023 (JP) 2023-177748
Oct. 27, 2023 (JP) 2023-184939
Oct. 30, 2023 (JP) 2023-185845
Oct. 30, 2023 (JP) 2023-185846
Nov. 13, 2023 (JP) 2023-193182
Nov. 16, 2023 (JP) 2023-195488
Dec. 19, 2023 (JP) 2023-214129
Dec. 28, 2023 (JP) 2023-223427

(51) Int. Cl. G06Q 30/0601; G02B 27/01; G06F 1/16; G06F 16/34; G06V 30/10; G10L 13/08; G10L 15/22

(52) U.S. Cl. CPC G06Q 30/06311; G02B 27/01; G06F 1/163; G06F 16/345; G06V 30/10; G10L 13/08; G10L 15/22; G02B 2027/0138

(57) ABSTRACT

Provided is an electronic apparatus capable of using an agent system that understands emotions of a user and the agent system and interacts with the user. An electronic apparatus, capable of using an agent system including an emotion determination unit that determines an emotion of a user or an emotion of an agent, and an interaction processing unit that determines speech content of the agent for interacting with the user on the basis of the emotion determined by the emotion determination unit, includes an acquisition unit capable of acquiring information regarding a state of the user, and an output unit capable of outputting the speech content generated in the agent system to the user, in which the emotion determination unit determines the emotion of the user on the basis of the state of the user obtained from the acquisition unit.

### TECHNICAL FIELD

The present invention relates to an electronic apparatus, an agent system, a program thereof, smart glasses, an order terminal, and a program thereof.

### BACKGROUND ART

Patent Literature 1 discloses a technique for determining an appropriate action of a robot with respect to a state of a user. In the related art of Patent Literature 1, a reaction of a user in a case in which the robot executes a specific action is recognized, and in a case in which an action of the robot with respect to the recognized reaction of the user cannot be determined, the action of the robot is updated by receiving information regarding an action suitable for the recognized state of the user from a server.

### PRIOR ART DOCUMENT

### Patent Literature

Patent Literature 1: Japanese Patent No. 6053847

### SUMMARY OF INVENTION

### Technical Problem

An object of the present disclosure is to provide an electronic apparatus, an agent system, a program thereof, smart glasses, an order terminal, and a program thereof capable of using an agent system that understands emotions of a user and the agent system and interacts with the user.

### Solution to Problem

An agent system related to a first aspect includes a reception unit that receives a budget of settlement means available for obtaining a product, a history acquisition unit that acquires history information that is information regarding an acquisition history in which a product acquired by a user in the past is recorded, a product determination unit that determines a product to be acquired on the basis of the budget received by the reception unit and the history information obtained from the history acquisition unit, and an operation execution unit that executes an operation of acquiring the product determined by the product determination unit at a predetermined timing.

In the agent system related to the first aspect, an agent system related to a second aspect further includes a user state recognition unit capable of acquiring information regarding a state of the user, and an emotion determination unit that determines an emotion of the user on the basis of the information regarding the state of the user acquired by the user state recognition unit, in which the history information includes an acquisition history in which a product acquired by the operation execution unit and an emotion of the user determined by the emotion determination unit for the product are recorded in association with each other.

In the agent system related to the second aspect, according to an agent system related to a third aspect, the emotion determination unit further determines an emotion of an agent on the basis of the state of the user acquired via the user state recognition unit, and the product determination unit determines a product to be acquired on the basis of the emotion of the agent determined by the emotion determination unit.

In the agent system related to the second aspect, according to an agent system related to a fourth aspect, the user state recognition unit further acquires information regarding a surrounding situation of the user, and the product determination unit determines a product to be acquired on the basis of the surrounding situation acquired by the user state recognition unit.

In the agent system related to the fourth aspect, according to an agent system related to a fifth aspect, the information regarding the surrounding situation is information regarding a stock for each product estimated from image information indicating the surrounding situation of the user, and the product determination unit determines a product to be acquired on the basis of the information regarding the stock.

In the agent system related to the fifth aspect, according to an agent system related to a sixth aspect, the operation execution unit executes an operation of acquiring the product at a timing at which the stock falls below a predetermined threshold continuously for a predetermined period.

In the agent system related to the second aspect, according to an agent system related to a seventh aspect, the reception unit further receives setting information of at least one of information regarding a category of a product or information regarding a preference of the user, and the product determination unit determines a product to be acquired on the basis of the setting information received by the reception unit.

A program related to an eighth aspect causes a computer to operate as the agent system related to any one of the first to seventh aspects.

An agent system related to a ninth aspect includes a reception unit that receives a keyword indicating a target desired by a user and a concept word indicating directionality of the keyword, a proposal determination unit that determines proposal information which is information to be proposed to the user on the basis of the keyword and the concept word received by the reception unit, a specifying unit that specifies a thing required by the user from the proposal information determined by the proposal determination unit, a user state recognition unit that acquires image information regarding a surrounding situation of the user, and a position output unit that outputs position information indicating a position of information regarding the thing in a case in which the image information acquired by the user state recognition unit includes the information regarding the thing specified by the specifying unit.

In the agent system related to the first aspect, according to an agent system related to a tenth aspect, the user state recognition unit is capable of acquiring information regarding a state of the user, the agent system further includes an emotion determination unit that determines an emotion of the user on the basis of the information regarding the state of the user acquired by the user state recognition unit, and a history acquisition unit that acquires history information that is information in which a past action of the user and an emotion of the user determined by the emotion determination unit when the action is performed are stored in association with each other, and the proposal determination unit determines the proposal information on the basis of the emotion of the user determined by the emotion determination unit and the history information acquired by the history acquisition unit.

A program related to an eleventh aspect causes a computer to operate as the agent system related to the first aspect or the second aspect.

An agent system related to a twelfth aspect includes a face information acquisition unit that acquires face information that is information regarding a face of a conversation partner of a user, a state recognition unit capable of acquiring information regarding a state of the conversation partner, an emotion determination unit that determines an emotion of the conversation partner on the basis of the information regarding the state of the conversation partner acquired by the state recognition unit, a published information acquisition unit that acquires published information regarding the conversation partner from information on the Internet including social media on the basis of the face information and the emotion of the conversation partner, a person information acquisition unit that acquires person information specifying the conversation partner from the published information, and an information output unit that outputs at least one of the emotion of the conversation partner, the published information, or the person information.

In the agent system related to the twelfth aspect, according to a thirteenth aspect, the person information acquisition unit acquires the person information from a database in which face information of a plurality of persons and person information for specifying each of the plurality of persons are stored in association with each other on the basis of the face information acquired by the face information acquisition unit.

In the agent system related to the twelfth aspect, according to an agent system related to a fourteenth aspect, the information output unit outputs a summary generated from a combination of at least two of the emotion of the conversation partner, the published information, and the person information.

In the agent system related to the twelfth aspect, according to an agent system related to a fifteenth aspect, the information output unit outputs conversation information that is generated on the basis of at least one of the emotion of the conversation partner, the published information, or the person information and is information for conversation with the conversation partner.

A program related to a sixteenth aspect causes a computer to operate as the above agent system.

Smart glasses related to a seventeenth aspect can use the above agent system.

According to an eighteenth aspect of the disclosure, an electronic apparatus is provided. The electronic apparatus is capable of using an agent system including an emotion determination unit that determines an emotion of a user or an emotion of an agent, and an interaction processing unit that determines speech content of the agent for interacting with the user on the basis of the emotion determined by the emotion determination unit, the electronic apparatus including an acquisition unit capable of acquiring information regarding a state of the user, an execution unit that causes the agent system to create a summary sentence for a letter string in a specific region that the user intends to read by the acquisition unit acquiring a preset prompt, and an output unit that outputs the summary sentence generated in the agent system to the user as the speech content. In the disclosure, the electronic apparatus is a wearable terminal worn by the user, an image of the specific region on a line of sight of the user is captured by a camera mounted on the wearable terminal, the letter string in the image of the specific region captured by the camera is converted into text data from which letters are recognizable, and the text data is sent to the acquisition unit. In the disclosure, the specific region is a double spread region of a book gripped by the user, and the summary sentence is created and spoken with the double spread region as a unit. In the disclosure, a summary sentence of a plurality of units for each of double spread pages is created by determining whether or not page turning of the book is performed, and the summary sentence is output in synchronization with the page turning.

According to a nineteenth aspect of the disclosure, an electronic apparatus is provided. The electronic apparatus is capable of using an agent system including an emotion determination unit that determines an emotion of a user or an emotion of an agent, and an interaction processing unit that determines speech content of the agent for interacting with the user on the basis of the emotion determined by the emotion determination unit, the electronic apparatus including an acquisition unit capable of acquiring information regarding a state of the user, an execution unit that causes the agent system to create a sentence that changes an emotion of the user related to a specific event to positive by the acquisition unit acquiring a predefined prompt when the emotion determination unit analyzes that the emotion of the user related to the specific event is negative, and an output unit that outputs the sentence generated in the agent system to the user as the speech content. In this case, the determination of the emotion of the user may be repeated until the emotion of the user changes from negative to positive. The electronic apparatus may be applied to determination of the emotion of the user on the basis of sensor information from which an action range of the user is detected in synchronization with an action of the user. The electronic apparatus may be a wearable terminal worn by the user, and may aggregate the sensor information in the action range along a line of sight of the user on the basis of a sensor mounted on the wearable terminal. The sensor may be a camera mounted on the wearable terminal, and the sensor information may be an image in the action range of the user captured by the camera. The sensor may be a microphone mounted on the wearable terminal, and the sensor information may be environmental sound in the action range of the user recorded by the microphone.

According to a twentieth aspect of the disclosure, an electronic apparatus is provided. The electronic apparatus is capable of using an agent system including an emotion determination unit that determines an emotion of a user or an emotion of an agent, and an interaction processing unit that determines speech content of the agent for interacting with the user on the basis of the emotion determined by the emotion determination unit, the electronic apparatus including an acquisition unit capable of acquiring information regarding a state of the user, a determination unit that determines whether or not a specific action of an action history target has been achieved on the basis of an action history of the action history target, an execution unit that causes the agent system to generate a sentence regarding the specific action on the basis of a determination result of the determination unit regarding the specific action in a case in which there is an instruction to determine whether or not the specific action has been achieved from the user, and an output unit that outputs the sentence generated in the agent system to the user as the speech content. In this case, the electronic apparatus may further include a storage unit that stores action history images captured in time series following an action of the action history target, and the determination unit may determine whether or not the specific action has been achieved on the basis of the action history images stored in the storage unit. A relationship in which the user is an administrator or a guardian and the action history target is a managed person or a protected person may be established between the user and the action history target. The relationship between the user and the action history target may be a relationship between a parent and a child under protection of the parent, and the specific action may be selected from actions registered in advance as a ToDo list of the child.

According to a twenty-first aspect of the disclosure, an agent system is provided. The agent system includes an emotion determination unit that determines an emotion of a user or an emotion of an agent, an interaction processing unit that determines speech content of the agent for interacting with the user on the basis of the emotion determined by the emotion determination unit, a generation unit that generates a sentence for giving an instruction for an action corresponding to a sudden change in an emotion in a case in which the emotion of the user or the emotion of the agent related to a specific event shows the sudden change exceeding a predefined change degree, and an execution unit that executes the action corresponding to the sudden change on the user between an action before the emotion change and an action after the emotion change on the basis of the generated sentence. In this case, the action corresponding to the sudden change in the emotion may be executed by combining at least one sense of hearing, vision, touch, smell, or taste, or two or more senses. The execution unit may adjust a degree of emphasis of the action corresponding to the sudden change in the emotion in proportion to a degree of the sudden change in the emotion. The emotion may be classified into happiness, anger, sadness, and pleasure, and the execution unit may vary an action according to emotions before and after a change in the emotion. In the disclosure, in a case in which the user feels intimidated or scared, the execution unit may execute an action corresponding to a change in the emotion that alleviates intimidation or scare. In a case in which the user is delighted, the execution unit may execute an action corresponding to a sudden change in the emotion that promotes and excites delight.

According to a twenty-second aspect of the disclosure, an agent system is provided. The agent system includes plurality of agents each including an acquisition unit that acquires information regarding a state of a user, an emotion determination unit that determines an emotion of the user on the basis of the information regarding the state of the user acquired by the acquisition unit, and an interaction processing unit that determines speech content of an agent for interacting with the user on the basis of the emotion determined by the emotion determination unit, and an arbitration unit that is mounted on at least one of the agents and that determines one piece of speech content in a case in which the speech content differs among the plurality of agents when the speech content is requested for the emotion of the user. In this case, the acquisition unit may be capable of acquiring vocal sound information output by the user or text information created by the user, and the speech content may be generated by using a sentence generation model that generates a sentence for answering to the vocal sound information or the text information input via the acquisition unit. The arbitration unit may determine any one of a plurality of pieces of new speech content on the basis of a history of which agent's speech content has been determined in the past. Each of the plurality of agents may be mounted on a wearable device that can be worn by the user.

An order terminal related to a twenty-third aspect includes a reception unit that receives order information indicating an order of a product from a user, an input unit that inputs the order information received by the reception unit to a sentence generation model, a presentation unit that presents check information for checking the order information output from the sentence generation model to the user, and an order placement unit that places an order for a product in accordance with an answer of the user to the check information.

In the order terminal related to the twenty-third aspect, an order terminal related to a twenty-fourth aspect further includes an acquisition unit capable of acquiring information regarding a state of the user, an emotion determination unit that determines an emotion of the user on the basis of the information regarding the state of the user acquired by the acquisition unit, and a conversation processing unit that determines speech content of an agent who has a conversation with the user on the basis of the emotion determined by the emotion determination unit, in which the conversation processing unit determines the speech content on the basis of the check information, and the presentation unit presents the product indicated by the order information to the user according to the speech content determined on the basis of the check information.

In the order terminal related to the twenty-fourth aspect, according to an order terminal related to a twenty-fifth aspect, the conversation processing unit determines, as the speech content, a product proposal for the user based on the emotion of the user determined by the emotion determination unit.

In the order terminal related to the twenty-fourth aspect, according to an order terminal related to a twenty-sixth aspect, the acquisition unit acquires consumption information regarding consumption of a product ordered by the user, and the conversation processing unit determines a proposal of a product for the user based on the consumption information acquired by the acquisition unit as the speech content.

In the order terminal related to the twenty-fourth aspect, according to an order terminal related to a twenty-seventh aspect, the reception unit receives the order information from a plurality of the users at a time, and the presentation unit presents the check information in which the order information from a plurality of the users received by the reception unit is aggregated to the user.

In the order terminal related to the twenty-fourth aspect, according to an order terminal related to a twenty-eighth aspect, the acquisition unit acquires configuration information regarding configurations of a plurality of the users, and the conversation processing unit determines, as the speech content, a proposal of a product for the plurality of the users based on the configuration information acquired by the acquisition unit.

A program related to a twenty-ninth aspect causes a computer to operate as the order terminal according to any one of the first to sixth aspects.

According to a thirtieth aspect of the disclosure, an electronic apparatus is provided. The electronic apparatus is capable of using an agent system including an emotion determination unit that determines an emotion of a user or an emotion of an agent, and an interaction processing unit that determines speech content of the agent for interacting with the user on the basis of the emotion determined by the emotion determination unit, the electronic apparatus including an acquisition unit that acquires at least one of information regarding a state of the user or input of vocal sound including instruction information of the user, and an output unit that outputs the speech content generated in the agent system to the user, in which the emotion determination unit determines the emotion of the user on the basis of the state of the user obtained from the acquisition unit, and the interaction processing unit performs setting on the basis of the instruction information of the user.

According to a thirty-first aspect of the disclosure, an electronic apparatus is provided. The electronic apparatus is capable of using an agent system including an emotion determination unit that determines an emotion of a user or an emotion of an agent, and an interaction processing unit that determines speech content of the agent for interacting with the user on the basis of the emotion determined by the emotion determination unit, the electronic apparatus including an acquisition unit capable of acquiring information regarding a state of the user, and an output unit capable of outputting the speech content generated in the agent system to the user, in which the output unit outputs speech information to another electronic apparatus capable of communicating with a computer network in a case in which communication with the computer network is disabled, and the acquisition unit acquires response information corresponding to the speech information from the another electronic apparatus.

According to a thirty-second aspect of the disclosure, an electronic apparatus is provided. The electronic apparatus is capable of using an agent system including an emotion determination unit that determines an emotion of a user or an emotion of an agent, and an interaction processing unit that determines speech content of the agent for interacting with the user on the basis of the emotion determined by the emotion determination unit, the electronic apparatus including an acquisition unit capable of acquiring information regarding a state of the user, and an output unit capable of outputting the speech content generated in the agent system to the user. The acquisition unit acquires a state of another user from another agent system, and the output unit outputs an emotion of the another user determined by the emotion determination unit on the basis of the state of the another user as the speech content of the agent.

### BRIEF DESCRIPTION OF DRAWINGS

FIG. 1 schematically illustrates an example of a system 5 according to a first embodiment.

FIG. 2 is a diagram schematically illustrating an example of a functional configuration of a robot 100 according to the first embodiment.

FIG. 3 schematically illustrates an example of an operation flow in the robot 100 according to the first embodiment.

FIG. 4 schematically illustrates an example of a hardware configuration of a computer 1200 according to the first embodiment.

FIG. 5 illustrates an emotion map on which a plurality of emotions are mapped according to the first embodiment.

FIG. 6 illustrates an emotion map on which a plurality of emotions are mapped according to the first embodiment.

FIG. 7 schematically illustrates a functional configuration of an agent system according to the first embodiment.

FIG. 8 illustrates an example of an operation of the agent system according to the first embodiment.

FIG. 9 illustrates an example of an operation of the agent system according to the first embodiment.

FIG. 10 schematically illustrates an example of a hardware configuration of smart glasses according to the first embodiment.

FIG. 11 illustrates an example of a usage aspect of the agent system by the smart glasses according to the first embodiment.

FIG. 12 schematically illustrates an example of a hardware configuration of a smart pendant according to the first embodiment.

FIG. 13 is a diagram schematically illustrating an example of a functional configuration of an agent system according to a second embodiment.

FIG. 14 is a flowchart illustrating an example of a flow of product determination processing of determining an article to be purchased by the agent system according to the second embodiment.

FIG. 15 is a flowchart illustrating an example of a flow of product acquisition processing in which the agent system according to the second embodiment purchases an article.

FIG. 16 is a flowchart illustrating an example of a flow of acquisition determination processing in which the agent system according to Modification 1 of the second embodiment determines whether or not to purchase an article.

FIG. 17 is a flowchart illustrating an example of a flow of product determination processing in which the agent system according to Modification 2 of the second embodiment determines a service to be contracted.

FIG. 18 is a diagram schematically illustrating an example of a functional configuration of an agent system according to a third embodiment.

FIG. 19 is a flowchart illustrating an example of a flow of output processing in which the agent system according to the third embodiment outputs information regarding a position of a necessary object.

FIG. 20 is a flowchart illustrating an example of a flow of proposal determination processing of determining a proposal by using a sentence generation model according to the third embodiment.

FIG. 21 is a flowchart illustrating an example of a flow of proposal determination processing of determining a proposal by using a sentence generation model according to a modification of the third embodiment.

FIG. 22 schematically illustrates an example of a functional configuration of an agent system according to a fourth embodiment.

FIG. 23 is a flowchart illustrating an example of a flow of partner information output processing according to the fourth embodiment.

FIG. 24 is a flowchart illustrating an example of a flow of emotion acquisition processing according to the fourth embodiment.

FIG. 25 schematically illustrates an example of a storage unit according to Modification 1 of the fourth embodiment.

FIG. 26 schematically illustrates an example of a person information DB according to Modification 1 of the fourth embodiment.

FIG. 27 is a flowchart illustrating an example of a flow of partner information output processing according to Modification 1 of the fourth embodiment.

FIG. 28 is a flowchart illustrating an example of a flow of summary output processing according to Modification 2 of the fourth embodiment.

FIG. 29 is a flowchart illustrating an example of a flow of conversation information output processing according to Modification 3 of the fourth embodiment.

FIG. 30 is a flowchart illustrating an example of a flow of partner information output processing according to Modification 4 of the fourth embodiment.

FIG. 31 is a perspective view illustrating an example of fast reading of a book in a fast reading application using smart glasses in a fifth embodiment, in which (A) illustrates a case in which a fast reading result is output from a speaker of the smart glasses, and (B) illustrates a case in which the fast reading result is output from a speaker of another electronic apparatus which has received the fast reading result through communication.

FIG. 32 is a control flowchart for executing a fast reading application using smart glasses in a fifth embodiment.

FIG. 33 is a front view of an image regarding a specific event (cleaning) captured by a camera of smart glasses in a sixth embodiment.

FIG. 34 is a control flowchart illustrating a flow of processing of an emotion positivity application executed by a control device of the smart glasses in the sixth embodiment.

FIG. 35 is a front view of a group of images (images) captured in time series by a camera managed and controlled by an agent system for action history determination of an action history target designated by a user in a seventh embodiment.

FIG. 36 is a control flowchart illustrating a flow of action history acquisition in processing of a ToDo management application executed by a control device of a robot in the seventh embodiment.

FIG. 37 is a control flowchart illustrating a flow of an interruption routine interrupted when an action history determination request is made during the action history acquisition in FIG. 36 in the seventh embodiment.

FIG. 38 schematically illustrates an example of a system 5 according to an eighth embodiment.

FIG. 39 is a flowchart for describing an operation of the system 5 according to the eighth embodiment.

FIG. 40 schematically illustrates an example of a system 5 according to a ninth embodiment.

FIG. 41 is a flowchart for describing an operation of the system 5 according to the ninth embodiment.

FIG. 42 schematically illustrates an example of a system 5 according to a tenth embodiment.

FIG. 43 is a flowchart for describing the operation of the system 5 according to the tenth embodiment.

FIG. 44 is a characteristic diagram illustrating intensity of each of emotions (“happy”, “angry”, “sad”, and “pleasant”) at regular time intervals in an eleventh embodiment.

FIG. 45 is a functional block diagram of an emotion sudden change determination unit that determines the presence or absence of a sudden change in emotion based on the characteristic diagram in FIG. 44.

FIG. 46 is a control flowchart illustrating a flow of action execution processing executed by an action control system (an action execution unit and an action control unit).

FIG. 47 is a schematic diagram illustrating an example of a hardware configuration of smart glasses and a smart pendant according to a twelfth embodiment.

FIG. 48(A) is a control flowchart illustrating a flow of user-corresponding processing executed by an arbitrating agent system mounted on the smart glasses, and FIG. 48(B) is a control flowchart illustrating a flow of user-corresponding processing executed by a non-arbitrating agent system mounted on the smart pendant.

FIG. 49 is a flowchart illustrating a specific example of user-corresponding processing executed in accordance with the flowchart in FIG. 48 in chronological order.

FIG. 50 schematically illustrates an example of a hardware configuration of an order terminal 3400 according to a thirteenth embodiment.

FIG. 51 schematically illustrates an example of a configuration of a storage 411 of the order terminal 3400 according to the thirteenth embodiment.

FIG. 52 schematically illustrates an example of a functional configuration of the order terminal 3400 according to the thirteenth embodiment.

FIG. 53 schematically illustrates an example of a flow of order placement processing according to the thirteenth embodiment.

FIG. 54 schematically illustrates an example of a flow of emotion determination processing according to the thirteenth embodiment.

FIG. 55 schematically illustrates an example of a flow of order placement processing according to Modification 1 of the thirteenth embodiment.

FIG. 56 schematically illustrates an example of a flow of order placement processing according to Modification 2 of the thirteenth embodiment.

FIG. 57 schematically illustrates an example of a flow of order placement processing according to Modification 3 of the thirteenth embodiment.

FIG. 58 schematically illustrates a functional configuration of an agent system according to a fourteenth embodiment.

FIG. 59 illustrates an example of an interaction of the agent system according to the fourteenth embodiment.

FIG. 60 illustrates an example of an interaction of the agent system according to the fourteenth embodiment.

FIG. 61 illustrates an example of an operation flow of an electronic apparatus of a user 60 according to the fourteenth embodiment.

FIG. 62 illustrates an example of an operation flow of another electronic apparatus according to the fourteenth embodiment.

FIG. 63 exemplifies an aspect in which an agent system 50 is provided for each of a plurality of users 60 in a case in which there are the plurality of users 60 in a fifteenth embodiment.

### DESCRIPTION OF EMBODIMENTS

Hereinafter, the disclosure will be described through embodiments of the invention, but the following embodiments do not limit the invention according to the claims. Not all combinations of features described in the embodiments are essential to the solution of the invention.

### First Embodiment

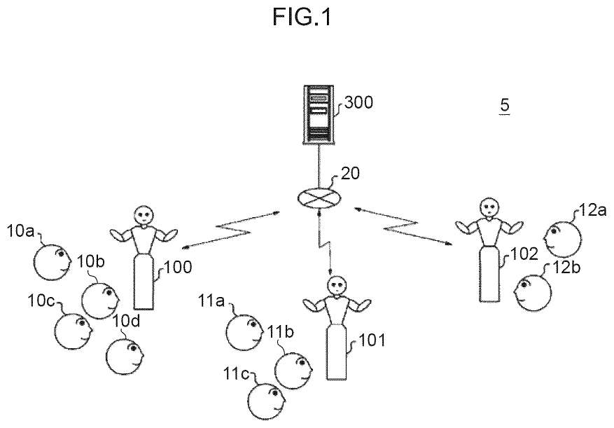

FIG. 1 schematically illustrates an example of a system 5 according to a first embodiment. The system 5 includes a robot 100, a robot 101, a robot 102, and a server 300. A user 10a, a user 10b, a user 10c, and a user 10d are users of the robot 100. The user 11a, the user 11b, and the user 11c are users of the robot 101. A user 12a and a user 12b are users of the robot 102. In the description of the present embodiment, the user 10a, the user 10b, the user 10c, and the user 10d may be collectively referred to as a user 10. The user 11a, the user 11b, and the user 11c may be collectively referred to as a user 11. The user 12a and the user 12b may be collectively referred to as a user 12. The robot 101 and the robot 102 have substantially the same functions as those of the robot 100. Therefore, the system 5 will be described focusing on the functions of the robot 100.

The robot 100 has a conversation with the user 10 and provides a video to the user 10. In this case, the robot 100 has a conversation with the user 10, provides a video to the user 10, and the like in cooperation with the server 300 and the like that can communicate via a communication network 20. For example, the robot 100 not only learns an appropriate conversation by itself, but also performs learning so that a conversation with the user 10 can be advanced more appropriately in cooperation with the server 300. The robot 100 causes the server 300 to record captured video data and the like of the user 10, requests the server 300 to transmit the video data and the like as necessary, and provides the video data and the like to the user 10.

The robot 100 has an emotion value indicating the type of its own emotion. For example, the robot 100 has emotion values indicating the intensities of respective emotions such as “happy”, “angry”, “sad”, “pleasant”, “pleased”, “displeased”, “safe”, “anxious”, “gloomy”, “excited”, “worried”, “relieved”, “sense of fulfilment”, “sense of emptiness”, and “normal”. For example, in a case in which the robot 100 has a conversation with the user 10 in a state in which the emotion value of excitement is great, the robot emits vocal sound at a fast speed. As described above, the robot 100 can express its own emotion by action.

The robot 100 may be configured to determine an action of the robot 100 corresponding to the emotion of the user 10 by matching a sentence generation model with an emotion engine. Specifically, the robot 100 may be configured to recognize an action of the user 10, determine an emotion of the user 10 for the action of the user, and determine an action of the robot 100 corresponding to the determined emotion.

More specifically, in a case in which the robot 100 recognizes the action of the user 10, the robot 100 automatically generates the action content to be taken by the robot with respect to the action of the user 10 by using the preset sentence generation model. The sentence generation model may be interpreted as an algorithm and an operation for automatic interaction processing using letters. Since the sentence generation model is known as disclosed in, for example, Japanese Patent Application Laid-Open (JP-A) No. 2018 081444 and chatGPT (Internet search <URL: https://openai.com/blog/chatgpt>), a detailed description thereof will be omitted. Such a sentence generation model is configured by a large language model (LLM).

As described above, in the present embodiment, it is possible to reflect the emotions of the user 10 and the robot 100 and various types of linguistic information in the action of the robot 100 by combining the large language model and the emotion engine. That is, according to the present embodiment, a synergistic effect can be obtained by combining the sentence generation model and the emotion engine.

The robot 100 has a function of recognizing an action of the user 10. The robot 100 recognizes the action of the user 10 by analyzing a face image of the user 10 acquired by a camera function and the vocal sound of the user 10 acquired by a microphone function. The robot 100 determines an action to be executed by the robot 100 on the basis of the recognized action of the user 10 or the like.

The robot 100 stores a rule defining an action to be executed by the robot 100 on the basis of the emotion of the user 10, the emotion of the robot 100, and the action of the user 10, and performs various actions according to the rule.

Specifically, the robot 100 has a reaction rule for determining an action of the robot 100 on the basis of the emotion of the user 10, the emotion of the robot 100, and the action of the user 10. In the reaction rule, for example, in a case in which the action of the user 10 is “smiling”, an action of “smiling” is set as the action of the robot 100. In the reaction rule, an action of “apologizing” is defined as an action of the robot 100, with respect to a case in which the action of the user 10 is “angry”. In the reaction rule, an action of “answering” is defined as an action of the robot 100 with respect to a case in which the action of the user 10 is “inquiry”. In the reaction rule, an action of “talking” is defined as an action of the robot 100 with respect to a case in which the action of the user 10 is “gloomy”.

In a case in which the robot 100 recognizes that the action of the user 10 is “angry” on the basis of the reaction rule, the robot selects an action of “apologizing” defined in the reaction rule as the action to be executed by the robot 100. For example, in the case of selecting the action of “apologizing”, the robot 100 performs an action of “apologizing” and outputs vocal sound expressing the word “apologizing”.

In a case in which a condition that the emotion of the robot 100 is “normal” (that is, “happy”=0, “angry”=0, “sad”=0, and “pleasant”=0) and the state of the user 10 is “one person, lonely” is satisfied, it is defined that the change content of the emotion that the emotion of the robot 100 is “worried” and the action of “talking” can be executed.

In a case in which the robot 100 recognizes that the current emotion of the robot 100 is “normal” and the user 10 is alone in a lonely state on the basis of the reaction rule, the emotion value of “sad” of the robot 100 is increased. The robot 100 selects the action of “talking” defined in the reaction rule as an action to be executed on the user 10. For example, in a case in which the action of “talking” is selected, the robot 100 converts a word “What's wrong?” indicating that the robot is concerned into vocal sound indicating that the robot is concerned, and outputs the vocal sound.

The robot 100 transmits, to the server 300, user reaction information indicating that a positive reaction has been obtained from the user 10 through this action. The user reaction information includes, for example, the user action of “angry”, the action of the robot 100 of “apologizing”, the positive reaction of the user 10, and an attribute of the user 10.

The server 300 stores the user reaction information received from the robot 100. The server 300 receives and stores the user reaction information not only from the robot 100 but also from each of the robot 101 and the robot 102. The server 300 analyzes the user reaction information from the robot 100, the robot 101, and the robot 102, and updates the reaction rule.

The robot 100 receives the updated reaction rule from the server 300 by inquiring the server 300 about the updated reaction rule. The robot 100 incorporates the updated reaction rule into the reaction rule stored in the robot 100. As a result, the robot 100 can incorporate the reaction rule acquired by the robot 101, the robot 102, or the like into its own reaction rule.

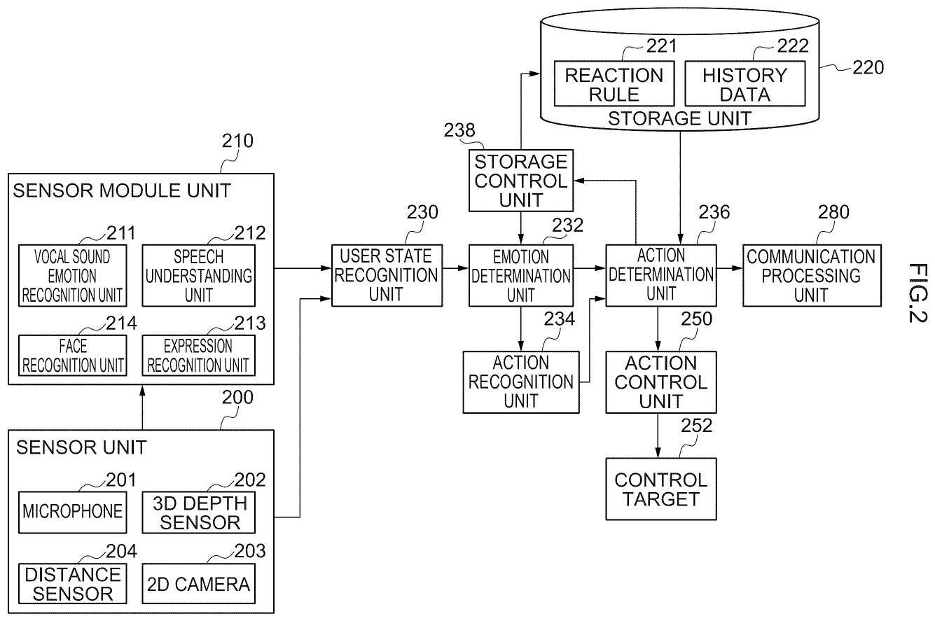

FIG. 2 schematically illustrates a functional configuration of the robot 100. The robot 100 includes a sensor unit 200, a sensor module unit 210, a storage unit 220, a user state recognition unit 230, an emotion determination unit 232, an action recognition unit 234, an action determination unit 236, a storage control unit 238, an action control unit 250, a control target 252, and a communication processing unit 280.

Examples of the control target 252 include a display device, a speaker, an LED of an eye portion, and motors that drive an arm, a hand, a foot, and the like. The posture and the action of the robot 100 are controlled by controlling motors for arms, hands, and feet. Some of the emotions of the robot 100 can be expressed by controlling these motors. The expression of the robot 100 can be expressed by controlling a light emission state of the LED of the eye portion of the robot 100. The posture, the gesture, and the expression of the robot 100 are examples of the attitude of the robot 100.

The sensor unit 200 includes a microphone 201, a 3D depth sensor 202, a 2D camera 203, and a distance sensor 204. The microphone 201 continuously detects vocal sound and outputs vocal sound data. The microphone 201 may be provided on the head of the robot 100 and may have a function of performing binaural recording. The 3D depth sensor 202 analyzes infrared patterns from infrared images continuously captured by an infrared camera by continuously applying the infrared patterns, and detects an outline of an object. The 2D camera 203 is an example of an image sensor. The 2D camera 203 captures an image with visible light and generates image information regarding visible light. The distance sensor 204 detects a distance to an object by emitting, for example, laser light or ultrasonic waves. The sensor unit 200 may further include a clock, a gyro sensor, a touch sensor, a sensor for motor feedback, and the like.

Among the constituents of the robot 100 illustrated in FIG. 2, the constituents other than the control target 252 and the sensor unit 200 are examples of the constituents included in the action control system included in the robot 100. The action control system of the robot 100 controls the control target 252.

The storage unit 220 includes a reaction rule 221 and history data 222. The history data 222 includes past emotion values and a history of actions of the user 10. The emotion values and the history of actions are recorded for each user 10 by being associated with identification information regarding the user 10, for example. At least a part of the storage unit 220 is implemented by a storage medium such as a memory. A person DB that stores a face image of the user 10, attribute information regarding the user 10, and the like may be included. Among the constituents of the robot 100 illustrated in FIG. 2, the functions of the constituents other than the control target 252, the sensor unit 200, and the storage unit 220 can be realized by a CPU operating on the basis of a program. For example, the functions of these constituents can be implemented as the operation of the CPU by basic software (OS) and a program operating on the OS.

The sensor module unit 210 includes a vocal sound emotion recognition unit 211, a speech understanding unit 212, an expression recognition unit 213, and a face recognition unit 214. Information detected by the sensor unit 200 is input to the sensor module unit 210. The sensor module unit 210 analyzes information detected by the sensor unit 200 and outputs an analysis result to the user state recognition unit 230.

The vocal sound emotion recognition unit 211 of the sensor module unit 210 analyzes the vocal sound of the user 10 detected by the microphone 201 to recognize the emotion of the user 10. For example, the vocal sound emotion recognition unit 211 extracts a feature amount such as a frequency component of the vocal sound and recognizes the emotion of the user 10 on the basis of the extracted feature amount. The speech understanding unit 212 analyzes the vocal sound of the user 10 detected by the microphone 201 and outputs letter information indicating the speech content of the user 10.

The expression recognition unit 213 recognizes the expression of the user 10 and the emotion of the user 10 from the image of the user 10 captured by the 2D camera 203. For example, the expression recognition unit 213 recognizes the expression and the emotion of the user 10 on the basis of the shapes, positional relationships, and the like of the eyes and the mouth.

The face recognition unit 214 recognizes the face of the user 10. The face recognition unit 214 recognizes the user 10 by matching a face image stored in a person DB (not illustrated) with a face image of the user 10 captured by the 2D camera 203.

The user state recognition unit 230 recognizes a state of the user 10 on the basis of the information analyzed by the sensor module unit 210. For example, processing mainly related to perception is performed by using the analysis result from the sensor module unit 210. For example, perception information such as “There is one father.” and “The probability that the father does not smile is 90%.” is generated. Processing of understanding the meaning of the generated perception information is performed. For example, semantic information such as “One father looks lonely.” is generated.

The emotion determination unit 232 determines an emotion value indicating the emotion of the user 10 on the basis of the information analyzed by the sensor module unit 210 and the state of the user 10 recognized by the user state recognition unit 230. For example, the information analyzed by the sensor module unit 210 and the recognized state of the user 10 are input to a neural network trained in advance, and an emotion value indicating the emotion of the user 10 is acquired.

Here, the emotion value indicating the emotion of the user 10 is a value indicating whether the emotion of the user is positive or negative. For example, in a case in which the emotion of the user is a bright emotion accompanied with pleasure or comfort, such as “happy”, “pleasant”, “pleased”, “safe”, “excited”, “relieved”, and “sense of fulfillment”, a positive value is indicated, and the value becomes larger as the emotion becomes brighter. In a case in which the emotion of the user is an emotion that makes the user feel unpleasant, such as “angry”, “sad”, “displeased”, “anxious”, “gloomy”, “worried”, and “sense of emptiness”, a negative value is indicated, and an absolute value of the negative value increases as the user feels unpleasant. In a case in which the emotion of the user is not included in any of the above emotions (“normal”), a value of 0 is indicated.

The emotion determination unit 232 determines an emotion value indicating the emotion of the robot 100 on the basis of the information analyzed by the sensor module unit 210 and the state of the user 10 recognized by the user state recognition unit 230. The emotion value of the robot 100 includes an emotion value for each of the plurality of emotion classifications, and is, for example, a value (0 to 5) indicating the intensity of each of “happy”, “angry”, “sad”, and “pleasant”.

Specifically, the emotion determination unit 232 determines an emotion value indicating the emotion of the robot 100 according to a rule for updating the emotion value of the robot 100, the rule being defined in association with the information analyzed by the sensor module unit 210 and the state of the user 10 recognized by the user state recognition unit 230.

For example, in a case in which the user state recognition unit 230 recognizes that the user 10 looks lonely, the emotion determination unit 232 increases the emotion value of “sad” of the robot 100. In a case in which the user state recognition unit 230 recognizes that the user 10 has a smiling face, the emotion value of “happy” of the robot 100 is increased.

The emotion determination unit 232 may determine the emotion value indicating the emotion of the robot 100 in further consideration of the state of the robot 100. For example, in a case in which a remaining battery level of the robot 100 is low or in a case in which the surrounding environment of the robot 100 is dark, the emotion value of “sad” of the robot 100 may be increased. In the case of the user 10 continuously talking to the robot even though the remaining battery level is low, the emotion value of “angry” may be increased.

The action recognition unit 234 recognizes an action of the user 10 on the basis of the information analyzed by the sensor module unit 210 and the state of the user 10 recognized by the user state recognition unit 230. For example, the information analyzed by the sensor module unit 210 and the recognized state of the user 10 are input to a neural network trained in advance, probabilities of a plurality of predetermined action classifications (for example, “smile”, “angry”, “ask a question”, and “gloomy”) are acquired, and an action classification having the highest probability is recognized as the action of the user 10.

As described above, in the present embodiment, the robot 100 acquires the speech content of the user 10 after identifying the user 10, but in acquiring and using the speech content, the action control system of the robot 100 according to the present embodiment considers protection of personal information and privacy of the user 10 in addition to acquiring necessary consent according to laws and regulations from the user 10.

The action determination unit 236 determines an action corresponding to the action of the user 10 recognized by the action recognition unit 234 on the basis of the current emotion value of the user 10 determined by the emotion determination unit 232, the history data 222 of the past emotion values determined by the emotion determination unit 232 before the current emotion value of the user 10 is determined, and the emotion value of the robot 100. In the present embodiment, a case in which the action determination unit 236 uses one most recent emotion value included in the history data 222 as the past emotion value of the user 10 will be described, but the disclosed technology is not limited to this aspect. For example, the action determination unit 236 may use a plurality of most recent emotion values as the past emotion values of the user 10, or may use emotion values that are earlier by a unit period such as one day before. The action determination unit 236 may determine an action corresponding to the action of the user 10 in further consideration of the history of the past emotion values of the robot 100 in addition to the current emotion value of the robot 100. The action determined by the action determination unit 236 includes a gesture performed by the robot 100 or speech content of the robot 100.

The action determination unit 236 according to the present embodiment determines the action of the robot 100 on the basis of a combination of the past emotion value and the current emotion value of the user 10, the emotion value of the robot 100, the action of the user 10, and the reaction rule 221, as an action corresponding to the action of the user 10. For example, in a case in which the past emotion value of the user 10 is a positive value and the current emotion value is a negative value, the action determination unit 236 determines an action for positively changing the emotion value of the user 10 as an action corresponding to the action of the user 10.

The reaction rule 221 defines an action of the robot 100 according to the combination of the past emotion value and the current emotion value of the user 10, the emotion value of the robot 100, and the action of the user 10. For example, in a case in which the past emotion value of the user 10 is a positive value, the current emotion value is a negative value, and the action of the user 10 is gloomy, a combination of a gesture and speech content at the time of making an inquiry to encourage the user 10 including a gesture is defined as the action of the robot 100.

For example, the reaction rule 221 defines an action of the robot 100 for all combinations of patterns of emotion values of the robot 100 (1296 patterns that is the fourth power of six values of the values “0” to “5” of “happy”, “angry”, “sad”, and “pleasant”), a pattern of the combination of the past emotion value and the current emotion value of the user 10, and an action pattern of the user 10. That is, for each pattern of the emotion value of the robot 100, the action of the robot 100 according to the action pattern of the user 10 is defined for each of a plurality of combinations such as combinations of the past emotion value and the current emotion value of the user 10 being a negative value and a negative value, a negative value and a positive value, a positive value and a negative value, a positive value and a positive value, a negative value and normal, and normal and normal. The action determination unit 236 may transition to an operation mode of determining the action of the robot 100 by using the history data 222, for example, in a case in which the user 10 has made speech that intends a conversation continued from a past topic such as “I want to talk about the topic I discussed earlier”.

In the reaction rule 221, at least one of a gesture and statement content may be defined as an action of the robot 100 for each pattern (1296 patterns) of the emotion values of the robot 100 at the maximum. Alternatively, in the reaction rule 221, at least one of a gesture and statement content may be defined as an action of the robot 100 for each of groups of the patterns of the emotion values of the robot 100.

The intensity of each gesture included in the action of the robot 100 defined in the reaction rule 221 is defined in advance. In each piece of speech content included in the action of the robot 100 defined in the reaction rule 221, the intensity of the speech content is defined in advance.

The storage control unit 238 determines whether or not to store data including the action of the user 10 in the history data 222 on the basis of the intensity of the action predefined for the action determined by the action determination unit 236 and the emotion value of the robot 100 determined by the emotion determination unit 232. Specifically, in a case in which a total value of the intensities that is a sum of a sum total of the emotion values for the plurality of respective emotion classifications of the robot 100, the intensity predefined for the gesture included in the action determined by the action determination unit 236, and the intensity predefined for the speech content included in the action determined by the action determination unit 236 is a threshold or more, it is determined to store data including the action of the user 10 in the history data 222.

In a case in which the storage control unit 238 determines to store the data including the action of the user 10 in the history data 222, the action determined by the action determination unit 236, information (for example, any surrounding information including data such as vocal sound, an image, and a smell at the place) analyzed by the sensor module unit 210 from the current time point to a certain period before, and a state (for example, the expression and the emotion of the user 10) of the user 10 recognized by the user state recognition unit 230 are stored in the history data 222.

The action control unit 250 controls the control target 252 on the basis of the action determined by the action determination unit 236. For example, in a case in which the action determination unit 236 determines an action including speech, the action control unit 250 causes a speaker included in the control target 252 to output vocal sound. In this case, the action control unit 250 may determine an emission speed of the vocal sound on the basis of the emotion value of the robot 100. For example, the action control unit 250 determines a higher vocal sound emission speed as the emotion value of the robot 100 becomes greater. As described above, the action control unit 250 determines an execution form of the action determined by the action determination unit 236 on the basis of the emotion value determined by the emotion determination unit 232.

The action control unit 250 may recognize a change in emotion of the user 10 with respect to execution of the action determined by the action determination unit 236. For example, the change in emotion may be recognized on the basis of the vocal sound or expression of the user 10. A change in the emotion of the user 10 may be recognized on the basis of detection of an impact by the touch sensor included in the sensor unit 200. In a case in which an impact is detected by the touch sensor included in the sensor unit 200, it may be recognized that the emotion of the user 10 is worsened, or in a case in which it is determined that the reaction of the user 10 is smiling or happy from the detection result in the touch sensor included in the sensor unit 200, it may be recognized that the emotion of the user 10 is improved. Information indicating the reaction of the user 10 is output to the communication processing unit 280.

After the action control unit 250 executes the action determined by the action determination unit 236 in the execution form determined according to the emotion of the robot 100, the emotion determination unit 232 further changes the emotion value of the robot 100 on the basis of the user's reaction to the execution of the action. Specifically, the emotion determination unit 232 increases the emotion value of “happy” of the robot 100 in a case in which the user's reaction to the action determined by the action determination unit 236 performed on the user in the execution form determined by the action control unit 250 is not bad, and the emotion determination unit 232 increases the emotion value of “sad” of the robot 100 in a case in which the user's reaction to the action determined by the action determination unit 236 performed on the user in the execution form determined by the action control unit 250 is poor.

The action control unit 250 expresses the emotion of the robot 100 on the basis of the determined emotion value of the robot 100. For example, in a case in which the emotion value of “happy” of the robot 100 is increased, the action control unit 250 controls the control target 252 to cause the robot 100 to perform a gesture of being happy. In a case in which the emotion value of “sad” of the robot 100 is increased, the action control unit 250 controls the control target 252 so that the posture of the robot 100 becomes a head-drooping posture.

The communication processing unit 280 performs communication with the server 300. As described above, the communication processing unit 280 transmits the user reaction information to the server 300. The communication processing unit 280 receives the updated reaction rule from the server 300. Upon receiving the updated reaction rule from the server 300, the communication processing unit 280 updates the reaction rule 221.

The server 300 performs communication between the robot 100, the robot 101, and the robot 102 and the server 300, receives the user reaction information transmitted from the robot 100, and updates the reaction rule on the basis of the reaction rule including the action for which a positive reaction has been obtained.

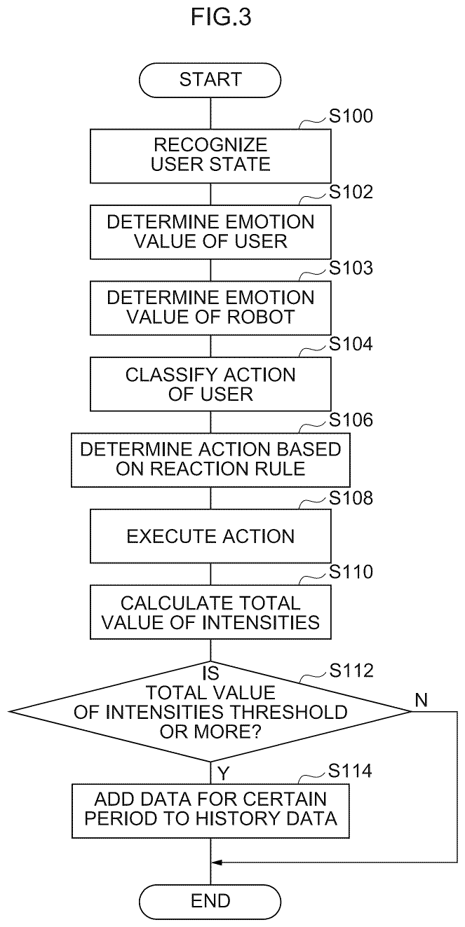

FIG. 3 schematically illustrates an example of an operation flow related to an operation of determining an action of the robot 100. The operation flow illustrated in FIG. 3 is repeatedly executed. In this case, it is assumed that information analyzed by the sensor module unit 210 is input. “S” in the operation flow represents a step to be executed.

First, in step S100, the user state recognition unit 230 recognizes a state of the user 10 on the basis of the information analyzed by the sensor module unit 210.

In step S102, the emotion determination unit 232 determines an emotion value indicating the emotion of the user 10 on the basis of the information analyzed by the sensor module unit 210 and the state of the user 10 recognized by the user state recognition unit 230.

In step S103, the emotion determination unit 232 determines an emotion value indicating the emotion of the robot 100 on the basis of the information analyzed by the sensor module unit 210 and the state of the user 10 recognized by the user state recognition unit 230. The emotion determination unit 232 adds the determined emotion value of the user 10 to the history data 222.

In step S104, the action recognition unit 234 recognizes an action classification of the user 10 on the basis of the information analyzed by the sensor module unit 210 and the state of the user 10 recognized by the user state recognition unit 230.

In step S106, the action determination unit 236 determines an action of the robot 100 on the basis of a combination of the current emotion value of the user 10 determined in step S102 and the past emotion value included in the history data 222, the emotion value of the robot 100, the action of the user 10 recognized by the action recognition unit 234, and the reaction rule 221.

In step S108, the action control unit 250 controls the control target 252 on the basis of the action determined by the action determination unit 236.

In step S110, the storage control unit 238 calculates a total value of the intensities on the basis of the intensity of the action predefined for the action determined by the action determination unit 236 and the emotion value of the robot 100 determined by the emotion determination unit 232.

In step S112, the storage control unit 238 determines whether or not the total value of the intensities is a threshold or more. In a case in which the total value of the intensities is less than the threshold, the data including the action of the user 10 is not stored in the history data 222, and the processing is ended. On the other hand, in a case in which the total value of the intensities is the threshold or more, the processing proceeds to step S114.

In step S114, the action determined by the action determination unit 236, the information analyzed by the sensor module unit 210 from the current time point to a certain period before, and the state of the user 10 recognized by the user state recognition unit 230 are stored in the history data 222.

As described above, the robot 100 determines the emotion value indicating the emotion of the robot 100 on the basis of the user state, and determines whether or not to store data including the action of the user 10 in the history data 222 on the basis of the emotion value of the robot 100. As a result, the capacity of the history data 222 that stores data including an action of the user 10 can be suppressed. For example, in a case in which the robot 100 determines that the user state of 10 years ago is the same as the user state after 10 years, the robot 100 reads the history data 222 of 10 years ago, and thus, can present the state of the user 10 of 10 years ago (for example, an expression and an emotion of the user 10), and any surrounding information including data such as vocal sound, an image, and a smell at the place to the user 10.

According to the robot 100, it is possible to cause the robot 100 to execute an appropriate action with respect to the action of the user 10. Conventionally, an action of a user is classified to determine an action including an expression or an appearance of a robot. On the other hand, the robot 100 determines the current emotion value of the user 10, and executes an action on the user 10 on the basis of the past emotion value and the current emotion value.

Therefore, for example, in a case in which the user 10 who was fine yesterday is depressed today, the robot 100 may say, “You were fine yesterday. What's wrong with you today?”. The robot 100 may also make speech with a gesture. For example, in a case in which the user 10 who was depressed yesterday is fine today, the robot 100 may say, “You were depressed yesterday, but you look fine today?”. For example, in a case in which the user 10 who was fine yesterday is better today than yesterday, the robot 100 may say, “You are better today than yesterday. What's better than yesterday?”. For example, the robot 100 may make speech such as “Recently, the mood is stable, which is good.” to the user 10 whose emotion value is 0 or more and whose state in which the fluctuation range of the emotion value is within a certain range continues.

For example, in a case in which the robot 100 asks a question of “Did you finish the homework that you said yesterday?” to the user 10 and an answer of “I did it” is obtained from the user 10, the robot may make affirmative speech such as “Good!” and make an affirmative gesture such as applause or thumbs-up. For example, in a case in which the user 10 says, “The presentation we discussed the day before yesterday was successful”, the robot 100 can make affirmative speech such as “Good job!” and also make the above affirmative gesture. As described above, the robot 100 performs an action based on the history of the state of the user 10, whereby the user 10 can be expected to feel a sense of closeness to the robot 100.

In the above embodiment, the case in which the robot 100 recognizes the user 10 by using the face image of the user 10 has been described, but the disclosed technology is not limited to this aspect. For example, the robot 100 may recognize the user 10 by using vocal sound uttered by the user 10, a mail address of the user 10, an ID of an SNS of the user 10, an ID card in which a wireless IC tag is built and which is possessed by the user 10, or the like.

The robot 100 is an example of an electronic apparatus including an action control system. An application target of the action control system is not limited to the robot 100, and the action control system can be applied to various electronic apparatuses. The functions of the server 300 may be implemented by one or more computers. At least some functions of the server 300 may be implemented by a virtual machine. At least some of the functions of the server 300 may be implemented in a cloud.

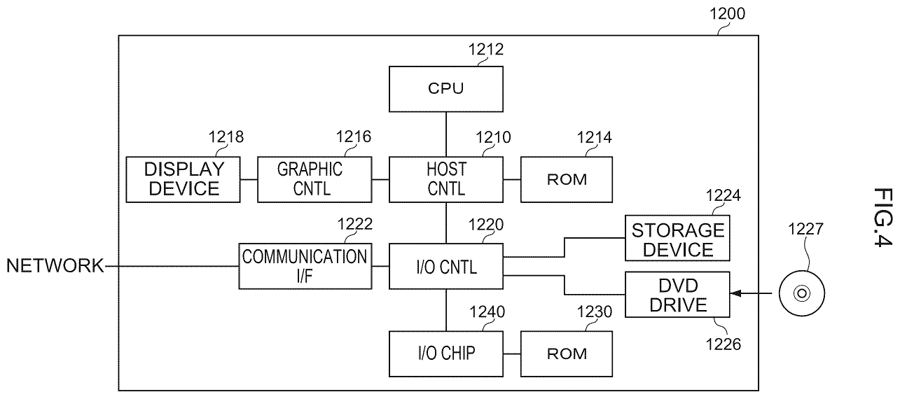

FIG. 4 schematically illustrates an example of a hardware configuration of a computer 1200 that functions as the robot 100 and the server 300. A program installed in the computer 1200 can cause the computer 1200 to function as one or more “units” of the device according to the present embodiment, or cause the computer 1200 to execute an operation associated with the device according to the present embodiment or one or more “units” thereof, and/or cause the computer 1200 to execute a process according to the present embodiment or a stage of the process. Such a program may be executed by a CPU 1212 to cause the computer 1200 to execute certain operations associated with some or all of the blocks in the flowcharts and block diagrams described herein.

The computer 1200 according to the present embodiment includes a CPU 1212, a RAM 1214, and a graphic controller 1216, which are connected to each other via a host controller 1210. The computer 1200 also includes input/output units such as a communication interface 1222, a storage device 1224, a DVD drive 1226, and an IC card drive, which are connected to the host controller 1210 via an input/output controller 1220. The DVD drive 1226 may be a DVD-ROM drive, a DVD-RAM drive, or the like. The storage device 1224 may be a hard disk drive, a solid state drive, or the like. The computer 1200 also includes a ROM 1230 and legacy input/output units such as a keyboard, which are connected to the input/output controller 1220 via an input/output chip 1240.

The CPU 1212 operates according to programs stored in the ROM 1230 and the RAM 1214, thereby controlling each unit. The graphic controller 1216 acquires image data generated by the CPU 1212 in a frame buffer or the like provided in the RAM 1214 or itself, and causes the image data to be displayed on the display device 1218.

The communication interface 1222 communicates with other electronic devices via a network. The storage device 1224 stores programs and data used by the CPU 1212 in the computer 1200. The DVD drive 1226 reads a program or data from the DVD-ROM 1227 or the like and provides the program or data to the storage device 1224. The IC card drive reads a program and data from the IC card and/or writes the program and data to the IC card.

The ROM 1230 stores therein a boot program or the like executed by the computer 1200 at the time of activation and/or a program depending on hardware of the computer 1200. The input/output chip 1240 may also connect various input/output units to the input/output controller 1220 via a USB port, a parallel port, a serial port, a keyboard port, a mouse port, or the like.

The program is provided by a computer readable storage medium such as the DVD-ROM 1227 or an IC card. The program is read from a computer readable storage medium, installed in the storage device 1224, the RAM 1214, or the ROM 1230, which is also an example of a computer readable storage medium, and executed by the CPU 1212. The information processing described in such a program is read by the computer 1200 and provides cooperation between the program and the various types of hardware resources. A device or a method may be configured by implementing an operation or processing of information according to use of the computer 1200.

For example, in a case in which communication is executed between the computer 1200 and an external device, the CPU 1212 may execute a communication program loaded in the RAM 1214 and instruct the communication interface 1222 to perform communication processing on the basis of processing described in the communication program. Under the control of the CPU 1212, the communication interface 1222 reads transmission data stored in a transmission buffer area provided in a recording medium such as the RAM 1214, the storage device 1224, the DVD-ROM 1227, or the IC card, transmits the read transmission data to the network, or writes reception data received from the network to a reception buffer area or the like provided on the recording medium.

The CPU 1212 may cause the RAM 1214 to read all or a necessary portion of a file or database stored in an external recording medium such as the storage device 1224, the DVD drive 1226(DVD-ROM 1227), or the IC card, and may execute various types of processing on data in the RAM 1214. Next, the CPU 1212 may write back the processed data to the external recording medium.

Various types of information such as various types of programs, data, tables, and databases may be stored in a recording medium and subjected to information processing. The CPU 1212 may execute various types of processing on the data read from the RAM 1214, including various types of operations, information processing, condition determination, conditional branching, unconditional branching, information retrieval/replacement, and the like, which are described throughout the disclosure and specified by a command sequence of a program, and writes back the results to the RAM 1214. The CPU 1212 may search for information in a file, a database, or the like in the recording medium. For example, in a case in which a plurality of entries each having an attribute value of a first attribute associated with an attribute value of a second attribute is stored in the recording medium, the CPU 1212 may search for an entry in which the attribute value of the first attribute matches a specified condition from the plurality of entries, read the attribute value of the second attribute stored in the entry, and thus acquire the attribute value of the second attribute associated with the first attribute satisfying a predetermined condition.

The programs or software modules described above may be stored in the computer 1200 or a computer readable storage medium near the computer 1200. A recording medium such as a hard disk or a RAM provided in a server system connected to a dedicated communication network or the Internet may be used as a computer readable storage medium, and provides a program to the computer 1200 via the network.

Blocks in the flowcharts and the block diagrams in the present embodiments may represent stages of a process in which an operation is performed or “units” of a device having a role of performing an operation. Specific stages and “units” may be implemented by a dedicated circuit, a programmable circuit supplied along with computer readable instructions stored on a computer readable storage medium, and/or a processor supplied along with computer readable instructions stored on a computer readable storage medium. Dedicated circuits may include digital and/or analog hardware circuits, and may include integrated circuits (ICs) and/or discrete circuits. Programmable circuits may include reconfigurable hardware circuits including, for example, AND, OR, XOR, NAND, NOR, and other logical operations, flip-flops, registers, and memory elements, such as field programmable gate arrays (FPGA) and programmable logic arrays (PLA).

Computer readable storage media may include any tangible device capable of storing instructions executed by a suitable device, and, as a result, a computer readable storage medium having instructions stored thereon has a product including instructions that may be executed to create means for executing operations designated in the flowcharts or block diagrams. Examples of the computer readable storage medium may include an electronic storage medium, a magnetic storage medium, an optical storage medium, an electromagnetic storage medium, and a semiconductor storage medium. More specific examples of the computer readable storage medium may include a Floppy (registered trademark) disk, a diskette, a hard disk, a random access memory (RAM), a read-only memory (ROM), an erasable programmable read-only memory (an EPROM or a flash memory), an electrically erasable programmable read-only memory (EEPROM), a static random access memory (SRAM), a compact disc read-only memory (CD-ROM), a digital versatile disk (DVD), a Blu-Ray (registered trademark) disk, a memory stick, and an integrated circuit card.

The computer readable instructions may include either source codes or object codes written in any combination of one or more programming languages, including assembler instructions, instruction-set-architecture (ISA) instructions, machine instructions, machine-dependent instructions, microcode, firmware instructions, state-setting data, or an object oriented programming language such as Smalltalk (registered trademark), or JAVA (registered trademark), C++, and conventional procedural programming languages such as the “C” programming language or similar programming languages.

The computer readable instructions may be provided to a processor of a general purpose computer, a special purpose computer, or another programmable data processing device, or a programmable circuit locally or via a local area network (LAN) or a wide area network (WAN) such as the Internet, in order to cause the processor of the general purpose computer, the special purpose computer, or another programmable data processing device or the programmable circuit to execute the computer readable instructions to generate means for executing operations designated in the flowcharts or the block diagrams. Examples of the processor include a computer processor, a processing unit, a microprocessor, a digital signal processor, a controller, and a microcontroller.

Although the technology of the disclosure has been described by using each embodiment, the technology of the disclosure is not limited to the scope disclosed in each embodiment. It is apparent to those skilled in the art that various modifications or improvements can be made to the above embodiments. It is apparent from the description of the claims that modes to which such modifications or improvements are added can also be included in the technical scope of the disclosure.

The order of execution of each piece of processing of operations, procedures, steps, stages, and the like in the devices, the systems, the programs, and the methods illustrated in the claims, the specification, and the drawings can be realized in any order unless “before”, “prior to”, or the like is explicitly stated, and unless the output of the previous processing is used in the later processing. Even in a case in which the operation flow in the claims, the specification, and the drawings is described by using “first,”, “next,”, and the like for convenience, this does not mean that it is essential to perform in this order.

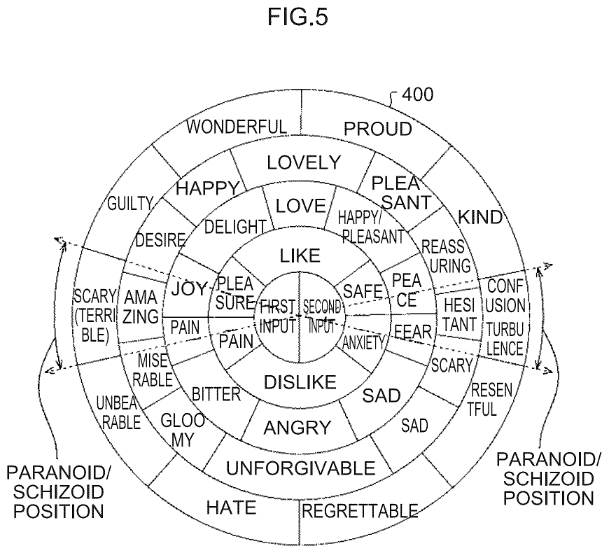

The emotion determination unit 232 may determine an emotion of the user according to a specific mapping. Specifically, the emotion determination unit 232 may determine an emotion of the user on the basis of an emotion map (see FIG. 5) that is a specific mapping.

FIG. 5 is a diagram illustrating an emotion map 300 on which a plurality of emotions are mapped. In the emotion map 300, emotions are disposed concentrically radially from the center. The closer to the center of the concentric circle, the more the emotion of the primitive state is disposed. Emotions indicating states and actions generated from the state of mind are disposed outside the concentric circle. The emotion is a concept including an affection and a mental state. On the left side of the concentric circle, emotions generated from reactions generally occurring in the brain are disposed. On the right side of the concentric circle, emotions induced by situation determination are generally disposed. In the up and down directions of the concentric circles, emotions generated from reactions generally occurring in the brain and induced by situational judgment are disposed. The emotion of “pleased” is disposed on the upper side of the concentric circle, and the emotion of “displeased” is disposed on the lower side. As described above, in the emotion map 300, a plurality of emotions are mapped on the basis of a structure in which emotions occur, and emotions that are likely to occur at the same time are mapped close to each other.

(1) For example, in a case in which the emotion engine, which is the emotion determination unit 232 of the robot 100, detects an emotion at about 100 msec, determination of the reaction operation (for example, a quick-response) of the robot 100 may be performed at a timing at which a detection frequency is set to be similar to at least the detection frequency (100 msec) of the emotion engine, or may be performed at a timing at which the detection frequency is set to be higher than the detection frequency. The detection frequency of the emotion engine may be interpreted as a sampling rate.

The emotion is detected in about 100 msec, and the reaction operation (for example, a quick-response) is performed immediately in conjunction with the detection, whereby an unnatural quick-response is eliminated, and an interaction that naturally reads the atmosphere can be realized. The robot 100 performs a reaction operation (quick-response or the like) according to the directionality and the degree (intensity) of the mandala of the emotion map 300. The detection frequency (sampling rate) of the emotion engine is not limited to 100 ms, and may be changed according to a situation (for example, in the case of playing sports), the age of the user, or the like.

(2) In comparison with the emotion map 300, the directionality of the emotion and the intensity of the degree thereof may be set in advance, and the quick-response motion and the strength of the quick-response may be set. For example, in a case in which the robot 100 feels a sense of stability, safety, or the like, the robot 100 continues listening to the speech while nodding. In a case in which the robot 100 feels anxious, hesitant, or suspicious, the robot 100 may tilt its head or stop swinging its head.

These emotions are distributed in the 3:00 direction of the emotion map 300, and usually come and go between safety and anxiety. In the right half of the emotion map 300, situation recognition is superior to internal sensation, and thus gives a calm impression.

(3) In a case in which the robot 100 feels good in the case of receiving the compliment, a filler “Oh” may come in front of the line. In a case in which the robot feels pain in the case of receiving harsh words, a filler “Ugh!” may come in front of the line. A physical reaction such as a gesture of the robot 100 crouching while saying “Ohh!” may be included. These emotions are distributed around the 9:00 o'clock position on the emotion map 300.

(4) In the left half of the emotion map 300, internal sensation (reaction) is superior to situation recognition. Therefore, an impression of unintentional reaction may be given.

In a case in which the robot 100 has a favorable emotion in situation recognition while remembering internal sensation (reaction) of satisfaction, the robot 100 may nod deeply while looking at the other party, or may say “yeah, yeah”. As described above, the robot 100 may generate a balanced favorable emotion to the other party, that is, an action such as allowance or tolerance to the other party. Such emotions are distributed around 12:00 in the emotion map 300.

In contrast, in a case in which the robot 100 feels antipathy in the situation recognition while remembering internal sensation (reaction) of displeasure, the robot 100 may shake its head sideways, and may turn red the LED of the eye and look at the other party in the case of emotion hatred. Such emotions are distributed around 6:00 in the emotion map 300.

(5) Since the inside of the emotion map 300 represents the inside of the mind and the outside of the emotion map 300 represents an action, the emotion is more visible (appears in the action) toward the outside of the emotion map 300.

(6) In a case in which the robot 100 listens to a person's speech while remembering the safety distributed around 3:00 on the emotion map 300, the robot slightly shakes its head vertically and says “uh-huh”. However, in the direction of love around 12:00, the robot may perform strong nodding such as shaking its head deeply vertically.

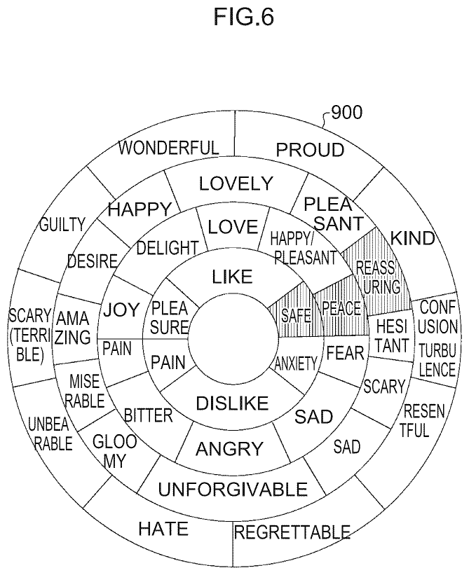

The emotion determination unit 232 inputs the information analyzed by the sensor module unit 210 and the recognized state of the user 10 to a neural network trained in advance, acquires an emotion value indicating each emotion indicated in the emotion map 300, and determines an emotion of the user 10. This neural network is trained in advance on the basis of a plurality of pieces of learning data that is a combination of the information analyzed by the sensor module unit 210 and the recognized state of the user 10 and the emotion value indicating each emotion indicated in the emotion map 300. This neural network is trained such that, as in an emotion map 900 illustrated in FIG. 6, emotions disposed close to each other have close values. FIG. 6 illustrates an example in which a plurality of emotions such as “safe”, “calm”, and “reassuring” have close emotion values.

The emotion determination unit 232 may determine an emotion of the robot 100 according to a specific mapping. Specifically, the emotion determination unit 232 inputs the information analyzed by the sensor module unit 210, the state of the user 10 recognized by the user state recognition unit 230, and the state of the robot 100 to a neural network trained in advance, acquires an emotion value indicating each emotion indicated in the emotion map 300, and determines an emotion of the robot 100. This neural network is trained in advance on the basis of a plurality of pieces of learning data that is a combination of the information analyzed by the sensor module unit 210, the recognized state of the user 10, the state of the robot 100, and the emotion value indicating each emotion indicated in the emotion map 300. For example, the neural network is trained on the basis of learning data indicating that the emotion value “3” of “happy” is obtained in a case in which the robot 100 is recognized as being petted by the user 10 from the output of the touch sensor (not illustrated), and learning data indicating that the emotion value “3” of “angry” is obtained in a case in which the robot 100 is recognized as being hit by the user 10 from the output of the acceleration sensor (not illustrated). This neural network is trained such that, as in the emotion map 900 illustrated in FIG. 6, emotions disposed close to each other have close values.

The action determination unit 236 adds a fixed sentence for inquiry about the action content of the robot corresponding to the action of the user to text representing the action of the user, the emotion of the user, and the emotion of the robot, and inputs the text to the interaction function, thereby generating the action content of the robot.

For example, the action determination unit 236 acquires text indicating the state of the robot 100 from the emotion of the robot 100 determined by the emotion determination unit 232 by using an emotion table as illustrated in Table 1. Here, in the emotion table, an index number is assigned to each emotion value for each type of emotion, and a text indicating the state of the robot 100 is stored for each index number.

In a case in which the emotion of the robot 100 determined by the emotion determination unit 232 corresponds to the index number “2”, text “very pleasant state” is obtained. In a case in which the emotion of the robot 100 corresponds to a plurality of index numbers, a plurality of pieces of text indicating the state of the robot 100 are obtained.

An emotion table as illustrated in Table 2 is prepared for an emotion of the user 10. Here, in a case in which the action of the user is to say “***”, the emotion of the robot 100 is the index number “2”, and the emotion of the user 10 is the index number “3”, a sentence such as “The robot is in a very pleasant state. The user is in a normally pleasant state. The user says,” ***”. How do you answer as a robot?” is input to the sentence generation model to acquire the action content of the robot. The action determination unit 236 determines an action of the robot from the action content.

TABLE 1

| Index | Type of | Emotion | State of |
|---|---|---|---|
| Number | Emotion | Value | Robot |
| 1 | Pleasant | 5 | Very Pleasant State |
| 2 | Pleasant | 4 | Extremely Pleasant State |
| 3 | Pleasant | 3 | Normally Pleasant State |
| 4 | Pleasant | 2 | Slightly Pleasant State |
| 5 | Pleasant | 1 | Only a Little Pleasant State |
| . . . | . . . | . . . | . . . |

TABLE 2

| Index | Type of | Emotion | State of |
|---|---|---|---|
| Number | Emotion | Value | User |
| 1 | Pleasant | 5 | Very Pleasant State |
| 2 | Pleasant | 4 | Extremely Pleasant State |
| 3 | Pleasant | 3 | Normally Pleasant State |
| 4 | Pleasant | 2 | Slightly Pleasant State |
| 5 | Pleasant | 1 | Only a Little Pleasant State |
| . . . | . . . | . . . | . . . |

That is, since the robot 100 can change the action of the robot according to the index number corresponding to the emotion of the robot, the user has an impression that the robot has a mind, and is promoted to take an action such as talking to the robot.

The action determination unit 236 may generate the action content of the robot by adding a fixed sentence for inquiry about the action content of the robot corresponding to the action of the user and inputting the fixed sentence to the sentence generation model having the interaction function after adding not only the text indicating the action of the user, the emotion of the user, and the emotion of the robot but also the text indicating the content of the history data 222. As a result, the robot 100 can change the action of the robot according to the history data indicating the emotion or the action of the user, and thus, the user has an impression that the robot has personality, and is promoted to take an action such as talking to the robot. The history data may further include an emotion or an action of the robot.

The robot 100 may be mounted on a stuffed toy, or may be applied to a control device connected wirelessly or by wire to a control target device (speaker or camera) mounted on the stuffed toy.

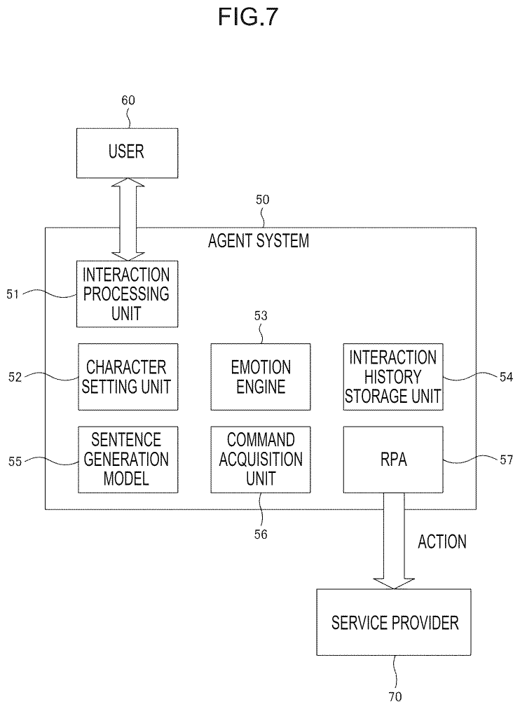

In the above description, the case in which the action control system is applied to the robot 100 has been exemplified, but the disclosure is not limited to this aspect. FIG. 7 is a functional block diagram of an agent system 50 configured by using some or all of the functions of the action control system. The agent system 50 is a computer system that performs a series of actions according to the intention of the user 10 through an interaction with the user 10. The interaction with the user 10 can be performed by vocal sound or text.

The agent system 50 can be mounted on, for example, a robot, a doll, a stuffed toy, a pendant, a smart watch, a smartphone, a smart speaker, an earphone, a camera, and a personal computer. The agent system 50 may be implemented in a web server and used via a web browser operating on a communication terminal such as a smartphone possessed by the user.

The agent system 50 serves as, for example, a butler, a secretary, a teacher, a partner, a friend, a lover, or a teacher acting for the user 10. The agent system 50 not only interacts with the user 10 but also provides advice, guidance to a destination, recommendation according to user's preference, or the like. The agent system 50 performs reservation, order, payment, or the like on a service provider 70.

The agent system 50 includes an emotion engine 53 to determine an emotion of the user 10 and an emotion of the agent itself, and acts for the user 10 while taking into account the emotions of the user 60 and the agent. Here, the agent is an agent that operates on software. In other words, the agent system 50 understands the emotion of the user 10 and reads the mood to realize heartfelt support, assistance, advice, and service provision. The agent system 50 comforts, encourages, and energizes the user 10 by attending to the concern of the user 10. The agent system 50 plays with the user 10 and draws a picture diary to remind the user of the past. The agent system 50 performs an action that increases the sense of happiness of the user 10.

The agent system 50 includes an interaction processing unit 51, a character setting unit 52, an emotion engine 53, an interaction history storage unit 54, a sentence generation model 55, a command acquisition unit 56, and a Robotic Process Automation (RPA) 57.

The interaction processing unit 51 includes an action determination unit 236 and an action control unit 250 that perform processing related to speech. The interaction processing unit 51 generates speech content of an agent for interacting with the user 10, and outputs the speech content by at least one of vocal sound or text.

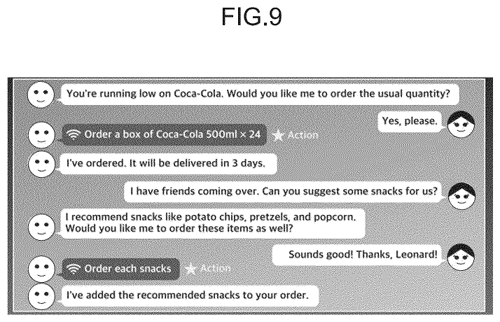

The character setting unit 52 sets a character of an agent (corresponding to an agent 52A illustrated in FIG. 9) in a case in which the agent system 50 interacts with the user 10 on the basis of designation from the user 10. That is, the speech content output from the interaction processing unit 51 is output through the agent having the set character. As the character, for example, a real celebrity or famous person such as an actor, an entertainer, an idol, or an athlete can be set. It is also possible to set a fictitious character appearing in a cartoon, a movie, or an animation. For example, it is possible to set, as the character of the agent, “Queen Anne” performed by “Audrey Hepburn” appearing in the movie “Roman Holiday”. In a case in which the agent's character is known, since the vocal sound, the wording, the tone, and the personality of the character are known, the prompt setting in the character setting unit 52 is automatically performed only by the user 10 designating his/her favorite character. The vocal sound, the wording, the tone, and the personality of the set character are reflected in the interaction with the user 10. In other words, the interaction processing unit 51 synthesizes vocal sound corresponding to the character set by the character setting unit 52, and outputs the speech content of the agent by the synthesized vocal sound. As a result, the user 10 can feel as if he/she is interacting with his/her favorite character (for example, a favorite actor).

In a case in which the agent system 50 is mounted on a device having a display such as a smartphone, for example, an icon, a still image, or a moving image of an agent having a character set by the character setting unit 52 may be displayed on the display. The image of the agent is generated by using, for example, an image synthesis technology such as 3D rendering. In the agent system 50, an interaction with the user 10 may be performed while the image of the agent makes a gesture according to the emotion of the user 10, the emotion of the agent, and the speech content of the agent. The agent system 50 may output only vocal sound without outputting an image in the case of interacting with the user 10.

The emotion engine 53 includes an emotion determination unit 232, and determines an emotion value indicating the emotion of the user 10 and an emotion value of the agent itself. The emotion value of the agent itself is reflected in the emotion of the set character. In a case in which the agent system 50 interacts with the user 10, not only the emotion of the user 10 but also the emotion of the character is reflected in the interaction. That is, the interaction processing unit 51 outputs the speech content in an aspect according to the emotion determined by the emotion engine 53.

The emotion of the agent is also reflected in a case in which the agent system 50 performs an action toward the user 10. For example, in a case in which the user 10 requests the agent system 50 to take a photograph, whether or not the agent system 50 takes a photograph in response to the request of the user is determined according to the degree of the emotion of “gloomy” of the agent. In a case in which the agent has a positive emotion, the agent performs a favorable interaction or action on the user 10, and in a case in which the agent has a negative emotion, the agent performs a defiant interaction or action on the user 10.

The interaction history storage unit 54 is a storage medium for storing a history of interactions performed between the user 10 and the agent system 50. The interaction history storage unit 54 may be realized by the history data 222 of the storage unit 220 or may be realized by an external cloud storage. In the case of interacting with the user 10 or performing an action toward the user 10, the agent system 50 determines the interaction content or the action content in consideration of the content of the interaction history stored in the interaction history storage unit 54. For example, the agent system 50 ascertains the hobby and the preference of the user 10 on the basis of the interaction history stored in the interaction history storage unit 54. The agent system 50 generates interaction content matching the hobby and the preference of the user 10 and provides a recommendation. The interaction processing unit 51 generates speech content on the basis of the interaction history stored in the interaction history storage unit 54. The interaction history storage unit 54 stores personal information such as a name, an address, a telephone number, and a credit card number of the user 10 acquired through an interaction with the user 10. Here, the agent may voluntarily make speech such as “Is credit card number to be registered?”, to the user 10 to ask a question about whether or not to register the personal information, and may store the personal information in the interaction history storage unit 54 according to an answer of the user 10.

The sentence generation model 55 generates a sentence that is a response to the input text or vocal sound. The sentence generation model 55 may be interpreted as an algorithm and an operation for automatic interaction processing using letters. Since the sentence generation model is known as disclosed in, for example, JP-A No. 2018-081444 and chatGPT (Internet search <URL: https://openai.com/blog/chatgpt>), a detailed description thereof will be omitted. Such a sentence generation model is configured by a large language model (LLM).

The interaction processing unit 51 generates speech content on the basis of the sentence generated by the sentence generation model 55. Specifically, the interaction processing unit 51 inputs the text or vocal sound input by the user 10, the emotions of both the user 10 and the agent specified by the emotion engine 53, and the conversation history stored in the interaction history storage unit 54 to the sentence generation model 55, and generates the speech content of the agent. In this case, the interaction processing unit 51 may further input the character's personality set by the character setting unit 52 to the sentence generation model 55 to generate the speech content of the agent. In the agent system 50, the sentence generation model 55 is not located on the front-end side serving as a touch point with the user 10, but is used as a tool of the agent system 50.

The command acquisition unit 56 includes the speech understanding unit 212, and acquires an agent command from vocal sound output from the user 10 or text through an interaction with the user 10. The command includes, for example, content of actions to be executed by the agent system 50, such as information search, store reservation, ticket arrangement, purchase of products/services, payment, route guidance to a destination, and recommendation provision.

The RPA 57 performs an action according to the command acquired by the command acquisition unit 56. The RPA 57 performs actions related to use of the service provider 70, such as information search, store reservation, ticket arrangement, purchase of products/services, and payment. The RPA 57 is an example of an “operation execution unit” in the disclosure.

The RPA 57 reads the personal information regarding the user 10 necessary for executing the action related to the use of the service provider 70 from the interaction history storage unit 54 and uses the personal information. For example, in the case of purchasing a product in response to a request from the user 10, the agent system 50 reads and uses personal information such as a name, an address, a telephone number, and a credit card number of the user 10 stored in the interaction history storage unit 54. It is unkind to request the user 10 to input personal information in the initial setting, and it is also unpleasant for the user. In the agent system 50 according to the present embodiment, instead of requesting the user 10 to input personal information in the initial setting, the personal information acquired through the interaction with the user 10 is stored, and read and used as necessary. As a result, it is possible to avoid making the user feel unpleasant, and convenience of the user 10 is improved.

The agent system 50 executes the interaction processing according to the following Steps 1 to 6.

(step 1) The agent system 50 sets a character of the agent. Specifically, the character setting unit 52 sets a character of the agent in a case in which the agent system 50 interacts with the user 10 on the basis of the designation from the user 10.

(step 2) The agent system 50 acquires the state of the user 10 including the vocal sound or text input from the user 10, the emotion value of the user 10, the emotion value of the robot 100, and the history data 222. Specifically, the processing similar to steps S100 to S103 is performed to acquire the state of the user 10 including the vocal sound or text input from the user 10, the emotion value of the user 10, the emotion value of the robot 100, and the history data 222.

(step 3) The agent system 50 determines speech content of the agent. Specifically, the interaction processing unit 51 inputs the text or vocal sound input by the user 10, the emotions of both the user 10 and the character specified by the emotion engine 53, and the history of conversations stored in the interaction history storage unit 54 to the sentence generation model 55, and generates the speech content of the agent. For example, a fixed sentence “In this case, how do you answer as an agent?” is added to the text or vocal sound input by the user 10 and the text representing the emotions of both the user 60 and the character specified by the emotion engine 53 and the interaction history stored in the conversation history storage unit 54, and the text is input to the sentence generation model 55 to acquire the speech content of the agent. As an example, in a case in which the text or the vocal sound input by the user 10 is “I need a reservation at 7 μm at a good Chinese restaurant nearby.”, “Understood.”, and “These are recommended restaurants. 1.AAAA. 2.BBBB. 3.CCCC. and 4.DDDD” are acquired as the speech content of the agent. In a case in which the text or the vocal sound input by the user 10 is “Fourth DDDD is good”, “Yes. I will make a reservation. How many seats do you need?” are acquired as the speech content of the agent.

(step 4) The agent system 50 outputs the speech content of the agent. Specifically, the interaction processing unit 51 synthesizes vocal sound corresponding to the character set by the character setting unit 52, and outputs the speech content of the agent by the synthesized vocal sound.

(step 5) The agent system 50 determines whether or not a timing to execute a command of the agent has arrived. Specifically, the interaction processing unit 51 determines whether or not the timing to execute the command of the agent has arrived on the basis of the output of the sentence generation model 55. For example, in a case in which the output of the sentence generation model includes that the agent executes the command, it is determined that the timing to execute the command of the agent has arrived, and the processing proceeds to Step 6. On the other hand, in a case in which it is determined that it is not the timing to execute the command of the agent, the processing returns to Step 2 described above.

(step 6) The agent system 50 executes the command of the agent. Specifically, the command acquisition unit 56 acquires the command of the agent from the vocal sound output from the user 10 or the text through an interaction with the user 10. The RPA 57 performs an action corresponding to the command acquired by the command acquisition unit 56. For example, in a case in which the command is “information search”, information search is performed by a search site by using a search query obtained through an interaction with the user 10 and an application programming interface (API). The interaction processing unit 51 inputs the search result to the sentence generation model 55 and generates the speech content of the agent. The interaction processing unit 51 synthesizes vocal sound corresponding to the character set by the character setting unit 52, and outputs the speech content of the agent by the synthesized vocal sound. In a case in which the command is “store reservation”, the reservation is made by making a phone call to the reservation destination store by using the reservation information obtained through the interaction with the user 10, the reservation destination store information, and the API by using phone software. In this case, the interaction processing unit 51 acquires the speech content of the agent with respect to the vocal sound input from the other party by using the sentence generation model having the interaction function. The interaction processing unit 51 inputs the result of the store reservation (whether or not the reservation is correct) to the sentence generation model 55, and generates the speech content of the agent. The interaction processing unit 51 synthesizes vocal sound corresponding to the character set by the character setting unit 52, and outputs the speech content of the agent by the synthesized vocal sound. The processing returns to Step 2 described above.

In Step 6, the result of the action (for example, store reservation) executed by the agent is also stored in the interaction history storage unit 54. The result of the action executed by the agent stored in the interaction history storage unit 54 is used by the agent system 50 to ascertain a hobby or a preference of the user 10. For example, in a case in which the same store is reserved a plurality of times, it is recognized that the user 10 likes the store, or the reserved time period, or the reservation content such as the content of the course or the fee is used as a criterion for choosing the store at the time of the next reservation.

As described above, the agent system 50 can execute interaction processing and perform an action related to use of the service provider 70 as necessary. While the user is sleeping, the agent system 50 may search for news or the like that the user is interested in on the basis of the taste of the user acquired in advance, and in a case in which the user wakes up, the agent system 50 may deliver the news from itself. For example, the agent says “The Yankees seems to have won the game yesterday. Let's go to the baseball park to cheer on this evening.” In a case in which the user says “I need to consult father”, the father says “I doubt whether a ticket can be obtained”. The agent says “I will check whether a ticket can be obtained”, and the request for a seat or the like is interrogated from an interaction with the user to secure a ticket.

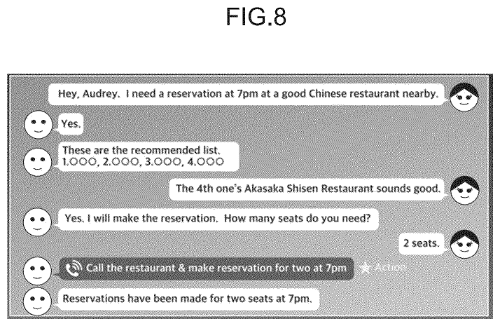

FIGS. 8 and 9 are diagrams illustrating an example of the operation of the agent system 50. FIG. 8 illustrates an aspect in which the agent system 50 makes a restaurant reservation through an interaction with the user 10. The agent system 50 can ascertain a preference of the user 10 based on an interaction history with the user 10, provide a recommendation list of restaurants that match the preference of the user 10, and perform a reservation of a selected restaurant.

On the other hand, FIG. 9 illustrates an aspect in which the agent system 50 accesses a mail order site through an interaction with the user 10 to purchase a product. The agent system 50 can estimate a remaining amount of the beverage stocked by the user 10 on the basis of the interaction history with the user 10, and can propose and execute the purchase of the beverage to the user 10. The agent system 50 can ascertain the taste of the user on the basis of the past interaction history with the user 10, and recommend a snack that the user likes. As described above, the agent system 50 supports the daily life of the user 10 by performing various actions such as restaurant reservation or product purchase payment while communicating with the user 10 as an agent such as a butler.

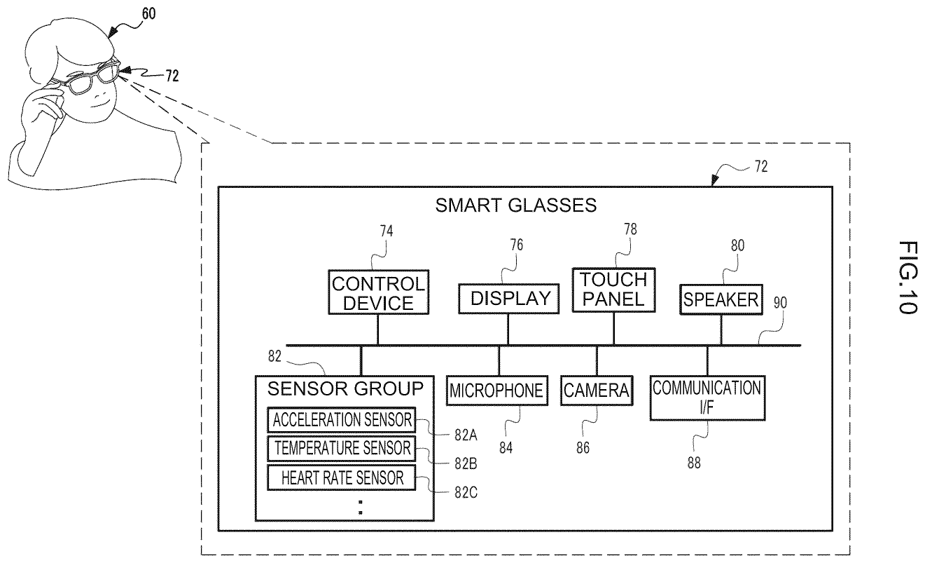

The agent system 50 described above can be applied to smart glasses 72. FIG. 10 is a block diagram illustrating an example of a hardware configuration of the smart glasses 72. The smart glasses 72 are glasses-type smart devices, and are worn by the user 10 similarly to general glasses. The smart glasses 72 include a control device 74, a display 76, a touch panel 78, a speaker 80, a sensor group 82, a microphone 84, a camera 86, and a communication I/F 88. The smart glasses 72 are examples of an “electronic apparatus” and a “wearable terminal” in the disclosure.

The control device 74 is a device that controls the entire smart glasses 72, and includes, for example, a processor, a memory, and a storage (not illustrated). The display 76 displays various types of information to the user 10. The display 76 is, for example, a liquid crystal display. The display 76 is provided, for example, in a lens portion of the smart glasses 72, and allows the display content to be visually recognized by the user 10. The touch panel 78 receives an input from the user 10. The speaker 80 outputs vocal sound indicating various types of information to the user 10.

The sensor group 82 detects a state of the user 10. The sensor group 82 includes a plurality of sensors. For example, the sensor group 82 includes an acceleration sensor 82A, a temperature sensor 82B, and a heart rate sensor 82C. These sensors are merely examples, and other sensors may be mounted in order to detect the state of the user 10.

The microphone 84 acquires vocal sound output by the user 10 or an environmental sound around the smart glasses 72. The camera 86 can image the surroundings of the smart glasses 72. The camera 86 can also image the face of the user 10. The camera 86 is, for example, a CCD camera. The communication I/F 88 manages communication between the smart glasses 72 and the outside. The control device 74, the display 76, the touch panel 78, the speaker 80, the sensor group 82, the microphone 84, the camera 86, and the communication I/F 88 are connected to a bus 90.

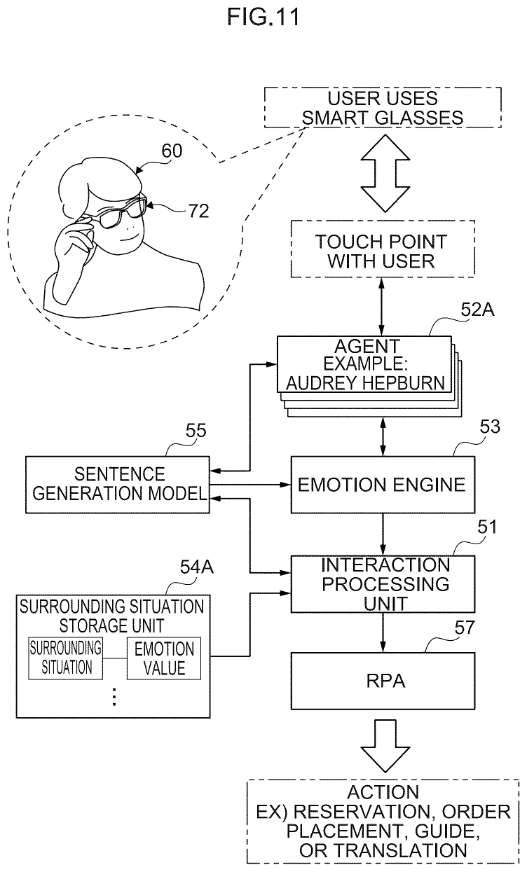

FIG. 11 is a diagram illustrating an example of a usage aspect of the agent system 50 by the smart glasses 72. The smart glasses 72 realize provision of various services to the user 10 using the agent system 50. For example, in a case in which the smart glasses 72 are operated (for example, sound is input to a microphone, or a touch panel is tapped with a finger) by the user 10, the smart glasses 72 start to use the agent system 50. Here, using the agent system 50 includes that the control device 74 has a function similar to that of the agent system 50 and uses the function, and also includes an aspect in which the smart glasses 72 communicate with the outside (for example, a server) via the communication I/F 88 to use the agent system 50 stored outside the smart glasses 72.

In a case in which the user 10 operates the smart glasses 72, a touch point is generated between the agent system 50 and the user 10. That is, a service is started to be provided by the agent system 50. As described above, in the agent system 50, the character (for example, the character of Audrey Hepburn) of the agent 52A is set by the character setting unit 52.

As described above, the emotion engine 53 includes the emotion determination unit 232, and determines an emotion value indicating the emotion of the user 10 and an emotion value of the agent itself. Here, the emotion value indicating the emotion of the user 10 may be estimated from the various sensors included in the sensor group 82 mounted on the smart glasses 72. For example, in a case in which the heart rate of the user 10 detected by the heart rate sensor 82C mounted on the smart glasses 72 increases, emotion values such as “anxiety” and “fear” are estimated to be great. The heart rate sensor 82C is an example of an “acquisition unit” in the disclosure.

As a result of measuring the body temperature of the user with the temperature sensor 82B, for example, in a case in which the body temperature exceeds the average body temperature, the emotion value such as “pain” or “bitter” is estimated to be great. For example, in a case in which it is detected by the acceleration sensor 82A that the user 10 performs some sport, an emotion value such as “pleasant” is estimated.

For example, the emotion value (for example, the emotion value of “gloomy”) of the user 10 may be estimated on the basis of the expression (for example, the gloomy expression) of the user 10 captured by the camera 86 mounted on the smart glasses 72. In this case, the camera 86 is an example of an “acquisition unit” in the disclosure.

For example, the emotion value of the user 10 may be estimated from the vocal sound or speech content of the user 10 acquired by the microphone 84 mounted on the smart glasses 72. For example, in a case in which the user 10 is raising his/her vocal sound, an emotion value such as “angry” is estimated. In this case, the microphone 84 is an example of an “acquisition unit” in the disclosure.

In a case in which the emotion value estimated by the emotion engine 53 is greater than a predefined value, the agent system 50 causes the smart glasses 72 to acquire information regarding a surrounding situation. Specifically, for example, the camera mounted on the smart glasses 72 is caused to capture an image or a moving image indicating a surrounding situation of the user 10 (for example, a surrounding person or object). The microphone mounted on the smart glasses 72 is caused to record surrounding environmental sound. Examples of other information regarding the surrounding situation include date, time, and position information, and information indicating weather. The agent system 50 acquires information regarding the surrounding situation in a case in which the emotion value becomes great from the smart glasses 72. The information regarding the surrounding situation is stored in the surrounding situation storage unit 54A together with the emotion value. The surrounding situation storage unit 54A is a storage medium for storing information regarding the surrounding situation acquired by the agent system 50. Similar to the interaction history storage unit 54, the surrounding situation storage unit 54A may be realized by the history data 222 of the storage unit 220, or may be realized by an external cloud storage. As described above, the surrounding situation obtained by the smart glasses 72 is stored in the surrounding situation storage unit 54A as a so-called life log in a state of being associated with the emotion value of the user 10 at that time.

In the agent system 50, information indicating the surrounding situation is stored in the surrounding situation storage unit 54A in association with the emotion value. As a result, the agent system 50 ascertains personal information such as a hobby, a preference, or a personality of the user 10. For example, in a case in which an image indicating a state of baseball watching is associated with an emotion value such as “happy” or “pleasant”, the hobby of the user 10 is baseball watching, and a favorite team or player is ascertained by the agent system 50 from the information stored in the surrounding situation storage unit 54A.

In the case of interacting with the user 10 or performing an action toward the user 10, the agent system 50 determines the interaction content or the action content in consideration of the content of the surrounding situation stored in the surrounding situation storage unit 54A. The interaction content or the action content may be determined in consideration of the interaction history stored in the interaction history storage unit 54 as described above in addition to the surrounding situation.

As described above, the interaction processing unit 51 generates the speech content on the basis of the sentence generated by the sentence generation model 55. Specifically, the interaction processing unit 51 inputs the text or the vocal sound input by the user 10, the emotions of both the user 10 and the agent specified by the emotion engine 53, the conversation history stored in the interaction history storage unit 54, the personality of the agent, and the like to the sentence generation model 55, and generates the speech content of the agent. The interaction processing unit 51 inputs the surrounding situation stored in the surrounding situation storage unit 54A to the sentence generation model 55, and generates the speech content of the agent.

The generated speech content is output by vocal sound from, for example, the speaker 80 mounted on the smart glasses 72 to the user 10. In this case, a synthesized vocal sound corresponding to the character of the agent is used as the vocal sound. The interaction processing unit 51 reproduces the vocal sound quality of the character of the agent (for example, Audrey Hepburn) to generate a synthesized vocal sound, or generates a synthesized vocal sound (for example, in the case of an emotion of “angry”, vocal sound in which tone is enhanced) according to the emotion of the character. The speech content may be displayed on the display 76 instead of the vocal sound output or together with the vocal sound output. The speaker 80 and the display 76 are examples of an “output unit” in the disclosure.

The RPA 57 executes an operation according to the command (for example, a command of the agent acquired from vocal sound output by the user 10 or text through interaction with the user 10). The RPA 57 performs actions related to use of the service provider 70, such as information search, store reservation, ticket arrangement, product/service purchase, payment, route guidance, and translation.

As another example, the RPA 57 executes an operation of transmitting content input by vocal sound of the user 10 (for example, a child) through interaction with the agent to the other party (for example, the parent). Examples of transmission means include message application software, chat application software, and mail application software.

In a case in which the operation of the RPA 57 is executed, for example, vocal sound indicating that the execution of the operation is finished is output from the speaker 80 mounted on the smart glasses 72. For example, vocal sound such as “Reservation of the store has been completed” is output to the user 10. For example, in a case in which the reservation of the store is full, vocal sound such as “Reservation could not be made. What would you like to do?” is output to the user 10.

As described above, in the smart glasses 72, various services are provided to the user 10 by using the agent system 50. Since the smart glasses 72 are worn by the user 10, the agent system 50 can be used in various scenes such as a home, a workplace, and a place outside the house.

The smart glasses 72 are worn by the user 10, and are thus suitable for collecting a so-called life log of the user 10. Specifically, the emotion value of the user 10 is estimated on the basis of detection results from various sensors or the like mounted on the smart glasses 72 or recording results from the camera 86 or the like. Thus, the emotion value of the user 10 can be collected in various scenes, and the agent system 50 can provide a service or speech content suitable for the emotion of the user 10.

In the smart glasses 72, the surrounding situation of the user 10 can be obtained by the camera 86, the microphone 84, and the like. The surrounding situation and the emotion value of the user 10 are associated with each other. As a result, it is possible to estimate what kind of emotion the user 10 has in what kind of situation. As a result, the accuracy in a case in which the agent system 50 ascertains the hobby/preference of the user 10 can be improved. In the agent system 50, the hobby/preference of the user 10 is accurately ascertained, so that the agent system 50 can provide a service or speech content suitable for the hobby/preference of the user 10.

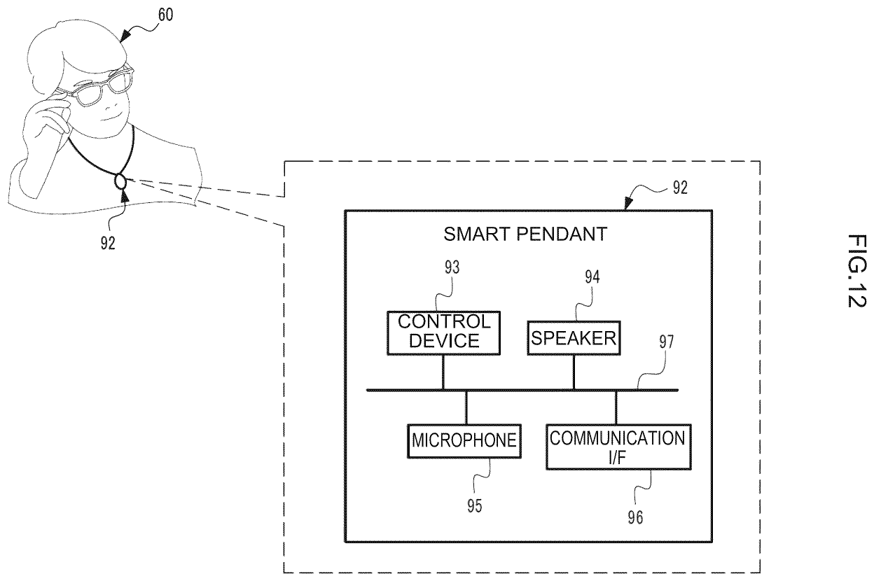

The agent system 50 can also be applied to the smart pendant 92. FIG. 12 is a block diagram illustrating an example of a hardware configuration of the smart pendant 92. The smart pendant 92 is a pendant type smart device, and is worn by the user 10 similarly to a general pendant. The smart pendant 92 includes a control device 93, a speaker 94, a microphone 95, and a communication I/F 96. The smart pendant 92 is an example of an “electronic apparatus” and a “wearable terminal” in the disclosure.

The control device 93 is a device that controls the entire smart pendant 92, and includes, for example, a processor, a memory, and a storage (not illustrated). The speaker 94 outputs vocal sound indicating various types of information to the user 10. The speaker 94 is, for example, a speaker (that is, the directional speaker) capable of outputting vocal sound having directivity. Speaker 94 is set to have directivity toward the ear of user 10. As a result, the vocal sound is suppressed from reaching a person other than the user 10. The speaker 94 is an example of an “output unit” in the disclosure.

The microphone 95 acquires vocal sound output by the user 10 or an environmental sound around the smart pendant 92. The smart pendant 92 is worn to be carried from the neck of the user 10. Thus, the smart pendant 92 is located relatively close to the mouth of the user 10 while being worn. This facilitates acquisition of vocal sound output by the user 10. The microphone 95 is an example of an “acquisition unit” in the disclosure. The communication I/F 96 manages communication between the smart pendant 92 and the outside. The control device 93, the speaker 94, the microphone 95, and the communication I/F 96 are connected to a bus 97.

The agent system 50 can also be used in the smart pendant 92. That is, the service (see FIG. 11) provided by using the agent system 50 in the smart glasses 72 described above is also provided in the smart pendant 92. For example, emotion values of the user 10 and the agent are estimated through an interaction with the agent in which the character is set, and speech content of the agent is changed or content of a service to be provided is changed according to the emotion values. For example, the surrounding situation of the user 10 and the emotion value at that time are recorded as a life log, and are reflected in the estimation of the emotion value of the user 10 or the content of the provided service.

Similarly to the smart glasses 72, the smart pendant 92 may also be provided with a sensor group (corresponding to the sensor group 82 in the smart glasses 72). As a result, information indicating the physical condition or the surrounding situation of the user 10 can be detected, and an emotion value can be estimated or the surrounding situation can be recorded in the agent system 50.

As described above, also in the smart pendant 92, effects similar to those of the smart glasses 72 described above can be obtained. The smart pendant 92 is lightweight and easy to carry compared with a stuffed toy, a smart speaker, a smartphone, smart glasses, or the like. Compared with other smart terminals such as a smartphone and smart glasses, the smart pendant 92 is lightweight, is worn usually, and has high portability. Therefore, it is realized that the agent system 50 is used in various scenes such as a home, a workplace, and a place outside the house. The smart pendant 92 is more suitable by collecting the life log of the user 10, and can thus collect the emotion value of the user 10 in various scenes, and the agent system 50 can provide a service or speech content suitable for the emotion of the user 10.

### Second Embodiment

Next, a second embodiment will be described while omitting or simplifying an overlapping portion with the above embodiment. The second embodiment is characterized in that an agent system 50 purchases a product on the basis of a budget received from a user 60 and a history of products acquired by the user 60.

Here, the “budget” is a budget for cash, electronic money, virtual currency, points, or the like as a settlement means. The “budget” may be a budget of any payment method such as a pre-payment method (prepaid type), a post-payment method (post-payment type), or an immediate payment method (debit type). The term “acquisition” includes purchase, rental, and contract, and “products” include both articles and services.

In the second embodiment, a case in which the agent system 50 purchases an article with prepaid electronic money will be described.

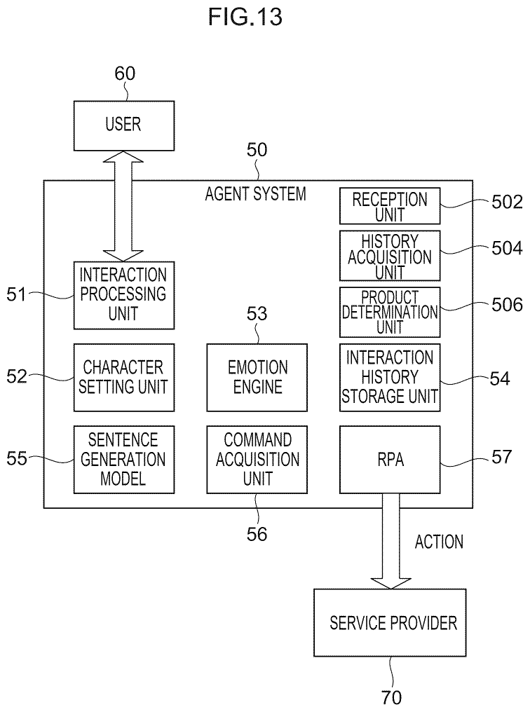

FIG. 13 is a diagram schematically illustrating an example of a functional configuration of the agent system 50 according to the second embodiment. As described above, the agent system 50 is configured by using some or all of the functions of the action control system illustrated in FIG. 2.

As illustrated in FIG. 13, the agent system 50 of the present embodiment includes a reception unit 502, an acquisition unit 504, and a product determination unit 506 in addition to the functional configuration of the above-described embodiment.

The reception unit 502 of the present embodiment has a function of receiving an amount of electronic money that can be used to purchase an article. Specifically, the reception unit 502 receives the amount of electronic money charged by the user 60. As an example, the reception unit 502 receives an amount of “10,000 yen” charged by the user 60 as the available electronic money. The amount of electronic money is an example of a “budget” in the disclosure.

The history acquisition unit 504 of the present embodiment has a function of acquiring a purchase history in which articles purchased by the user 60 in the past are recorded. Specifically, the acquisition unit 504 acquires the purchase history from the history data 222 (see FIG. 2) in the storage unit 220. As an example, the history acquisition unit 504 acquires a list of an item of an article purchased by the user 60, a purchase date, a purchase quantity, an emotion value of the user 60, and the like. The purchase history is an example of “history information” in the disclosure.

The product determination unit 506 of the present embodiment has a function of determining an article to be purchased on the basis of the amount of electronic money and the purchase history. As an example, the product determination unit 506 determines articles to be purchased in descending order of purchase frequency so that the total amount falls within the range of 10,000 yen. In a case in which an emotion value of the user 60 for a purchased article is recorded in the purchase history, the product determination unit 506 may determine an article to be purchased on the basis of the emotion value of the user 60. The product determination unit 506 may determine the quantity of articles to be purchased.

The product determination unit 506 has a function of determining an article to be purchased on the basis of the emotion value of the agent. Specifically, the product determination unit 506 determines an article to be purchased on the basis of the emotion value of the agent determined by the emotion engine 53. As an example, the product determination unit 506 determines an article to be purchased by using the reaction rule 221 (see FIG. 2) of the storage unit 220.

In the reaction rule 221 in the present embodiment, an article to be purchased is defined according to a combination of the past emotion value and the current emotion value of the user 60, the emotion value of the agent, and the action of the user 60. That is, the reaction rule 221 in the present embodiment is characterized in that an article to be purchased is defined instead of the action of the robot 100 defined in the first embodiment. For example, in a case in which the past emotion value of the user 60 is a positive value, the current emotion value is a negative value, and the action of the user 60 is gloomy, an article for encouraging the user 60 is defined as the article to be purchased by the agent. Examples of the article for encouraging the user 60 include a favorite food of the user 60, a doll of a favorite character of the user 60, and a product of a favorite artist of the user 60.

For example, the articles to be purchased defined in the reaction rule 221 include the following (1) to (10).
(1) An article for congratulating a user
(2) Article for apology to a user
(3) An article for expressing gratitude to a user
(4) An article for making a user laugh
(5) An article for distracting a user
(6) An article for comforting a user
(7) An article for solving a problem of a user
(8) An article for entertaining a user
(9) An article for annoying a user
(10) An article for reassuring a user

For example, a specific article name determined by analyzing the history data 222 and the interaction history storage unit 54 is registered in the article defined in the reaction rule 221. For example, “strawberry shortcake” is registered as “(1) an article for congratulating the user”, and “box of sweets” is registered as “(2) an article for apology to the user”. The registered article name may be updated every certain period.

In a case in which the article to be purchased is not registered in the reaction rule 221 or in a case in which the emotion value of the agent is a negative value, the product determination unit 506 need not determine an article to be purchased. As an example, in a case in which the emotion of the agent is “dislike”, “anger”, “not forgivable”, “hated”, or the like, the product determination unit 506 does not determine an article to be purchased. In a case in which the emotion of the agent becomes “happy” because the agent is complimented by the user 60, the product determination unit 506 determines “an article for expressing gratitude to the user” as an article to be purchased. In a case in which the emotion of the agent becomes “gloomy” because the agent is reprimanded by the user 60, the product determination unit 506 determines “an article for apology to the user” as an article to be purchased.

The RPA 57 of the present embodiment has a function of performing an action related to purchase of the determined article. Specifically, the RPA 57 purchases an article from an online shopping site by using the amount of received electronic money, the article name registered in the reaction rule 221 of the article to be purchased, and the API. The RPA 57 does not need to purchase all the articles determined by one purchase.

The RPA 57 of the present embodiment has a function of performing an action related to purchase of an article at a predetermined timing. Specifically, the RPA 57 performs the action in a case in which the emotion value of the agent becomes a predetermined numerical value or more. As an example, in a case in which the emotion value of “pleasant” of the agent becomes 4 or more, the RPA 57 performs an action related to purchase of an article for entertaining the user. The case in which the emotion value of the agent is a predetermined numerical value or more is an example of “predetermined timing”. Examples of the predetermined timing include a timing at which the emotion value of the user becomes a predetermined numerical value or more, and a timing at which a purchase instruction is given from the user.

The RPA 57 of the present embodiment has a function of transmitting a reason for determining an article to be purchased to the user 60. Specifically, the RPA 57 inputs, to the sentence generation model 55, on what basis the product determination unit 506 has determined an article to be purchased, and transmits the reason to the user 60 by using text generated as a message for the user 60. As an example, a case will be described in which since the user 60 is happy to have a birthday, the emotion of the agent is “happy”, and the product determination unit 506 determines to purchase “an article for congratulating the user”. In this case, the RPA 57 inputs text “Happy Birthday!” to a gift message field of an online shopping site. As another example, a case will be described in which the emotion of the agent becomes “gloomy” because the agent is reprimanded by the user 60, and the product determination unit 506 determines to purchase “an article for apology to the user”. In this case, the RPA 57 describes a message “Sorry. This is an article for apology.” in the text of an email and transmits the message, or transmits the message to the user 60 through an interaction.

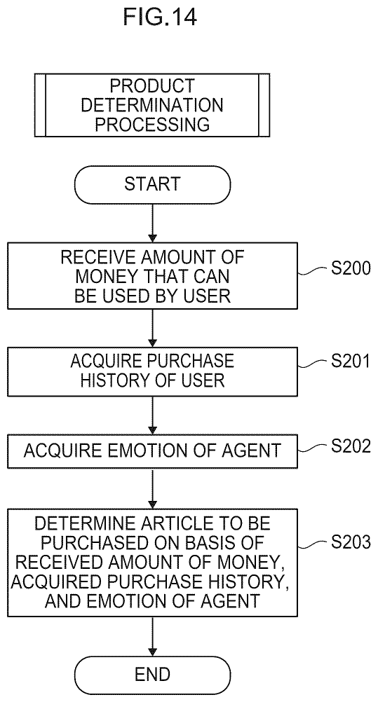

FIG. 14 is a flowchart illustrating an example of a flow of product determination processing in which the agent system 50 determines an article to be purchased according to the second embodiment.

In step S200 in FIG. 14, the agent system 50 receives an amount of money that can be used by the user 60. As an example, the agent system 50 receives the amount of electronic money charged by the user 60.

In step S201, the agent system 50 acquires a purchase history of the user 60. Specifically, the agent system 50 acquires the purchase history of the user 60 from the history data 222.

In step S202, the agent system 50 acquires an emotion of the agent. In the agent system 50, specifically, the emotion determination unit 232 determines the emotion of the agent on the basis of the state of the user 60 acquired by the user state recognition unit 230.

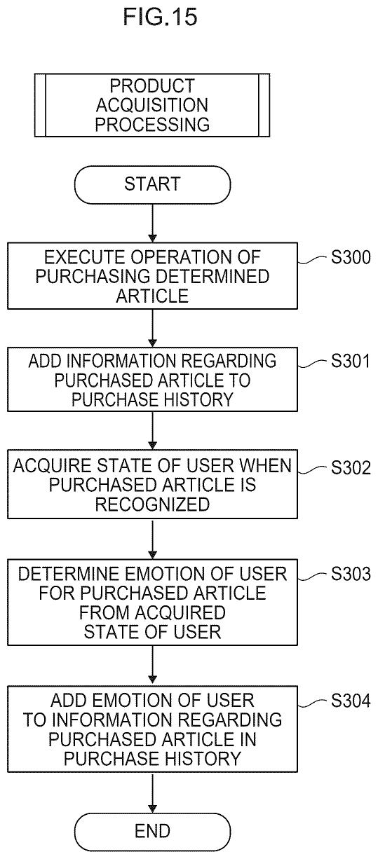

In step S203, the agent system 50 determines an article to be purchased on the basis of the received amount of money, the acquired purchase history, and the emotion of the agent. The agent system 50 ends the product determination processing. The agent system 50 may proceed to product acquisition processing illustrated in FIG. 15 that will be described later after the product determination processing.

FIG. 15 is a flowchart illustrating an example of a flow of product acquisition processing in which the agent system 50 purchases an article according to the second embodiment. After the product determination processing, the agent system 50 executes the product acquisition processing at a predetermined timing.

In step S300 in FIG. 15, the agent system 50 executes an operation of purchasing the determined article. Specifically, the agent system 50 purchases the article determined in step S203 in FIG. 14. Specifically, the agent system 50 causes the RPA 57 to purchase an article from an online shopping site by using the amount of electronic money, the determined article, and the API.

In step S301 in FIG. 15, the agent system 50 adds the information regarding the purchased article to the purchase history. Specifically, the agent system 50 causes the storage control unit 238 to add information regarding the purchased article to the purchase history of the history data 222.

In step S302, the agent system 50 acquires the state of the user 60 at the time of recognizing the purchased article. Specifically, the agent system 50 causes the user state recognition unit 230 to acquire the state of the user 60.

In step S303, the agent system 50 determines an emotion of the user 60 for the purchased article from the acquired state of the user 60. Specifically, the agent system 50 causes the emotion determination unit 232 to determine the emotion of the user 60.

In step S304, the agent system 50 adds the emotion of the user 60 to the information regarding the purchased article stored in the purchase history. Specifically, the agent system 50 causes the storage control unit 238 to add the information regarding the purchased article and the emotion value of the user 60 to the purchase history of the history data 222 in association with each other. The agent system 50 ends the product acquisition processing.

### Summary of Second Embodiment

The agent system 50 of the second embodiment purchases an article determined on the basis of the electronic money received from the user 60 and the purchase history of the user 60. That is, the agent system 50 can purchase an article purchased in the past by the user 60. That is, since the agent system 50 purchases, on behalf of the user 60, an article that the user 60 regularly purchases, it is possible to save the trouble of the user 60 purchasing the article.

Meanwhile, the agent system 50 can purchase an article that the user 60 has not purchased in the past. That is, the agent system 50 can provide the user 60 with a new experience by purchasing, on behalf of the user 60, an article that has not been purchased by the user 60.

The agent system 50 of the second embodiment determines an article to be purchased on the basis of a purchase history in which a purchased article and an emotion of the user 60 for the article are recorded. Therefore, the agent system 50 can reflect the past emotion of the user 60 for the purchased article in the determination of an article to be purchased. That is, the agent system 50 can purchase an article that the user 60 has felt favorable and does not need to purchase an article that the user 60 is indifferent to.

The agent system 50 of the second embodiment determines an article to be purchased on the basis of an emotion of the agent. Thus, the agent system 50 can determine whether or not to purchase an article according to the emotion of the agent, or can change an article to be purchased. The agent system 50 can express the emotion of the agent by using the article to be purchased. That is, the agent system 50 can communicate with the user 60 through the purchased article.

The agent system 50 of the second embodiment transmits a message related to the purchased article to the user 60. Therefore, the user 60 can ascertain the emotion of the agent through the message. The agent system 50 can notify the user 60 that an article has been purchased in accordance with the emotion of the user 60.

### Modification 1 of Second Embodiment

In the second embodiment, an emotion of the agent is used to determine an article to be purchased. In Modification 1, a surrounding situation of the user 60 is used to determine an article to be purchased. In the second embodiment, an article is purchased by using prepaid electronic money, but in Modification 1 of the second embodiment, a case of purchasing an article by using a credit card will be described. In Modification 1, the portion described as the “amount of electronic money” in the above description except for a special description is replaced with a “limit amount of credit card settlement”. Hereinafter, content unique to Modification 1 will be described.

In Modification 1, the user state recognition unit 230 illustrated in FIG. 2 has a function of acquiring an image of a surrounding situation of the user 60 and recognizing the surrounding situation. Specifically, the user state recognition unit 230 acquires the image via the 2D camera 203 of the sensor unit 200. The user state recognition unit 230 applies a known image recognition technology to the image to estimate the quantity of each article captured in the image. The image of the surrounding situation of the user 60 is an example of “information regarding the surrounding situation of the user” in the disclosure, and the quantity of each article is an example of “information regarding a stock of each product” in the disclosure.

As an example, in a case in which the user state recognition unit 230 recognizes a place where articles that are used daily by the user 60 such as a refrigerator or a pantry are stored, the user state recognition unit 230 acquires an image of the place and estimates the quantity of each article stored in the place. The image of the refrigerator or the pantry is an example of “image information” in the disclosure.

In Modification 1, the reception unit 502 illustrated in FIG. 13 has a function of receiving a limit amount of credit card settlement that can be used for purchase of an article. Specifically, the reception unit 502 receives the limit amount input by the user 60. As an example, the reception unit 502 receives an amount of money for which signature-free settlement is possible. The limit amount of the credit card settlement is an example of a “budget” in the disclosure.

The product determination unit 506 in Modification 1 has a function of determining an article to be purchased on the basis of an image of a surrounding situation of the user 60. Specifically, the product determination unit 506 has a function of determining an article to be purchased on the basis of the quantity of each article estimated by the user state recognition unit 230. As an example, in a case in which the estimated quantity of articles is less than the minimum quantity of articles set by the user 60, the product determination unit 506 determines the article as an article to be purchased.

In a case in which the estimated quantity of articles is less than the minimum quantity set by the user 60 continuously for a predetermined period, the RPA 57 in Modification 1 performs an action related to purchase of the article. Specifically, the RPA 57 determines whether or not to purchase the article by using the quantity of each article estimated by the user state recognition unit 230, the estimation date, and the minimum quantity set for each article. As an example, in a case in which the number of PET bottles of 500 mL-sized carbonated water falls below twelve continuously for seven days, the RPA 57 purchases 24 PET bottles of the carbonated water (for one box of cardboard). Twelve that is the minimum quantity set by the user 60 is an example of a “predetermined threshold” in the disclosure, and seven days is an example of a “predetermined period” in the disclosure. After performing the action related to purchase of an article, the RPA 57 need not purchase the article until the purchased article arrives.

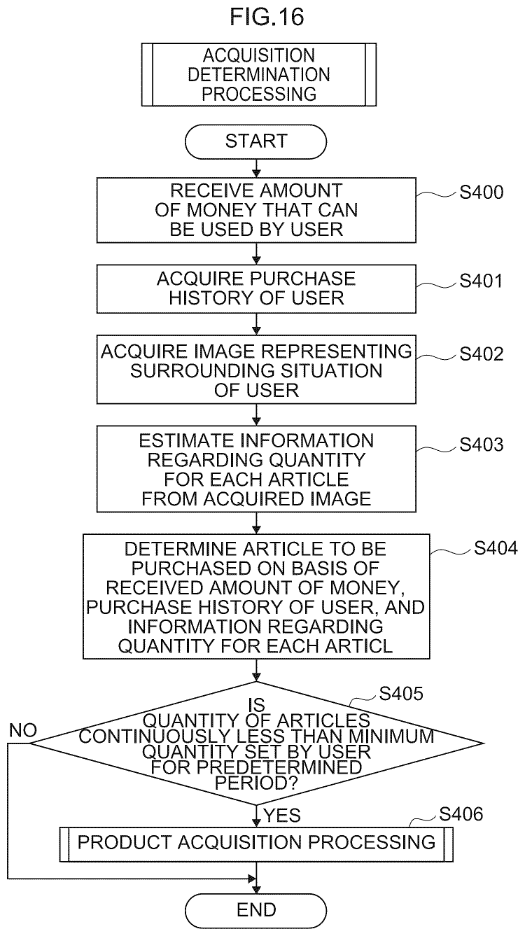

FIG. 16 is a flowchart illustrating an example of a flow of acquisition determination processing in which the agent system 50 according to Modification 1 of the second embodiment determines whether or not to purchase an article.

In step S400 in FIG. 16, the agent system 50 receives an amount of money that can be used by the user 60. As an example, the agent system 50 receives a credit card limit amount set by the user 60.

In step S401, the agent system 50 acquires a purchase history of the user 60. Specifically, the agent system 50 acquires the purchase history of the user 60 from the history data 222.

In step S402, the agent system 50 acquires an image indicating a surrounding situation of the user 60. Specifically, the agent system 50 acquires the image from the sensor unit 200.

In step S403, the agent system 50 estimates information regarding the quantity of each article from the acquired image. Specifically, the agent system 50 causes the user state recognition unit 230 to estimate the quantity of each article captured in the image.

In step S404, the agent system 50 determines an article to be purchased on the basis of the received amount of money, the purchase history of the user, and the information regarding the quantity for each article.

In step S405, the agent system 50 determines whether or not the quantity of articles is less than the minimum quantity set by the user continuously for a predetermined period. In a case in which the agent system 50 determines that the quantity of articles is less than the minimum quantity set by the user continuously for the predetermined period (step S405: YES), the processing proceeds to step S406. In a case in which the agent system 50 determines that the quantity of articles is not less than the minimum quantity set by the user continuously for the predetermined period (step S405: NO), the acquisition determination processing is ended.

In step S406, the agent system 50 executes the product acquisition processing illustrated in FIG. 15. The agent system 50 ends the acquisition determination processing.

### Summary of Modification 1 of Second Embodiment

The agent system 50 of Modification 1 determines an article to be purchased on the basis of a surrounding situation of the user 60. Therefore, the agent system 50 can change an article to be purchased according to a change in the surrounding situation of the user 60. Since an instruction of the user 60 is unnecessary in a case in which the agent system 50 purchases the article, the agent system 50 can purchase the article according to the change even in a case in which the user 60 does not notice the change in the surrounding situation.

The agent system 50 of Modification 1 determines an article to be purchased on the basis of a quantity of articles estimated from an image obtained by imaging a surrounding situation of the user 60. Therefore, the agent system 50 can change an article to be purchased according to the quantity of articles owned by the user 60. That is, the agent system 50 does not need to purchase an article having a sufficient quantity.

The agent system 50 of Modification 1 purchases the article at a timing at which the quantity of articles estimated from a video obtained by imaging the surrounding situation of the user 60 falls below a predetermined threshold continuously for a predetermined period. That is, the agent system 50 can purchase the article so that the stock of the article does not run out. That is, the agent system 50 can save the trouble of the user 60 who checks the quantity of articles and purchases an article that is likely to be insufficient.

### Modification 2 of Second Embodiment

In the second embodiment, an emotion of the agent is used to determine an article to be purchased. In Modification 2, information received from the user 60 is used to determine a service to be contracted. In the second embodiment, an article is purchased by using prepaid electronic money, but in Modification 2 of the second embodiment, a case in which a service is to be contracted with a point balance given to the user 60 will be described. In Modification 2, the portion described as the “amount of electronic money” and the “limit amount of credit card settlement” in the above description except for the case of special description is replaced with the “balance of points”. In Modification 2, except for the case of special description, the portion described as the “article” in the above description is replaced with a “service”, and the portion described as “purchase” is replaced with “contract”. Hereinafter, contents unique to Modification 2 will be described.

In Modification 2, the reception unit 502 illustrated in FIG. 13 has a function of receiving a balance of points that can be used for a service contract. Specifically, the reception unit 502 receives the balance input by the user 60 from the total amount of points owned by the user 60. As an example, the reception unit 502 receives a balance of “10,000 pt” out of the points owned by the user 60. The service contract is an example of “product acquisition” in the disclosure, and the balance of points is an example of a “budget” in the disclosure.

The reception unit 502 of Modification 2 has a function of receiving at least one of information regarding a service category or information regarding a preference of the user 60. Specifically, the reception unit 502 of Modification 2 presents a plurality of service categories and a plurality of preferences to the user 60 as options, and receives a service category and a preference selected by the user 60.

The plurality of service categories presented by the reception unit 502 include, for example, the following categories.
(1) Moving image
(2) Music
(3) Book/electronic book
(4) Game
(5) Home appliance/digital device
(6) Sports
(7) Beauty
(8) Healthcare/dieting
(9) Fashion
(10) Housing related category
(11) Eating and drinking related category
(12) Leisure

The plurality of preferences presented by the reception unit 502 are items obtained by subdividing each category. An item obtained by subdividing each category will be described by using the case of “(1) moving image” as an example. Items obtained by subdividing the category of “(1) moving image” are, for example, a “movie”, a “drama”, an “animation”, and a “variety”. The reception unit 502 may present a “comedy”, an “action”, a “horror”, a “romance”, a “fantasy”, an “SF”, a “documentary”, and the like, which are items obtained by further subdividing a “movie”. The reception unit 502 may present a “movie director”, a “release year”, “cast”, a “target age”, and the like, which are items obtained by subdividing a “movie” from another viewpoint.

The history acquisition unit 504 according to Modification 2 has a function of acquiring a contract history in which services contracted by the user 60 in the past are recorded. Specifically, the acquisition unit 504 acquires the contract history from the history data 222 of the storage unit 220. As an example, the history acquisition unit 504 acquires a list of items of services contracted by the user 60, contract dates, contracted quantities, emotion values of the user 60, and the like. The contract history is an example of “history information” in the disclosure.

The product determination unit 506 in Modification 2 has a function of determining a service to be contracted on the basis of the information received by the reception unit 502. Specifically, the product determination unit 506 determines a service suitable for the preference of user 60 from the category selected by user 60. As an example, the product determination unit 506 determines a viewing service of a movie of a favorite movie director of the user 60 from the category of the moving image. The moving image is an example of “information regarding a category of a product” in the disclosure, and the director whom the user 60 likes is an example of “information regarding a preference of a user” in the disclosure.

The product determination unit 506 has a function of determining an article to be purchased on the basis of the balance of points and the contract history. As an example, the product determination unit 506 determines services to be contracted in descending order of contract frequency so that the total points fall within the range of 10,000 pt. In a case in which an emotion value of the user 60 for a contracted service is recorded in the contract history, the product determination unit 506 may determine a service to be contracted on the basis of the emotion value of the user 60.

The RPA 57 of Modification 2 performs an action related to the determined service contract. As an example, the RPA 57 makes a service contract at a providing site that provides the service by using the point balance input by the user 60, the determined service, and the API. As an example, the RPA 57 makes a contract to allow the user 60 to view a movie of a favorite movie director at a site that provides a movie viewing service. In a case in which the agreement of the user 60 is required in the contract, the RPA 57 performs an action related to the contract except for the procedure related to the agreement of the user 60.

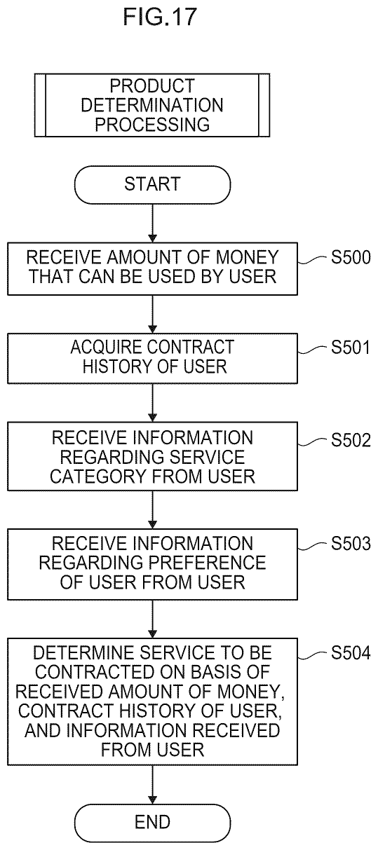

FIG. 17 is a flowchart illustrating an example of a flow of product determination processing in which the agent system 50 according to Modification 2 of the second embodiment determines a service to be contracted.

In step S500 in FIG. 17, the agent system 50 receives an amount of money that can be used by the user 60. As an example, the agent system 50 receives a balance of points that can be used by the agent system 50 from the total amount of points owned by the user 60.

In step S501, the agent system 50 acquires the contract history of the user 60. Specifically, the agent system 50 acquires the contract history of the user 60 from the history data 222.

In step S502, the agent system 50 receives information regarding the category of the service from the user 60. Specifically, the agent system 50 receives the information when the category presented by the reception unit 502 is selected by the user 60.

In step S503, the agent system 50 receives information regarding the preference of the user 60 from the user 60. Specifically, the agent system 50 receives the information by the user 60 selecting an item obtained by subdividing each category presented by the reception unit 502.

In step S504, the agent system 50 determines a service to be contracted on the basis of the received amount of money, the contract history of the user 60, and the information received from the user 60. The agent system 50 ends the product determination processing. The agent system 50 may proceed to the product acquisition processing illustrated in FIG. 15 after the product determination processing.

### Summary of Modification 2 of Second Embodiment

The agent system 50 of Modification 2 determines a service to be contracted on the basis of at least one of information regarding a category of the service and information regarding a preference of the user 60. That is, the agent system 50 can contract the service on the basis of the setting of the user 60. That is, the agent system 50 can contract a service suitable for the preference of the user 60.

### Remarks

In the first and second embodiments, the emotion determination unit 232 determines the emotion value indicating the emotion of the user 60 and the emotion value of the agent itself on the basis of the information analyzed by the sensor module unit 210 and the state of the user 60 recognized by the user state recognition unit 230. However, the state of the user 60 is not necessarily acquired. Therefore, the emotion determination unit 232 may determine an emotion value indicating the emotion of the user 60 and an emotion value of the agent itself on the basis of the interaction history between the user 60 and the agent. The interaction history may be stored in either the interaction history storage unit 54 or the history data 222.

In the second embodiment, as an example, the reception unit 502 receives the amount of electronic money charged by the user 60, but a method of receiving a budget is not limited thereto. For example, the reception unit 502 may automatically receive points acquired by the user through shopping or the like, or automatically receive an amount of money set by the user every month.

In the second embodiment, the product determination unit 506 determines an article to be purchased on the basis of the reaction rule 221, but a method of determining an article is not limited thereto. For example, the product determination unit 506 determines an article according to the level of the emotion value of the agent. As an example, the product determination unit 506 determines an article to be purchased as an expensive article as the emotion value of the agent increases.

In the second embodiment, the agent system 50 causes the user 60 to perform a procedure regarding the procedure that the user 60 needs to perform. For example, the agent system 50 checks whether or not the user 60 gives agreement or input regarding settlement, contract, or the like that requires agreement or input of the user 60.

In Modification 1 of the second embodiment, the agent system 50 acquires the image of the surrounding situation of the user from the sensor unit 200, but acquisition means of the image is not limited thereto. In a case in which the agent system 50 is mounted on the smart glasses 72 illustrated in FIG. 10, the image may be acquired via the camera 86.

In Modification 1 of the second embodiment, the agent system 50 purchases the article in a case in which the quantity of the articles is less than the minimum quantity set by the user 60 continuously for a predetermined period, but a purchase timing of the article is not limited thereto. The agent system 50 may immediately purchase the article in a case in which the quantity of the article falls below the minimum quantity.

In Modification 1 of the second embodiment, as an example, the agent system 50 purchases the article in a case where the quantity of the article falls below the predetermined threshold continuously for seven days, but it is not always necessary to recognize the quantity of the articles continuously for seven days. For example, in a case in which the agent system 50 recognizes that the quantity of the articles is insufficient on the first day and then recognizes that the quantity of the articles is insufficient on the eighth day, it can be regarded that the quantity is below the predetermined threshold continuously for seven days.

### Third Embodiment

Next, a third embodiment will be described while omitting or simplifying an overlapping portion with the above embodiments. The third embodiment is characterized in that the agent system 50 outputs information regarding a position of an object necessary for realizing a proposal to the user 60.

Hereinafter, a case in which the agent system 50 of the present embodiment outputs a name and position of a necessary ingredient to the smart glasses 72 (see FIG. 10) will be described.

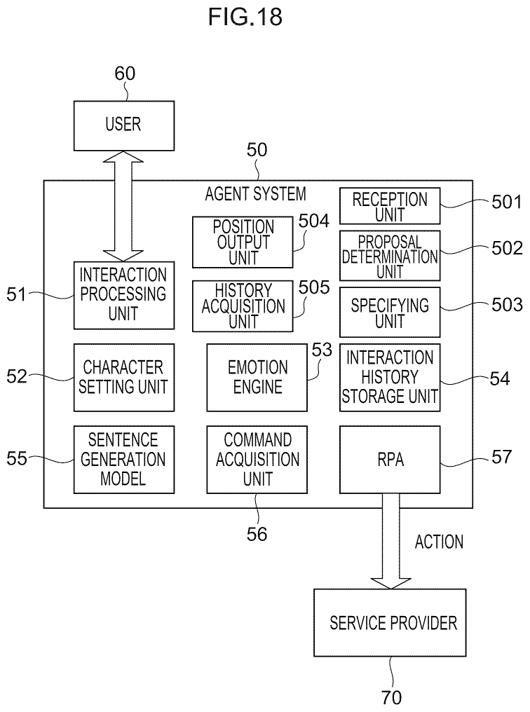

FIG. 18 is a diagram schematically illustrating an example of a functional configuration of the agent system 50 according to the third embodiment. As described above, the agent system 50 is configured by using some or all of the functions of the action control system illustrated in FIG. 2.

The user state recognition unit 230 of the present embodiment illustrated in FIG. 2 has a function of acquiring a video of a surrounding situation of the user 60 and recognizing the surrounding situation. Specifically, the user state recognition unit 230 acquires a video of a surrounding situation of the user 60 via the 2D camera 203 of the sensor unit 200. The user state recognition unit 230 applies a known image recognition technology to the video of the surrounding situation of the user 60 to estimate information regarding an object captured in the video. The video of the surrounding situation of the user 60 is an example of “image information regarding the surrounding situation of the user”.

As illustrated in FIG. 18, the agent system 50 of the present embodiment includes a reception unit 501, a proposal determination unit 502, a specifying unit 503, a position output unit 504, and a history acquisition unit 505 in addition to the functional configuration of the first embodiment described above, similarly to the second embodiment. The history acquisition unit 505 will be described in a modification of the third embodiment that will be described later.

The reception unit 501 of the present embodiment has a function of receiving words/phrases indicating names and seasonings of ingredients. Specifically, the reception unit 501 receives a word/phrase input from the user 60. As an example, the reception unit 501 receives words/phrases of “pork” and “salty-sweet” included in the vocal sound of the user 60 input via the microphone 84 (see FIG. 10) of the smart glasses 72. The name of the ingredient is an example of a “keyword indicating a target desired by the user”. The word/phrase indicating the seasoning is an example of a “concept word indicating the directionality of the keyword”.

The proposal determination unit 502 of the present embodiment has a function of determining content to be proposed to the user 60. Specifically, the proposal determination unit 502 inputs a word/phrase indicating the name and the seasoning of the ingredient received by the reception unit 501 to the sentence generation model 55. The proposal determination unit 502 determines a recipe output from the sentence generation model 55 as content to be proposed to the user 60. As an example, the proposal determination unit 502 inputs words/phrases of “pork” and “salty-sweet” to the sentence generation model 55. The proposal determination unit 502 determines the recipe of “stir-fried pork and kimchi” generated by the sentence generation model 55 as content to be proposed to the user 60. The content to be proposed is an example of “proposal information”.

The specifying unit 503 of the present embodiment has a function of specifying a necessary object that is an object required by the user 60 in order to realize the proposal determined by the proposal determination unit 502. Specifically, the specifying unit 503 specifies a necessary object by using the sentence generation model 55. As an example, the specifying unit 503 inputs text “Extract necessary ingredients from the recipe” to the sentence generation model 55 and acquires a list of names of necessary ingredients from the sentence generation model 55. The necessary object is an example of a “thing”.

The position output unit 504 of the present embodiment has a function of acquiring and outputting information regarding a position of an object captured in a video. Specifically, the position output unit 504 acquires information regarding the position measured by using at least one of the 3D depth sensor 202, the 2D camera 203, or the distance sensor 204 of the sensor unit 200 illustrated in FIG. 2. As an example, the position output unit 504 in FIG. 18 acquires a distance and a direction from the position of the user 60 to the position of “pork” captured in the video.

In a case in which the necessary object specified by the specifying unit 503 is captured in the video of the surrounding situation of the user 60 acquired by the user state recognition unit 230 (see FIG. 2), the position output unit 504 outputs information regarding the position of the necessary object. As an example, the position output unit 504 outputs the distance and the direction to the position of “pork” to the display 76 (see FIG. 10) of the smart glasses 72. Whether or not the object captured in the video is a necessary object may be determined by using a known image recognition technology.

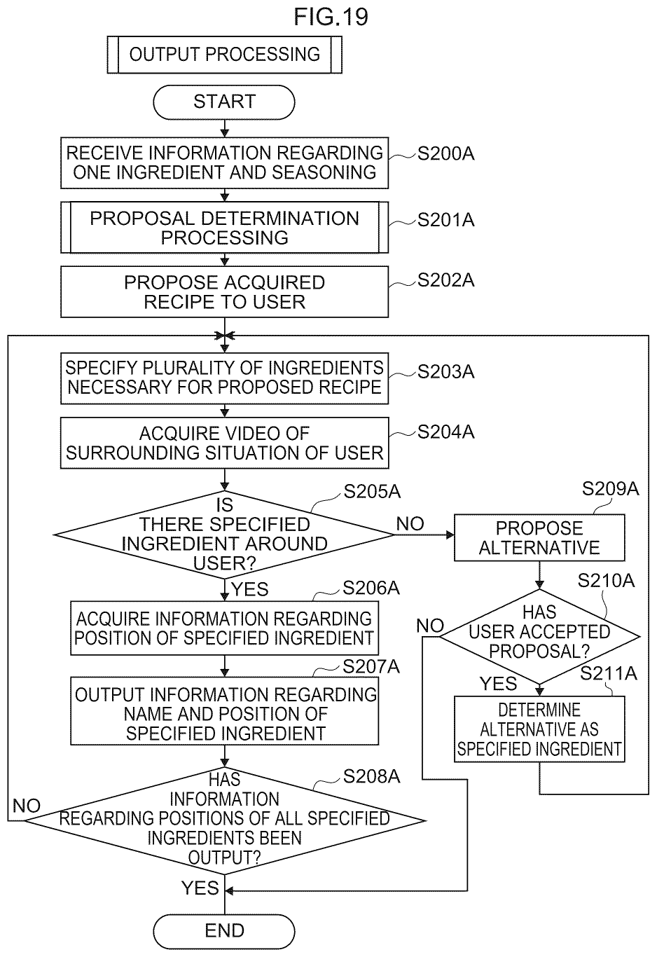

FIG. 19 is a flowchart illustrating an example of a flow of output processing in which the agent system 50 according to the third embodiment outputs information regarding a position of a necessary object.

In step S200A in FIG. 19, the agent system 50 receives information regarding one ingredient and seasoning thereof. Specifically, the agent system 50 receives an input from the user 60. As an example, the agent system 50 receives, as an input, vocal sound of the user 60 such as “I want to make a salty-sweet dish using pork”.

In step S201A, the agent system 50 executes proposal generation processing that will be described later. The agent system 50 acquires a recipe based on one ingredient and seasoning thereof by executing the proposal generation processing.

In step S202A, the agent system 50 proposes the acquired recipe to the user 60. As an example, the agent system 50 outputs a recipe of “stir-fried pork and kimchi” as letter information to the display 76 (see FIG. 10) of the smart glasses 72.

In step S203A, the agent system 50 specifies a plurality of ingredients necessary for the proposed recipe. Specifically, the agent system 50 specifies a plurality of ingredients by using the sentence generation model 55. As an example, the agent system 50 specifies “pork”, “Kimchi”, “garlic”, “ginger”, “sesame”, “green onion”, and the like as necessary ingredients.

In step S204A, the agent system 50 acquires a video of a surrounding situation of the user 60. As an example, the agent system 50 acquires a video of the surroundings of the user 60 from the 2D camera 203 (see FIG. 2).

In step S205A, the agent system 50 determines whether or not there is the specified ingredient around the user 60. In a case in which it is determined that there is no specified ingredient (step S205A: NO), the agent system 50 proceeds to step S209A. On the other hand, in a case in which it is determined that the specified ingredient is present (step S205A: YES), the agent system 50 proceeds to step S206A. A condition that a predetermined time elapses before the agent system 50 determines that there is no specified ingredient may be used.

In step S206A, the agent system 50 acquires information regarding the position of the specified ingredient. Specifically, the agent system 50 acquires information regarding the position of the specified ingredient on the basis of the information acquired from the 3D depth sensor 202 and the 2D camera 203. As an example, the agent system 50 acquires a distance and a direction to a place where there is pork.

In step S207A, the agent system 50 outputs information regarding the name and the position of the specified ingredient. Specifically, the agent system 50 outputs the information regarding the name and the position of the specified ingredient on the display 76 (see FIG. 10) of the smart glasses 72. As an example, the agent system 50 outputs text such as “pork” and “10 m in the diagonal right direction”.

In step S208A, the agent system 50 determines whether or not information regarding positions of all the specified ingredients has been output. In a case in which it is determined that the information regarding the positions of all the specified ingredients has been output (step S208A: YES), the agent system 50 ends the output processing. On the other hand, in a case in which it is determined that the information regarding the positions of all the specified ingredients has not been output (step S208A: NO), the agent system 50 returns to step S204A.

In step S209A, the agent system 50 proposes an alternative. The agent system 50 specifically proposes an alternative to the specific ingredient determined not to be around the user 60. As an example, the agent system 50 inputs a text “What is an alternative to pork?” to the sentence generation model 55, acquires the output name of the alternative, and proposes the alternative to the user 60.

In step S210A, the agent system 50 determines whether or not the user 60 has accepted the proposal. Specifically, the agent system 50 determines whether or not the user 60 has accepted the proposal in step S209. In a case in which it is determined that the user 60 has accepted the proposal (step S210: YES), the agent system 50 proceeds to step S211. On the other hand, in a case in which it is determined that the user 60 has not accepted the proposal (step S210A: NO), the agent system 50 ends the output processing.

In step S211A, the agent system 50 determines the alternative as the specified ingredient. Specifically, in step S205A, the agent system 50 determines, as the specific ingredient, the alternative accepted in step S210A instead of the ingredient determined not to be around the user 60. The agent system 50 returns to step S204.

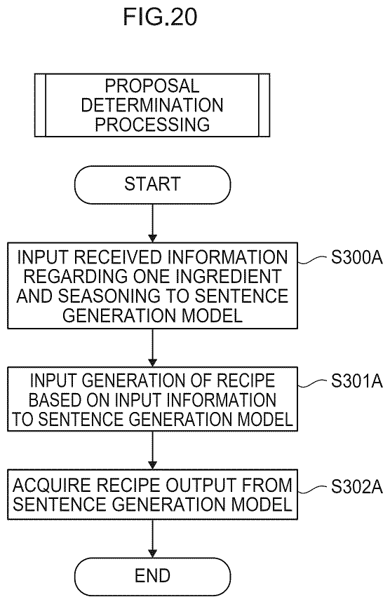

FIG. 20 is a flowchart illustrating an example of a flow of proposal determination processing of determining a proposal by using the sentence generation model 55 according to the third embodiment.

In step S300A in FIG. 20, the agent system 50 inputs the received information regarding one ingredient and seasoning thereof to the sentence generation model 55. As an example, the agent system 50 inputs text such as “Please memorize the word/phrase to be input from now. “Pork” and “salty-sweet“ ” to the sentence generation model 55.

In step S301A, the agent system 50 inputs generation of a recipe based on the input information to the sentence generation model 55. As an example, the agent system 50 inputs, to the sentence generation model 55, text indicating an output instruction such as “Output a recipe of a dish on the basis of the input ingredient and seasoning”.

In step S302A, the agent system 50 acquires the recipe output from the sentence generation model 55. The agent system 50 ends the proposal generation processing.

### Summary of Third Embodiment

The agent system 50 of the third embodiment displays a proposal on the basis of information input from the user 60. That is, the agent system 50 can embody and display the desire of the user 60 estimated from the input information. In other words, the agent system 50 enables the user 60 to recognize what the user 60 desires.

The agent system 50 of the third embodiment displays the position of the necessary object required by the user 60, proposed by the agent system 50 in a case in which there is the necessary object around the user 60. That is, the agent system 50 allows the user 60 to recognize that there is a necessary object nearby. That is, the agent system 50 can reduce the possibility that the user 60 overlooks the necessary object. The agent system 50 enables the user 60 to save time and effort to search for a necessary object.

### Modification of Third Embodiment

In the third embodiment, the agent system 50 causes the sentence generation model 55 to generate a proposal for the user 60 on the basis of a word/phrase received from the user 60. In the modification, the sentence generation model 55 is caused to generate a proposal for the user 60 on the basis of the action history of the user 60 and the emotion of the user 60 in addition to the word/phrase received from the user 60. Hereinafter, contents unique to the modification will be described.

The history acquisition unit 505 of the present embodiment illustrated in FIG. 18 has a function of acquiring an action history in which an action performed by the user 60 in the past is recorded. Specifically, the history acquisition unit 505 acquires an action history of the user 60 from the history data 222 (see FIG. 2) in the storage unit 220. As an example, the history acquisition unit 505 acquires past emotion values and a history of actions of the user 60. The action history is an example of “history information”.

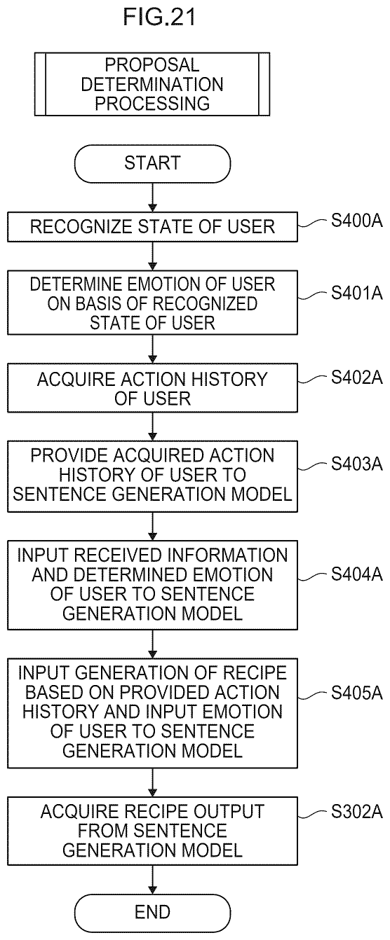

FIG. 21 is a flowchart illustrating an example of a flow of a proposal determination processing of determining a proposal by using the sentence generation model 55 according to the modification of the third embodiment.

In step S400A in FIG. 21, the agent system 50 recognizes a state of the user 60. Specifically, the agent system 50 causes the user state recognition unit 230 (see FIG. 2) to recognize the state of the user 60.

In step S401A, the agent system 50 determines an emotion of the user 60 on the basis of the recognized state of the user 60. Specifically, the agent system 50 causes the emotion engine 53 (see FIG. 18) to determine the emotion of the user 60. As an example, the agent system 50 determines the emotion of the user 60 as “gloomy”.

In step S402A, the agent system 50 acquires the action history of the user 60.

Specifically, the agent system 50 acquires the action history of the user 60 from the history data 222 included in the storage unit 220.

In step S403A, the agent system 50 provides the acquired action history of the user 60 to the sentence generation model 55. Specifically, the agent system 50 uploads the data of the action history of the user 60 to the sentence generation model 55. The agent system 50 can generate an answer with reference to the data of the action history when the data of the action history is uploaded.

In step S404A, the agent system 50 inputs the received information and the determined emotion of the user 60 to the sentence generation model 55. Specifically, the agent system 50 inputs the information received in step S200A (see FIG. 19) and the emotion of the user 60 determined in step S401A to the sentence generation model 55. As an example, the agent system 50 inputs text such as “Please memorize the word/phrase to be input from now. “pork”, “salty-sweet”, and “user's emotion is sad“ ” to the sentence generation model 55.

In step S405A, the agent system 50 inputs, to the sentence generation model 55, generation of a recipe based on the provided action history and the input emotion of the user 60. As an example, the agent system 50 inputs, to the sentence generation model 55, text indicating an instruction such as “Output a recipe of a dish on the basis of the uploaded action history and the current emotion of the user”. The agent system 50 proceeds to step S302A described above, and ends the proposal generation processing.

### Summary of Modification of Third Embodiment

The agent system 50 of the modification determines a proposal for the user 60 on the basis of the action history of the user 60 and the emotion of the user 60. That is, the agent system 50 can make a proposal reflecting the past action of the user 60 and the current emotion of the user 60. For example, the agent system 50 ascertains a tendency of wanting to eat a spicy dish when the user is emotionally depressed, and proposes a recipe of a spicy dish. The agent system 50 proposes a recipe of a dish that is good for digestion when it is determined that the user 60 reflected in the mirror is in poor physical condition due to a hangover or the like and looks distressed. In other words, the agent system 50 can make a proposal in accordance with the action history and the emotion of the user 60.

### Remarks

In the third embodiment, a case in which the reception unit 501 receives a word/phrase indicating the name and seasoning of an ingredient and the proposal determination unit 502 proposes a recipe has been described, but a word/phrase received by the reception unit 501 is not limited thereto. Table 3 below illustrates examples of combinations of keywords, concept words, and proposal information.

TABLE 3

| Keyword | Concept Word | Proposal Information |
|---|---|---|
| Shirt | Casual | Brand Information |
| Lunch | Healthy | Menu Information |
| Event | Pleasant | Festival Information |
| Plant | Easily Grown | Ornamental Plant Information |
| Harajuku | Delicious | Sweet Information in Harajuku |
| . . . | . . . | . . . |

In the third embodiment, the reception unit 501 receives an input based on the vocal sound of the user 60 as an example, but input means of the user 60 is not limited thereto. The reception unit 501 may receive an input based on text, an image, a video, or the like by the user 60.

In the third embodiment, the specifying unit 502 has a function of specifying a necessary object, but a specified target is not limited to an object. The specifying unit 502 may specify information required by the user. As an example, the specifying unit 502 specifies a route to a festival venue, the names of train stations where passengers get on and off, and the like. The information required by the user is an example of a “thing”.

In the third embodiment, the agent system 50 uses the list of the names of the ingredients as the information regarding the necessary object, but the present invention is not limited thereto. The information regarding the necessary object may be information regarding the necessary object represented by letters, images, videos, sounds, and the like.

In the third embodiment, as an example, the position output unit 504 acquires the distance and direction from the position of the user 60 to the position of “pork”, but acquired information regarding a position is not limited thereto. The position output unit 504 may acquire a distance and a direction to the position at which the related information appears. As an example, the position output unit 504 may acquire a distance and a direction to a signboard indicating that there is “pork”. A plurality of pieces of information regarding a position may be simultaneously displayed. The position output unit 504 may determine information to be displayed and information not to be displayed according to the degree of relevance between the necessary object and the object captured in the video.

In the third embodiment, the position output unit 504 outputs the information regarding the name and position of the specified ingredient, but output information is not limited thereto. The position output unit 504 may output information regarding specified ingredients such as nutrients of ingredients, compatible ingredients, and cooking methods. That is, the position output unit 504 can output information related to a necessary object when outputting information regarding a position.

In the third embodiment, the position output unit 504 outputs the information regarding the position of the necessary object to the display 76 of the smart glasses 72, but an output method is not limited thereto. The position output unit 504 may output the information regarding the position by vocal sound through, for example, a speaker provided in the electronic apparatus or an earphone worn by the user 60. The position output unit 504 may output information regarding a position by vibration.

In the third embodiment, the position output unit 504 acquires the information regarding the position of the necessary object by using at least one of the 3D depth sensor 202, the 2D camera 203, or the distance sensor 204, but acquisition means is not limited thereto. The position output unit 504 may acquire the information regarding the position by using the camera 86 of the smart glasses 72.

In the third embodiment, the agent system 50 provides the sentence generation model 55 with the action history data, but a method in which the sentence generation model 55 uses the action history data is not limited thereto. The sentence generation model 55 may use the action history data by directly referring to the action history data in the storage unit 220.

### Fourth Embodiment

Next, a fourth embodiment will be described while omitting or simplifying an overlapping portion with the above embodiments. The fourth embodiment is characterized in that the agent system 50 outputs information regarding a conversation partner on the basis of information regarding a face of the conversation partner.

Hereinafter, a case in which the agent system 50 of the present embodiment outputs the information regarding an interaction partner acquired on the basis of information regarding a face of the interaction partner to the smart glasses 72 (see FIG. 10) will be described. The interaction partner is an example of a “conversation partner”. The smart glasses 72 are an example of “smart glasses”.

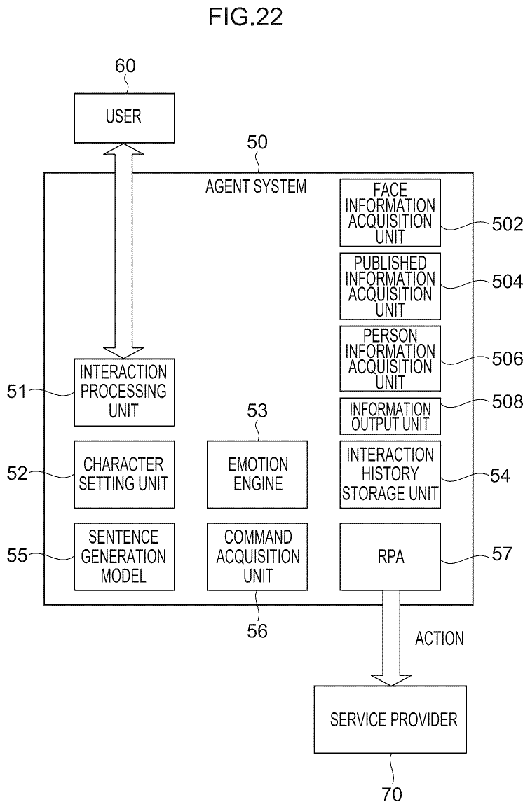

FIG. 22 is a diagram schematically illustrating an example of a functional configuration of an agent system 50 according to the fourth embodiment. As described above, the agent system 50 is configured by using some or all of the functions of the action control system illustrated in FIG. 2.

The sensor unit 200 of the present embodiment illustrated in FIG. 2 detects information regarding an interaction partner of the user 60.

The user state recognition unit 230 of the present embodiment recognizes a state of the interaction partner of the user 60 on the basis of the information analyzed by the sensor module unit 210. The user state recognition unit 230 is an example of a “state recognition unit”.

The emotion determination unit 232 of the present embodiment determines an emotion value indicating the emotion of the interaction partner on the basis of the information analyzed by the sensor module unit 210 and the state of the interaction partner recognized by the user state recognition unit 230. For example, the information analyzed by the sensor module unit 210 and the recognized state of the interaction partner are input to a neural network trained in advance, and an emotion value indicating the emotion of the interaction partner is acquired.

As illustrated in FIG. 22, the agent system 50 of the present embodiment includes a face information acquisition unit 502, a published information acquisition unit 504, a person information acquisition unit 506, and an information output unit 508 in addition to the functional configuration of the above-described embodiment.

The face information acquisition unit 502 has a function of acquiring face information. Specifically, the face information acquisition unit 502 acquires feature amount data indicating the feature amount of the face of the interaction partner of the user 60. As an example, the face information acquisition unit 502 acquires feature amount data of the face of the interaction partner measured by the sensor unit 200 (see FIG. 2). The feature amount data of the face is an example of “face information”.

The published information acquisition unit 504 has a function of acquiring information regarding an interaction partner from information on the Internet. Specifically, the published information acquisition unit 504 specifies a post of the interaction partner from a post on a social networking service (SNS) on the basis of the feature amount data of the face acquired by the face information acquisition unit 502 and the emotion value determined by the emotion determination unit 232, and acquires post content of the specified post. The acquired post content is not limited to text, and may be vocal sound, an image, a moving image, or the like. The post on the SNS is an example of “information on the Internet including social media”. The post content is an example of “published information that is published”.

The published information acquisition unit 504 of the present embodiment specifies a poster whose feature amount data of the face acquired by the face information acquisition unit 502 is similar to feature amount data of the face included in the image indicating the poster. Here, “being similar” indicates being similar at a predetermined ratio, and faces are not necessarily similar to an extent of being authenticable in a known face authentication technology. The published information acquisition unit 504 specifies a post in which an emotion value estimated from post content of a post within a predetermined period (for example, the last week) of the specified poster matches an emotion value of the interaction partner acquired by the emotion determination unit 232. As an example, in a case in which the emotion value of the interaction partner corresponds to “gloomy”, the published information acquisition unit 504 specifies posts including a “photo of a broken cup” and a “gloomy emoji” among the posts of the specified poster. A plurality of posts to be specified may be present as long as the posters are the same.

The person information acquisition unit 506 has a function of acquiring a profile. Specifically, the person information acquisition unit 506 acquires the profile of the poster who made the post specified by the published information acquisition unit 504. As an example, the person information acquisition unit 506 specifies text in which a profile is described from a home screen capable of displaying a list of posts of the specified poster, and acquires information such as the name, age, gender, and occupation of the poster included in the specified profile. The profile of the poster may be acquired from the post content acquired by the published information acquisition unit 504. The profile is an example of “person information”.

The information output unit 508 has a function of outputting acquired information. Specifically, the information output unit 508 outputs the emotion value acquired by the emotion determination unit 232, the post content acquired by the published information acquisition unit 504, and the profile acquired by the person information acquisition unit 506 to the display 76 (see FIG. 10) of the smart glasses 72. The information output unit 508 may output the acquired information in a format that is easy for the user 60 to understand. As an example, in the case of acquiring that the emotion of the interaction partner is “gloomy”, the information output unit 508 outputs an objective expression such as “being gloomy”. The information output unit 508 does not need to output all of the emotion value, the post content, and the profile, and may output information including at least one thereof.

### (Flow of Control)

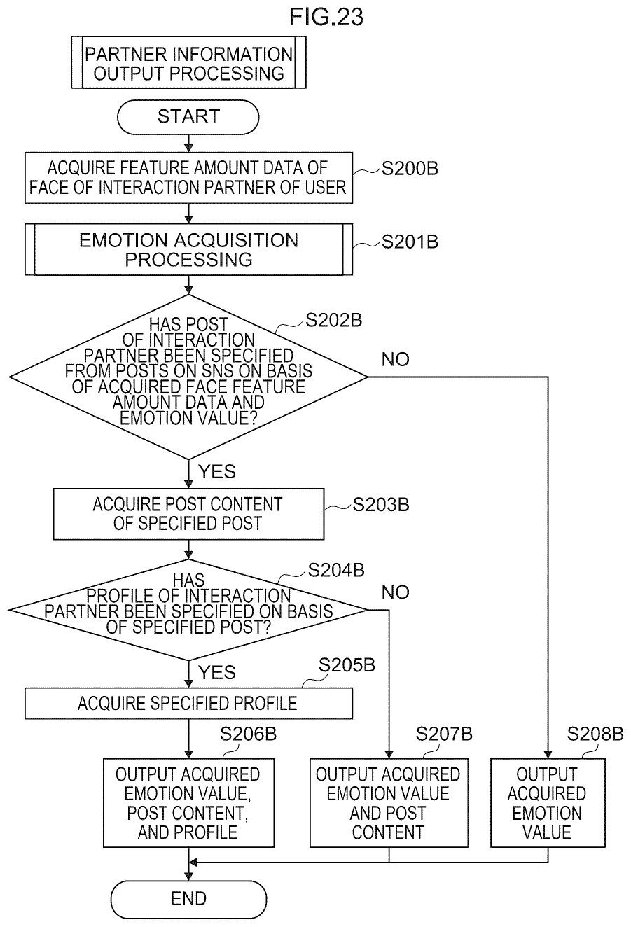

FIG. 23 is a flowchart illustrating an example of a flow of partner information output processing of outputting information regarding an interaction partner. The partner information output processing of the present embodiment is processing executed in a case in which the agent system 50 recognizes that an interaction partner of the user 60 is present and in a case in which the agent system 50 recognizes that the interaction partner of the user 60 has been changed. The partner information output processing may be executed at any timing of the user 60. In the present embodiment, the information output through the partner information output processing is output to the display 76 (see FIG. 10) of the smart glasses 72.

In step S200B in FIG. 23, the agent system 50 acquires feature amount data of the face of the interaction partner of the user 60. Specifically, the agent system 50 acquires feature amount data of the face of the interaction partner measured by the sensor unit 200 (see FIG. 2).

In step S201B, the agent system 50 executes emotion acquisition processing that will be described later. The agent system 50 acquires an emotion value of the interaction partner of the user 60 through the emotion acquisition processing. As an example, the agent system 50 acquires that the emotion of the interaction partner is “gloomy”.

In step S202B, the agent system 50 determines whether or not a post of the interaction partner has been specified from posts on the SNS on the basis of the acquired feature amount data of the face and emotion value. In a case of determining that the post of the interaction partner has been specified, the agent system 50 proceeds to step S203B. On the other hand, in a case in which it is determined that a post of the interaction partner has not been specified, the agent system 50 proceeds to step S208B.

In step S203B, the agent system 50 acquires post content of the specified post. As an example, the agent system 50 acquires post content such as “I broke my favorite cup yesterday.”.

In step S204B, the agent system 50 determines whether or not a profile of the interaction partner has been specified on the basis of the specified post. In a case in which it is determined that the profile has been specified, the agent system 50 proceeds to step S205B. On the other hand, in a case in which it is determined that the profile has not been specified, the agent system 50 proceeds to step S207B.

In step S205B, the agent system 50 acquires the specified profile. Specifically, the agent system 50 acquires the profile specified in step S204B. As an example, the agent system 50 acquires the name “A”.

In step S206B, the agent system 50 outputs the acquired emotion value, post content, and profile. Specifically, the agent system 50 outputs the emotion value acquired in step S201B, the post content acquired in step S203B, and the profile acquired in step S205B. As an example, the agent system 50 outputs information such as “being gloomy”, “recently, my favorite cup has been broken”, and “Mr. A”. The agent system 50 ends the partner information output processing.

In step S207B, the agent system 50 outputs the acquired emotion value and post content. Specifically, the agent system 50 outputs the emotion value acquired in step S201B and the post content acquired in step S203B. As an example, the agent system 50 outputs information such as “being gloomy” and “recently, my favorite cup has been broken”. The agent system 50 ends the partner information output processing.

In step S208B, the agent system 50 outputs the acquired emotion value. Specifically, the agent system 50 outputs the emotion value acquired in step S201B. As an example, the agent system 50 outputs information such as “being gloomy”. The agent system 50 ends the partner information output processing.

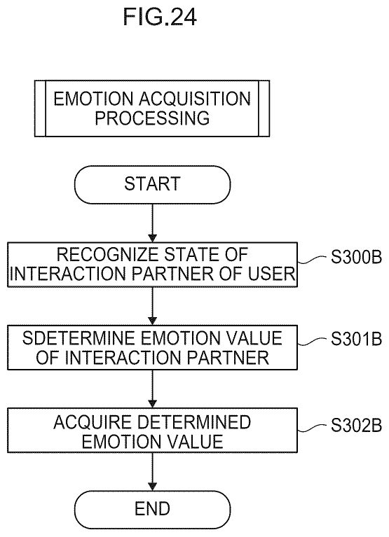

FIG. 24 is a flowchart illustrating an example of a flow of emotion acquisition processing of acquiring an emotion value of an interaction partner.

In step S300B, the agent system 50 recognizes a state of the interaction partner of the user 60. Specifically, the agent system 50 causes the user state recognition unit 230 (see FIG. 2) to recognize the state of the interaction partner.

In step S301B, the agent system 50 determines an emotion value of the interaction partner. Specifically, the agent system 50 causes the emotion determination unit 232 (see FIG. 2) to determine the emotion value of the interaction partner. The emotion engine 53 (see FIG. 22) may determine the emotion value of the interaction partner.

In step S302B, the agent system 50 acquires the determined emotion value. The agent system 50 ends the emotion acquisition processing. The agent system 50 may repeatedly execute the emotion acquisition processing as long as the user 60 continues the interaction.

### Summary of Fourth Embodiment

In the agent system 50 according to the fourth embodiment, the published information acquisition unit 504 acquires post content on an SNS on the basis of the feature amount of the face of the interaction partner acquired by the face information acquisition unit 502 and the emotion value of the interaction partner acquired by the emotion determination unit 232, and the person information acquisition unit 506 acquires the profile of the interaction partner. The agent system 50 outputs the information acquired by the information output unit 508. Media such as an SNS may not fully specify an individual. However, according to the agent system 50 of the present embodiment, since the profile of the interaction partner is acquired by using the feature amount of the face and the emotion value of the interaction partner in addition to the post information on the SNS, the information regarding the interaction partner can be obtained with high accuracy. According to the agent system 50 of the present embodiment, since the information regarding the interaction partner can be complemented with respect to the user 60, the user 60 can smoothly have a conversation with the interaction partner.

### Modification 1 of Fourth Embodiment

The agent system 50 according to the fourth embodiment acquires the profile of the interaction partner on the basis of the specified post. The agent system 50 according to Modification 1 acquires the profile of the interaction partner from a database. Hereinafter, contents unique to Modification 1 will be described.

A person information acquisition unit 506 according to Modification 1 illustrated in FIG. 22 has a function of acquiring a profile from a person information DB 223 that will be described later. Specifically, the person information acquisition unit 506 acquires a profile of a person having a high degree of similarity between the feature amount data of the face of the interaction partner acquired by the face information acquisition unit 502 and the registered feature amount data of the face. Here, “high similarity” indicates that faces are similar to an extent of being authenticable in a known face authentication technology.

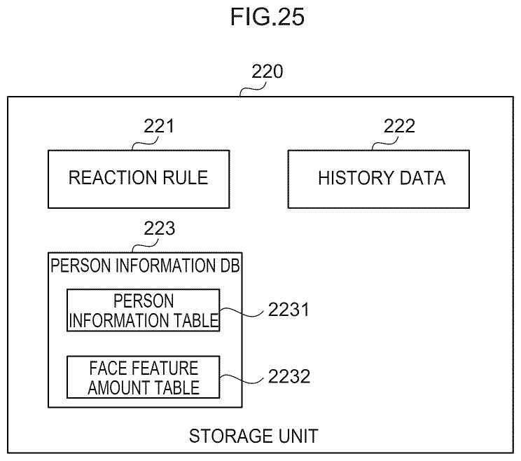

As illustrated in FIG. 25, the storage unit 220 of Modification 1 further includes a person information DB 223 in addition to the reaction rule 221 and the history data 222.

The person information DB 223 is a database in which feature amount data of faces of a plurality of persons and profiles are registered. The person information DB includes a person information table 2231 and a face feature amount table 2232.

The person information table 2231 is an information table in which the profile of each person is registered. The person information table 2231 includes a face information ID and a profile stored in association with the face information ID.

The face information ID is a combination of predetermined letters associated with the feature amount of the face and the profile.

The profile is information for specifying an individual. The profile includes a name, an affiliation/position, and other information. The profile may include an age, a gender, an occupation, and other information specifying an individual.

The face feature amount table 2232 is a data table in which face feature amounts are registered. The face feature amount table 2232 includes the above-described face information ID and face feature amount data stored in association with the face information ID.

In the face feature amount data, face feature amount data measured by a camera, an infrared sensor, a laser radar, or the like is stored. The stored face feature amount data is, for example, face feature amount data measured by the sensor unit 200 (see FIG. 2).

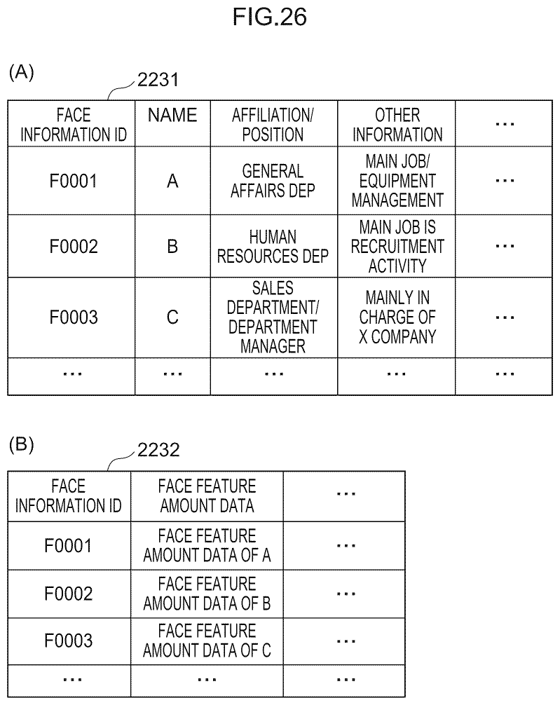

FIGS. 26(A) and 26(B) are diagrams illustrating a schematic example of a data table included in the person information DB 223.

As illustrated in FIG. 26(A), the person information table 2231 stores a face information ID and person information in association with each other. As person information corresponding to the face information ID “F0001”, “A” is stored in the name, “General Affairs Department” is stored in the affiliation/position, and “Main job is equipment management” is stored in the other information. As person information corresponding to the face information ID “F0002”, “B” is stored in the name, “Human Resources Division” is stored in the affiliation/position, and “Main job is recruiting activity” is stored in the other information. As person information corresponding to the face information ID “F0003”, “C” is stored in the name, “Sales Department/Department Manager” is stored in the affiliation/position, and “Mainly in charge of X company” is stored in the other information.

As illustrated in FIG. 26(B), the face feature amount table 2232 stores a face information ID and face feature amount data in association with each other. “Feature amount data of face of A” is stored in correspondence with the face information ID “F0001”. “Feature amount data of face of B” is stored in correspondence with the face information ID “F0002”. “Feature amount data of face of C” is stored in correspondence with the face information ID “F0003”.

### (Flow of Control)

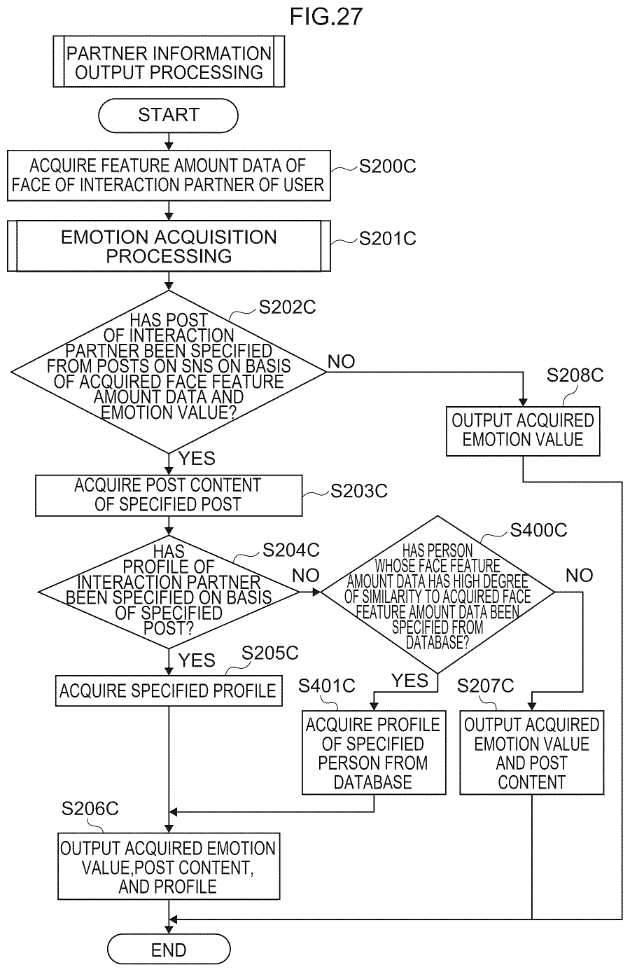

FIG. 27 is a flowchart illustrating an example of a flow of partner information acquisition processing according to Modification 1. In the partner information output processing according to Modification 1, when the agent system 50 determines that the profile of the interaction partner has not been specified in step S204, the profile of the interaction partner is acquired from the person information DB 223. Hereinafter, processing unique to Modification 1 will be described.

In step 204C in FIG. 27, in a case in which it is determined that the profile of the interaction partner has not been specified, the agent system 50 proceeds to step S400C.

In step S400C, the agent system 50 determines whether or not a person whose face feature amount data has a high degree of similarity to the acquired face feature amount data has been specified from the database. In a case in which it is determined that a person having a high similarity of the face feature amount data has been specified from the database, the agent system 50 proceeds to step S401C. On the other hand, in a case in which it is determined that a person having a high similarity of the face feature amount data has not been specified from the database, the agent system 50 proceeds to step S207C. The agent system 50 inquires the face feature amount data acquired in step S200 from the face feature amount table 2232 of the person information DB 223 to specify a person having a high similarity of the face feature amount data.

In step S401C, the agent system 50 acquires a profile of the specified person from the database. Specifically, the agent system 50 acquires the profile corresponding to the person specified in step S400C from the person information table 2231. As an example, the agent system 50 acquires the name “Mr. A” and the affiliation/position “General Affairs Department”. The agent system 50 proceeds to step S206C.

In step S206C, the agent system 50 outputs the acquired emotion value, post content, and profile. Specifically, the agent system 50 outputs the emotion value acquired in step S201C, the post content acquired in step S203C, and the profile. Here, the agent system 50 outputs the profile specified from the post in a case in which the profile has been specified on the basis of the specified post (in the case of YES in step S204C), and outputs the acquired profile in a case in which the profile has been acquired from the database (in the case of YES in step S400C). In the case of outputting the profile acquired in step S401C, the agent system 50 outputs, as an example, information such as “being gloomy”, “Recently, my favorite cup has been broken”, “Mr. A”, and “belonging to the general affairs department”. The agent system 50 ends the partner information output processing.

### Summary of Modification 1 of Fourth Embodiment

In the agent system 50 of Modification 1, the person information acquisition unit 506 acquires the profile of the interaction partner from the person information DB 223. Therefore, according to the agent system 50 of Modification 1, the user 60 can ascertain the profile of the highly reliable interaction partner registered in the database.

### Modification 2 of Fourth Embodiment

In the agent system 50 according to the fourth embodiment, the output destination of the partner information output processing is the display 76 (see FIG. 10) of the smart glasses 72. The agent system 50 according to Modification 2 is characterized in that the information output through the partner information output processing is summarized and then output to the display 76 (see FIG. 10) of the smart glasses 72. Hereinafter, contents unique to Modification 2 will be described.

The information output unit 508 according to Modification 2 in FIG. 22 has a function of outputting information acquired from the sentence generation model 55. Specifically, the information output unit 508 outputs the summary acquired from the sentence generation model 55.

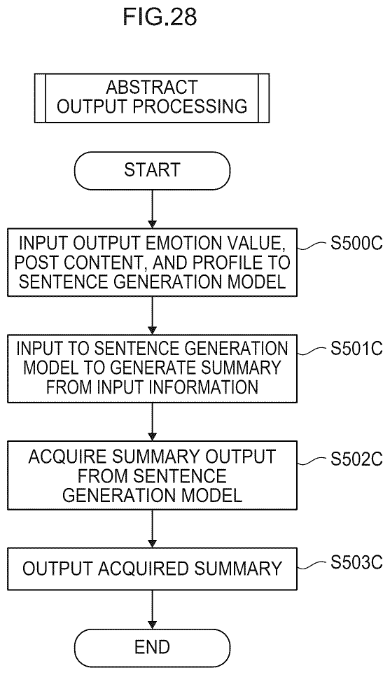

FIG. 28 is a flowchart illustrating an example of a flow of summary output processing of outputting summarized information.

In step S500C in FIG. 28, the agent system 50 inputs the output emotion value, post content, and profile to the sentence generation model 55. Specifically, the agent system 50 inputs the information output in step S206B (see FIG. 23) to the sentence generation model 55. As an example, the agent system 50 inputs information such as “being gloomy”, “Recently, my favorite cup has been broken. Bad things are continuing. I want to change my mood.”, and “Mr. A”. The agent system 50 may input at least two of the emotion value, the post content, and the profile of the interaction partner to the sentence generation model 55.

In step S501C, the agent system 50 inputs the information to the sentence generation model 55 to generate a summary from the input information. Specifically, the agent system 50 instructs the sentence generation model 55 to summarize the information input in step S500C. As an example, the agent system 50 inputs text such as “Summarize the input information” to the sentence generation model 55.

In step S502C, the agent system 50 acquires the summary output from the sentence generation model 55. As an example, the agent system 50 acquires text such as “Mr. A seems to be feeling gloomy due to continuous unpleasant events recently.”.

In step S503C, the agent system 50 outputs the acquired summary. Specifically, the agent system 50 outputs the summary acquired in step S503C to the display 76 (see FIG. 10) of the smart glasses 72. The agent system 50 ends the summary output processing.

### Summary of Modification 2 of Fourth Embodiment

In the agent system 50 of Modification 2, the information processing output unit 506 outputs summarized information regarding the interaction partner on the basis of at least two of the emotion value, the post content, and the profile of the interaction partner. Therefore, according to the agent system 50 of Modification 2, the time for the user 60 to check the information regarding the interaction partner can be shortened compared with the case in which the information regarding the interaction partner is not summarized.

### Modification 3 of Fourth Embodiment

The agent system 50 according to Modification 2 of the fourth embodiment summarizes the information output in the partner information output processing and then outputs the summarized information to the display 76 (see FIG. 10) of the smart glasses 72. The agent system 50 according to Modification 3 outputs a topic generated on the basis of the information output in the partner information output processing to the display 76 (see FIG. 10) of the smart glasses 72. The topic is an example of “conversation information”. Hereinafter, contents unique to Modification 3 will be described.

The information output unit 508 according to Modification 3 in FIG. 22 has a function of outputting information acquired from the sentence generation model 55. Specifically, the information output unit 508 outputs a topic acquired from the sentence generation model 55.

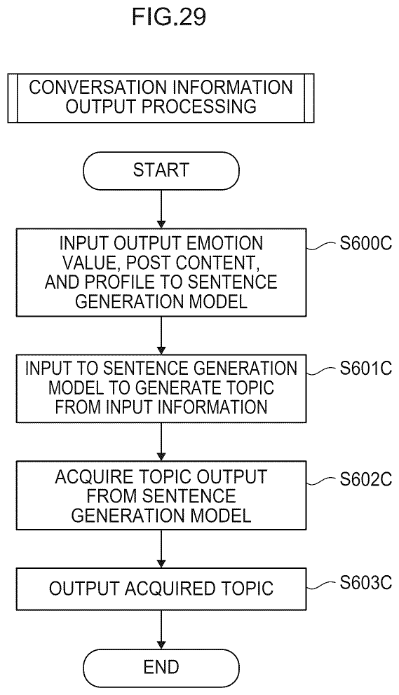

FIG. 29 is a flowchart illustrating an example of a flow of conversation information output processing of outputting a topic.

Step S600C in FIG. 29 is similar to step S500C (see FIG. 28), and thus description thereof will be omitted. The agent system 50 of Modification 3 may input at least one of the emotion value, the post content, or the profile of the interaction partner to the sentence generation model 55.

In step S601, the agent system 50 inputs the information to the sentence generation model 55 to generate a topic from the input information. Specifically, the agent system 50 instructs the sentence generation model 55 to generate a topic on the basis of the information input in step S600. As an example, the agent system 50 inputs text such as “Propose a topic on the basis of the input information” to the sentence generation model 55.

In step S602, the agent system 50 acquires the topic output from the sentence generation model 55. As an example, the agent system 50 acquires text “Why don't you explain that there is a technique called metal joining as a method of repairing a broken cup?”

In step S603, the agent system 50 outputs the acquired topic to the display 76 (see FIG. 10) of the smart glasses 72. The agent system 50 ends the conversation information output processing.

### Summary of Modification 3 of Fourth Embodiment

In the agent system 50 of Modification 3, the information processing output unit 506 outputs a topic with the interaction partner on the basis of at least one of the emotion value, the post content, or the profile of the interaction partner. Therefore, according to the agent system 50 of Modification 3, the user 60 can treat the topic according to the situation of the interaction partner.

### Modification 4 of Fourth Embodiment

The agent system 50 according to Modification 1 of the fourth embodiment specifies the profile of the interaction partner from the database in a case in which the profile of the interaction partner cannot be specified on the basis of the specified post. The agent system 50 according to Modification 4 of the fourth embodiment acquires the profile of the interaction partner from the database, and specifies the post of the interaction partner from the acquired profile. Hereinafter, contents unique to Modification 4 different from Modification 1 will be described.

The published information acquisition unit 504 according to Modification 4 has a function of acquiring information regarding an interaction partner from information on the Internet on the basis of the profile and the emotion value. Specifically, the published information acquisition unit 504 specifies a poster on the SNS on the basis of the profile acquired from the person information DB 223, specifies a post of the specified poster on the basis of the emotion value acquired by the emotion determination unit 232, and acquires post content of the specified post. As an example, the published information acquisition unit 504 specifies a poster whose name matches the name of “A” acquired from the person information DB 223. The published information acquisition unit 504 specifies a post in which the emotion value estimated from the post content of the post within the predetermined period of the specified poster matches the emotion value of the interaction partner acquired by the emotion determination unit 232. The published information acquisition unit 504 may acquire post content of a post within a predetermined period without using an emotion value.

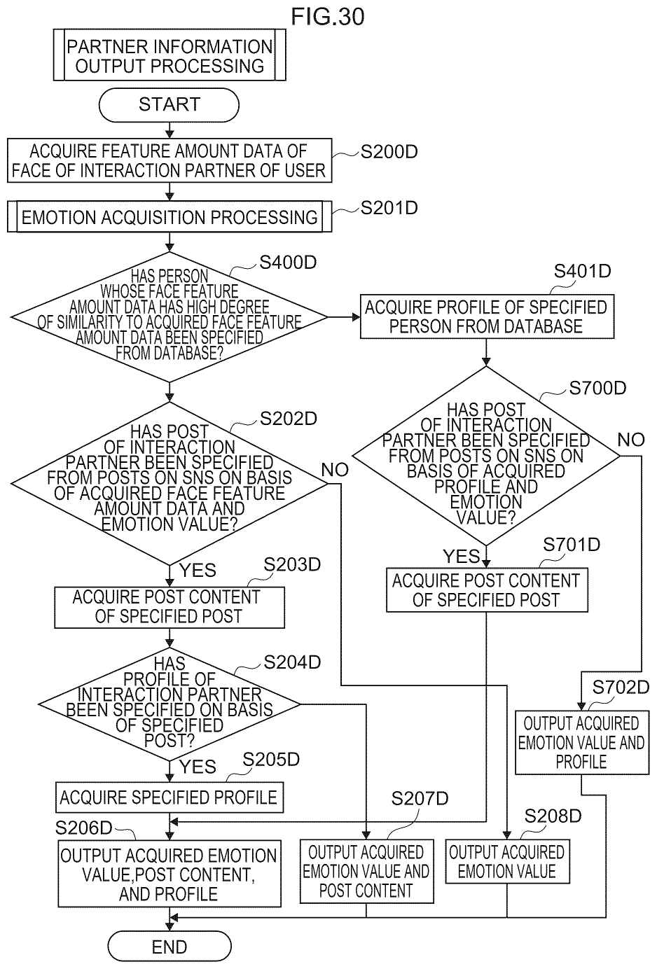

FIG. 30 is a flowchart illustrating an example of a flow of partner information output processing according to Modification 4. In the partner information output processing according to Modification 4, the agent system 50 executes step S400D after executing the emotion acquisition processing in step S201D, and specifies the interaction partner from the person information DB 223. Hereinafter, processing specific to Modification 4 will be described.

In step S201D in FIG. 30, the agent system 50 executes emotion acquisition processing. The agent system 50 proceeds to step S400D. As an example, the agent system 50 acquires that the emotion of the interaction partner is “pleasant”.

In step S400D, in a case in which the agent system 50 determines that the person having the high similarity of the feature amount data of the face has not been specified from the database, the processing proceeds to step S202D. On the other hand, in a case in which it is determined that a person having a high degree of similarity of the feature amount data of the face is specified from the database, the agent system 50 proceeds to step S401D.

In step S401D, the agent system 50 acquires a profile of the specified person from the database. Specifically, the agent system 50 acquires the profile corresponding to the person specified in step S400D from the person information table 2231. As an example, the agent system 50 acquires a name “Mr. A”. The agent system 50 proceeds to step S700D.

In step S700D, the agent system 50 determines whether or not the post of the interaction partner has been specified from the post on the SNS on the basis of the acquired profile and the emotion value. In a case in which it is determined that the post of the interaction partner has been specified, the agent system 50 proceeds to step S701D. On the other hand, in a case in which it is determined that the post of the interaction partner has not been specified, the agent system 50 proceeds to step S702D.

In step S701D, the agent system 50 acquires post content of the specified post. Specifically, the agent system 50 acquires the post content of the post specified in step S700D. As an example, the agent system 50 acquires post content such as “Today, it was pleasant to have flower-viewing.” of “Mr. A”. The agent system 50 proceeds to step S206D.

In step S206D, the agent system 50 outputs the acquired emotion value, post content, and profile. Specifically, the agent system 50 outputs the emotion value acquired in step S201, the post content acquired in step S701D, and the profile acquired in step S700D. As an example, the agent system 50 outputs information such as “looks pleasant”, “We went to flower viewing the other day.”, and “Mr. A”. The agent system 50 ends the partner information output processing.

In step S702D, the agent system 50 outputs the acquired emotion value and profile. As an example, the agent system 50 outputs information such as “looks pleasant” and “Mr. A”. The agent system 50 ends the partner information output processing.

### Summary of Modification 4 of Fourth Embodiment

In the agent system 50 according to Modification 4 of the fourth embodiment, the person information acquisition unit 506 acquires the profile of the interaction partner from the person information DB 223. The published information acquisition unit 504 acquires post content of a post on the SNS on the basis of the acquired profile and the emotion value acquired by the emotion determination unit 232. Therefore, according to the agent system 50 according to Modification 4, the user 60 can ascertain the latest information published regarding the interaction partner. Since the information published regarding the interaction partner is acquired on the basis of the profile registered in the person information DB 223, it is possible to acquire information with high accuracy compared with the case of acquiring the information on the basis of the face feature amount.

In a case in which the person information acquisition unit 506 does not specify a person whose degree of similarity to the face feature amount data of the interaction partner is high from the person information DB 223, the agent system 50 according to Modification 4 of the fourth embodiment specifies the post of the interaction partner from the post on the SNS and acquires the profile of the interaction partner. Therefore, according to the agent system 50 according to Modification 4, the user 60 can know the information regarding the interaction partner even in a case in which the information regarding the interaction partner is not registered in the person information DB 223.

### Remarks

The face information acquisition unit 502 according to the fourth embodiment acquires face feature amount data as face information. However, the disclosure is not limited thereto, and the face information acquisition unit 502 may acquire a face image as the face information. In the fourth embodiment, the processing using the face feature amount data may be performed by using a face image.

The partner information output processing of the fourth embodiment is executed in a case in which it is recognized that the interaction partner is present in the user 60 and in a case in which it is recognized that the interaction partner of the user 60 has been changed. However, the disclosure is not limited thereto, and in a case in which the information regarding the interaction partner is newly acquired, only the corresponding information may be updated and output. As an example, the agent system 50 may output only the emotion value to be updated in a case in which the emotion value of the interaction partner changes.

In the fourth embodiment, the agent system 50 acquires the face feature amount data from the sensor unit 200 (see FIG. 2). However, the disclosure is not limited thereto, and the agent system 50 may acquire the face feature amount data by using the camera 86 of the smart glasses 72 or the sensor group 82 (see FIG. 10). The face feature amount data may be acquired from an external device such as a smartphone or an imaging device.

In the fourth embodiment, the agent system 50 specifies a post of an interaction partner from a post on a social networking service (SNS), and acquires post content of the specified post. However, the disclosure is not limited thereto, and the agent system 50 may specify a post of the interaction partner from a post on social media such as a blog, a moving image sharing site, a word-of-mouth site, or a shopping site. A post is not limited to a post of the interaction partner, and may be news, an article, or the like in which the interaction partner is covered.

In the fourth embodiment, the agent system 50 specifies a poster whose face feature amount data acquired by the face information acquisition unit 502 is similar to the face feature amount data included in the image indicating the poster, and specifies the post of the interaction partner. However, the disclosure is not limited thereto, and the agent system 50 may specify the information regarding the interaction partner by executing web search using the feature amount data of the face of the interaction partner.

In the fourth embodiment, the agent system 50 outputs information to the display 76 (see FIG. 10) of the smart glasses 72. However, the disclosure is not limited thereto, and the agent system 50 may output information from the speaker 80 of the smart glasses 72. The output from the speaker 80 includes vocal sound output using an earphone or bone conduction. An output destination is not limited to the smart glasses 72, and may be a mobile terminal, a wearable terminal, or the like.

### Fifth Embodiment

Next, as a fifth embodiment, an execution example of a fast reading application in which a wearable terminal (specifically, the smart glasses 72) is applied as an electronic apparatus will be described. An electronic apparatus is not limited to the smart glasses 72, and may be other electronic apparatuses (robots, dolls, stuffed toys, pendants, smart watches, smartphones, smart speakers, earphones, personal computers, and the like) on which the agent system 50 can be mounted.

The execution program of the fast reading application of the present embodiment is stored in the recording medium of the control device 74 illustrated in FIG. 10 and executed by the CPU.

In the fast reading application, the smart glasses 72 are controlled to execute the following (Operation 1) to (Operation 7).

(Operation 1) The smart glasses 72 are activated when the user spreads a book and says “Read the book quickly”.

(Operation 2) A camera (not illustrated) of the smart glasses 72 images letter information of a page of a book or the like read by the user.

(Operation 3) The captured image is subjected to OCR to acquire a sentence.

(Operation 4) A prompt preset to “Summarize the acquired sentence” is input to ChatGPT to acquire a summary of the page being read. Depending on the function of the CHATGPT, an image or an illustration of the page may be captured to analyze the image (using the function of the GPT-4).

(Operation 5) The summary content is output by using vocal sound from the speaker of the smart glasses 72 or the connected earphone.

(Operation 6) Whether or not the user has performed a page turning operation is recognized from the image of the camera of the smart glasses 72.

(Operation 7) The above (Operation 2) to (Operation 6) are repeatedly executed.

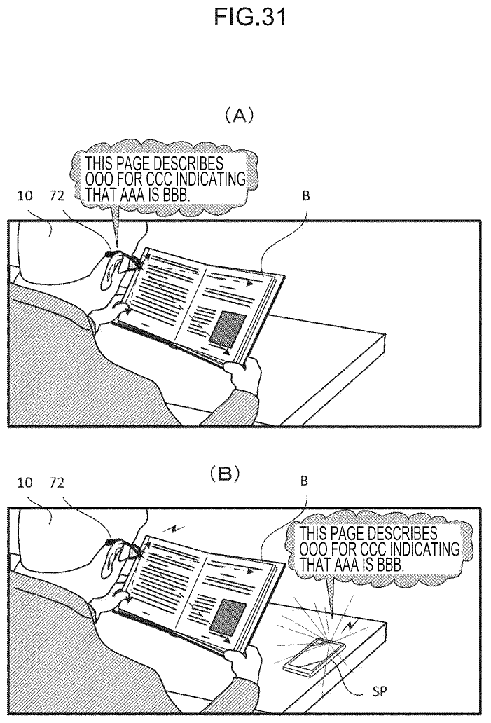

FIG. 31(A) is a perspective view illustrating a fast reading example of a book in a fast reading application using the smart glasses 72.

FIG. 31(A) illustrates a state in which the user 10 wearing the smart glasses 72 is reading a book B while holding the book B.

In accordance with the timing at which the user 10 is reading, a camera (not illustrated) of the smart glasses 72 images letter information of a page that is opened (normally two left and right pages), and the text information is subjected to OCR to acquire a sentence written on the page.

Since the answer from ChatGPT based on the fast reading instruction is output from the speaker (not illustrated) of the smart glasses 72 with vocal sound, the user 10 can recognize the outline before reading the letters on the page. The output is generated as text such as “This page describes OOO for CCC indicating that AAA is BBB.”.

Therefore, the user 10 can ascertain an outline of the content written on the page before reading the page. The utterance may be arranged to increase the reader's (user 10) reading motivation as in a preview. For example, in the case of a reasoning novel, utterance such as “Finally, the truth of OO becomes clear on this page. The person who holds the key is . . . ” is made.

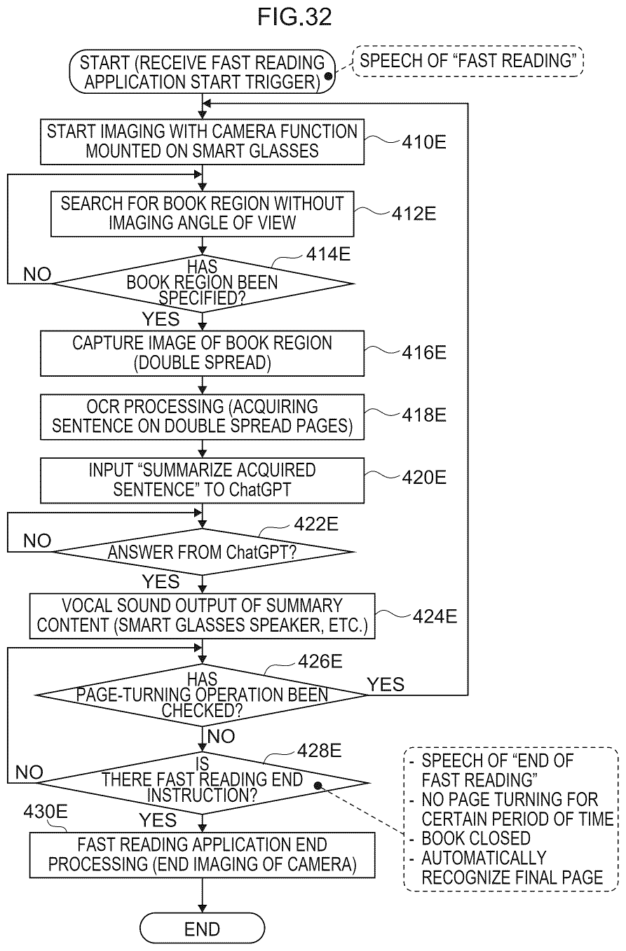

FIG. 32 is a control flowchart illustrating a flow of processing of the fast reading application illustrated in (Operation 1) to (Operation 7) described above, executed by the control device 74 of the smart glasses 72.

When the user 10 says “Read fast”, the fast reading application in FIG. 32 is activated, and in step 410E, imaging is started by the camera function of the smart glasses 72.

In next step 412E, a region (hereinafter, referred to as a book region) of the book B (see FIG. 31(A)) within the imaging angle of view is searched, and it is determined whether or not the book region is specified in step 414E. In a case in which a negative determination is made in step 414E, the processing returns to step 412E, and steps 412E and 414E are repeatedly executed until the book region is specified.

In a case in which a positive determination is made in step 414E (book region specification), the processing proceeds to step 416E to image the book region (double spread), and then the processing proceeds to step 418E to perform OCR processing. The sentence of the double spread pages is acquired through OCR processing.

In the next step 420E, text such as “summarize the acquired sentence” is input to ChatGPT. As a result, ChatGPT analyzes the sentence to create a summary of double spread pages with a predefined number of letters. The predefined number of letters may be fixed or may be a certain ratio (for example, 10%) based on the number of letters of the sentence to be analyzed. The user 10 (see FIG. 32) may add a request such as “at a high school student level” or “in English” to the input of “Summarize the acquired sentence”.

In the next step 422E, it is determined whether or not there is an answer from ChatGPT, and in a case in which an affirmative determination is made, the processing proceeds to step 424E, and the summary content is output by using vocal sound. For example, the output is performed at the ear of the user 10 from the speaker of the smart glasses 72, the connected earphone, or the like (not illustrated in FIG. 31(A)).

In the next step 426E, it is determined whether or not the page turning has been checked, and in a case in which a negative determination is made, the processing proceeds to step 428, and it is determined whether or not there is a fast reading end instruction.

Examples of the fast reading end instruction include utterance of “fast reading end” by the user 10, page turning not being performed for a certain period of time, the book B being closed, and automatic recognition of the last page.

In a case in which a negative determination is made in each of step 426E and step 428E, step 426E and step 428E are repeatedly executed. Here, in a case in which an affirmative determination is made in step 426E, the processing returns to step 410E to repeat the above processing in order to continue the fast reading.

In a case in which an affirmative determination is made in step 428E, the processing proceeds to step 430E, and end processing (at this point, the imaging by the camera is ended) of the fast reading application is executed, and this routine is ended.

In FIG. 31(A), the sound is output from the speaker of the smart glasses 72 or the like at the ear of the user 10, but as illustrated in FIG. 31(B), the fast reading result may be output from a speaker of another electronic apparatus (in FIG. 31(B), the smartphone SP) via a communication function. A communication destination may be another electronic apparatus such as a smart speaker or a PC. As a result, it is possible to make another person located in the vicinity of the user 10 listen to the reservation of the book B.

In the embodiment described with reference to FIGS. 31 and 32, the smart glasses 72 illustrated in FIGS. 10 and 11 are applied as an electronic apparatus, but another wearable terminal such as the smart pendant 92 or the headset (VR goggle) illustrated in FIG. 12 may be used. In the case of VR goggles, the book B itself may be a virtual reality image. That is, for example, in a case in which the user 10 utters identification information for specifying a book such as a title in a state in which the palm is opened toward the user, a virtual reality book image may be displayed and the book may be read, and the summary sentence may be uttered in synchronization with the page turning operation of the user.

An electronic apparatus is not limited to a wearable terminal, and may be robots 100 and 102 (see FIG. 1) that closely follow the user 10 side (see FIG. 31). The robots 100 and 102 control themselves to have an imaging optical axis that coincides with the destination (book region) of the line of sight of the user 10 (see FIG. 31).

The electronic apparatus may be a camera alone (a speaker function as an output unit is separately required) or another electronic apparatus such as a smartphone or a tablet terminal as long as the imaging optical axis coincides with the destination (book region) of the line of sight of the user 10.

As described above, in the present embodiment (fast reading application), when the user 10 reads, by using the fact that the user 10 faces the book B, a series of flows such as the letter information of the book being imaged by the camera mounted on the smart glasses 72, subjected to OCR, a summary being created by ChatGPT, and the summary being output by using vocal sound is executed, so that the user 10 can receive the assistance of reading ability without any special measure.

### Sixth Embodiment

Next, as a sixth embodiment, an execution example of an emotion positivity application in which a wearable terminal (specifically, the smart glasses 72) is applied as an electronic apparatus will be described. That is, as illustrated in FIGS. 10 and 11, the present embodiment assumes a state in which the user 60 wears the smart glasses 72.

An electronic apparatus is not limited to the smart glasses 72, and may be any of other electronic apparatuses (robots, dolls, stuffed toys, pendants, smart watches, smartphones, smart speakers, earphones, personal computers, and the like) on which the agent system 50 can be mounted.

The execution program of the emotion positivity application of the present embodiment is stored on the recording medium of the control device 74 illustrated in FIG. 10 and executed by the CPU.

In the emotion positivity application, the agent system 50 is controlled to execute the following (Operation 1) to (Operation 7).

(Operation 1) An action of the user 60 and a surrounding situation (image and vocal sound) of the user 60 are acquired by a sensor (a camera or a microphone that is “not illustrated”) of the smart glasses 72.

(Operation 2) An event related to the user 60 is recognized from the sensor output.

(Operation 3) An emotion of the user 60 during the execution of the event is analyzed by using the sensor output.

(Operation 4) In a case in which the emotion of the user 60 is negative, “How can I positively view the current event?” is input to the sentence generation model 55.

(Operation 5) A way of thinking for positive viewing is acquired from the sentence generation model 55.

(Operation 6) A way of thinking for positive viewing is output by using vocal sound from a speaker of the smart glasses 72 or a connected earphone. It is also possible to output the event and the way of thinking by using vocal sound later through setting.

(Operation 7) The above (Operation 1) to (Operation 6) are repeatedly executed.

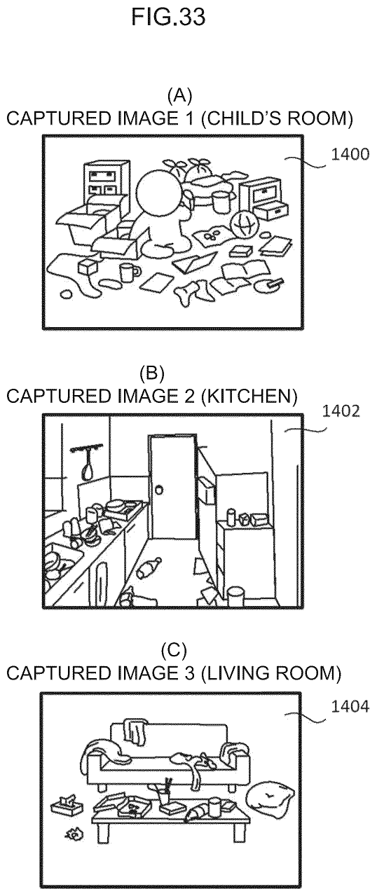

FIGS. 33(A) to 33(C) are front views of images relating to a specific event (here, “cleaning” is selected as the event) captured by the camera of the smart glasses 72.

FIGS. 33(A) to 33(C) are images captured when the user 60 stops by each room in the house. FIG. 33(A) is a children's room image 1400 (captured image 1), FIG. 33(B) is a kitchen image 1402 (captured image 2), and FIG. 33(C) is a living room image 1404 (captured image 3). The image may be captured when the user 60 is cleaning (during execution of an event) or when each room is checked before execution of the event.

The agent system 50 analyzes an emotion of the user 60 at the time of capturing the images of FIGS. 33(A) to 33(C).

In this case, since the room is messy, the agent collates usual activities of the user 60 and determines that “Each room is messy, and cleaning is very difficult.” and “Other work such as washing and preparation for dinner cannot be performed.”, and the emotion of the user 60 is “negative”.

Therefore, the agent system 50 inputs “How can I positively view the current event?” to the sentence generation model 55 as a prompt (advice request for positivity).

Since the answer from the sentence generation model 55 based on the advice request for positivity is output from the speaker (not illustrated) of the smart glasses 72 by using vocal sound while the user 60 executes the event, it is possible to help the emotion of the user 60 shift to a direction of positively viewing the event. The output is generated, for example, as a sentence such as “Why don't you consider it for OO?”.

The output may be “Next, how about AAA?” together with the content of the event after the end of the event instead of during the execution of the event (real time). As a result, even if a similar situation (each room is messy) is encountered in the same event (cleaning), the possibility of making emotions positive can be increased. In the present embodiment, “messy” with respect to “cleaning” is used as a relationship between the specific event and the negative, but a relationship between the specific event and the negative is not limited to “messy” with respect to “cleaning”, and “noise” with respect to “sound”, “damage” with respect to “decorative article”, “deviation or shortage” with respect to “schedule”, and the like can be considered.

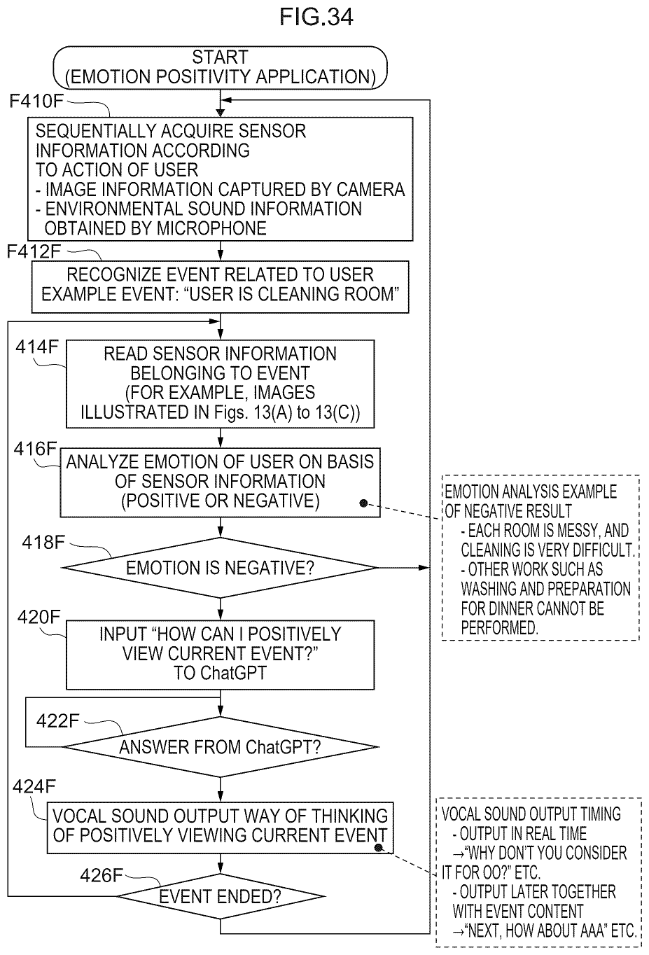

FIG. 34 is a control flowchart illustrating a flow of processing of the emotion positivity application illustrated in (Operation 1) to (Operation 7) described above, executed by the control device 74 of the smart glasses 72.

For example, the emotion positivity application is activated when the user 60 wears the smart glasses 72 and turns on the power, and basically maintains the operation state, but the operation may be activated or stopped by the speech or manual operation of the user 60.

In step 410F, sensor information is sequentially acquired in accordance with the action of the user 60 wearing the smart glasses 72. Specifically, the camera of the smart glasses 72 captures an image at an angle of view corresponding to a line of sight of the user 60, and the microphone acquires information corresponding to a user action such as recording surrounding environmental sound. Although the sensor information is the captured image information and the environmental sound information here, the sensor information includes all kinds of information regarding all of happiness, anger, sadness, and pleasure felt by the user 60 (see FIGS. 5 and 6).

In the next step 412F, an event related to the user 60 is recognized, and then the processing proceeds to step 414F to read sensor information belonging to the event. FIGS. 33(A) to 33(C) illustrate image information read as an event on the basis of a situation in which the user 60 is cleaning the room, and it can be seen that each room is messy.

In the next step 416F, the emotion (positive or negative) of the user 60 is analyzed on the basis of the sensor information. From the images in FIGS. 33(A) to 33(C), emotions such as “Each room is messy, and cleaning is very difficult.” and “Other work such as washing and preparation for dinner cannot be performed.” are analyzed, and it is predicted that the emotion of the user 60 is negative.

In the next step 418F, it is determined whether or not the emotion is negative, and in a case in which an affirmative determination (analysis result based on the images in FIGS. 33(A) to 33(C)) is made, it is determined that the emotion of the user 60 is negative, and the processing proceeds to step 420. In a case in which the sensor information indicates that each room is clean and tidy unlike in the image illustrated in FIG. 33(A), the emotion of the user 60 is positive and an affirmative determination is made in step 418F, and thus the processing returns from step 418F to step 410F to repeatedly execute the above steps.

In step 420F, “How can I positively view the current event?” is input to the sentence generation model 55 (as an example, ChatGPT), and the processing proceeds to step 422F.

In step 422F, it is determined whether or not there is an answer from the sentence generation model 55 (as an example, ChatGPT), and in a case in which an affirmative determination is made, the processing proceeds to step 424, and the way of thinking of positively viewing the current event is output by using vocal sound. The vocal sound output may be performed in real time during the event or after the end of the event.

Examples of real-time vocal sound output include “Why don't you consider it for OO?”. On the other hand, examples of the vocal sound output after the end of the event include “Next, how about AAA?” together with the content of the event.

In the next step 426F, it is determined whether or not the event has been ended. In a case in which a negative determination is made, the processing proceeds to step 414F, sensor information (latest information) belonging to the event is read, and the above-described steps are repeatedly executed. For example, in a case in which an image in which a child starts cleaning (tidying up) by himself/herself in a child's room is acquired, the emotion of the user 60 may change positively.

In a case in which an affirmative determination is made in step 426F, the processing proceeds to step 410F and the above steps are repeatedly executed in order to cope with the next event.

In the present embodiment, the smart glasses 72 illustrated in FIGS. 10 and 11 are applied as an electronic apparatus, but another wearable terminal such as the smart pendant 92 or a headset (VR goggle) illustrated in FIG. 12 may be used.

An electronic apparatus is not limited to a wearable terminal, and may be robots 100 and 102 that function as an agent system. The sensor information may be acquired from a single device such as a camera or a microphone installed in each portion in the house. In the case of a single device, it is necessary to transmit information (sensor information) acquired by the single device to another installed agent system.

As described above, in the present example (emotion positivity application), in a case in which the user 60 executes an event, the emotion (positive or negative) of the user 60 related to the event is analyzed on the basis of sensor information (captured image information obtained by the camera, vocal sound information obtained by the microphone, and the like) belonging to the event, and in the case of negative, appropriate advice can be obtained by asking about a countermeasure for positivity as a prompt to the sentence generation model 55, and it is possible to help the user 60 cope with the event in a positive manner. When the emotion is classified into negative and positive, the emotion may be classified by using an absolute threshold or may be classified relatively. The term “relative” indicates that (1) the emotion is more positive this time than the emotion determined yesterday, (2) the emotion is negative this time from a transition situation for a certain period of time, and (3) the emotion is more negative than that of the spouse and siblings living together.

### Seventh Embodiment

Next, as a seventh embodiment, an embodiment of a ToDo management application that manages an action history of an action history target designated by a user in an agent system will be described below.

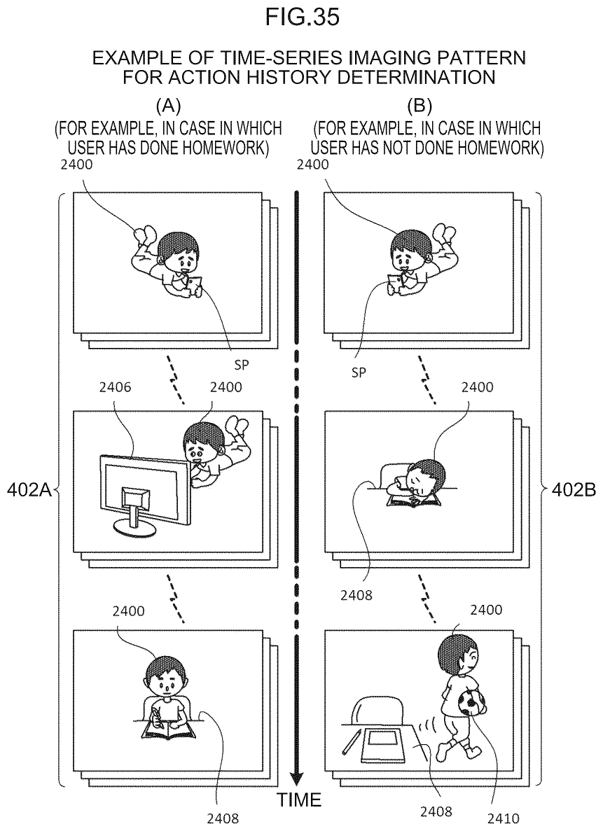

The user and the action history target have a predetermined relationship. In the present embodiment, the user 10 is an administrator (parent) of the robots 100, 101, and 102 (hereinafter, collectively referred to as a robot 100) illustrated in FIG. 1, while the action history target is set to a child 2400 (see FIG. 35) of the user 10, and a parent-child relationship is assumed.

An execution program of the ToDo management application of the present embodiment is executed by the function of the CPU (each functional configuration illustrated in FIG. 2). As described above, the functional configuration includes the sensor unit 200, the sensor module unit 210, the storage unit 220, the user state recognition unit 230, the emotion determination unit 232, the action recognition unit 234, the action determination unit 236, the storage control unit 238, the action control unit 250, the control target 252, and the communication processing unit 280, and the ToDo management application is executed by cooperation of the functional configuration units (see FIG. 2).

In the ToDo management application, the robot 100 is controlled to execute the following (Operation 1) to (Operation 5) in order to monitor an action of the action history target (child 2400) in response to a command from the user 10 (parent).

(Operation 1) The robot 100 sequentially recognizes actions of the action history target (child 2400) and stores an action history.

(Operation 2) From a communication terminal (a smartphone or a mobile phone) of the user 10 (parent) to the robot 100, by using the SNS, a specific action is selected from a ToDo list registered in advance as an instruction for determining whether or not the specific action has been achieved, and a check message is transmitted (for example, “Have you done your homework?”). The specific action is not limited to homework, and may be any action registered in the ToDo list in advance, such as whether the child has cleaned, napped, or fed a pet. In a case in which it is desired to check a specific action that is not registered in the ToDo list, the action may be additionally registered. In this case, in a case in which there is an action history related to the additionally registered specific action, the action can be handled.

(Operation 3) The robot 100 determines whether or not the child 2400 has done the homework from the action history of the child.

(Operation 4 “Operation 4-1 or Operation 4-2”)
Operation 4-1: In a case in which the child 2400 is doing homework (see the action history in FIG. 35(A)), a prompt such as “How should I praise the child in a case in which the child is doing his/her homework by himself/herself?” is input to the sentence generation model 55, to give an instruction for creating a sentence regarding a way of speaking (words of praise).
Operation 4-2: In a case in which the child 2400 is not doing homework (see the action history in FIG. 3(B)), a prompt such as “How can I encourage the child to do his/her homework?” is input to the sentence generation model 55, to give an instruction for creating a sentence regarding a way of speaking (words of encouragement).

(Operation 5) A speaker mounted on the robot 100 or a connected earphone outputs words of praise (in the case of Operation 4-1) or words of encouragement (in the case of Operation 4-2) to the child 2400 by using vocal sound.

FIG. 35 is a front view of image groups 402A and 402B captured in time series for determination of a history of a specific event (an action of a designated action history target) captured by a camera (for example, the 2D camera 203 which is one of the sensor units 200 mounted on the robot 100 illustrated in FIG. 2) managed and controlled by the agent system.

FIG. 35 illustrates an image group extracted in a case in which there is an instruction regarding the action history of whether or not the action history target (child 2400) has done the homework from the user 10.

FIG. 35(A) illustrates an example of an image group in a case in which the child 2400 has done the homework, and FIG. 35(B) illustrates an example of an image group in a case in which the child 2400 has not done the homework. In practice, one of the image groups exists in the same time period.

A camera is not limited to the 2D camera 203 mounted on the robot 100, and the robot 100 may acquire an image captured by a camera installed in each indoor room through communication. As a result, it is possible to acquire an image for the action history even if the robot 100 does not follow the action of the child 2400.

As illustrated in FIG. 35(A), in a case in which the image group at the time of doing the homework is checked in time series, it can be checked that the child 2400 is lying and operating the smartphone SP in the action history in the initial stage, and the child 2400 views a television 2406 in the action history in the middle stage, but the child 2400 is studying (homework) in the action history in the end stage by synthesizing a state in which the child 2400 faces the desk 2408.

This case corresponds to the above (Operation 4-1), the robot 100 inputs “How should I praise the child in a case in which the child is doing his/her homework by himself/herself?” to the sentence generation model 55. In response to this input, a way of speaking (words of praise) is acquired from the sentence generation model 55.

As illustrated in FIG. 35(B), in a case in which the image group when the child is not doing the homework is checked in time series, it can be checked that the child 2400 has not done the homework when summing up the states in which the child 2400 is lying down and operating the smartphone SP in the action history in the initial stage, the child 2400 is dozing while facing the desk 2408 in the action history in the middle stage, and the child 2400 moves away from the desk 2408 with the soccer ball 2410 in the action history in the final stage.

This case corresponds to the above (Operation 4-2), the robot 100 inputs “How can I encourage the child to do his/her homework?” to the sentence generation model 55. In response to this input, a way of speaking (words of encouragement) is acquired from the sentence generation model 55.

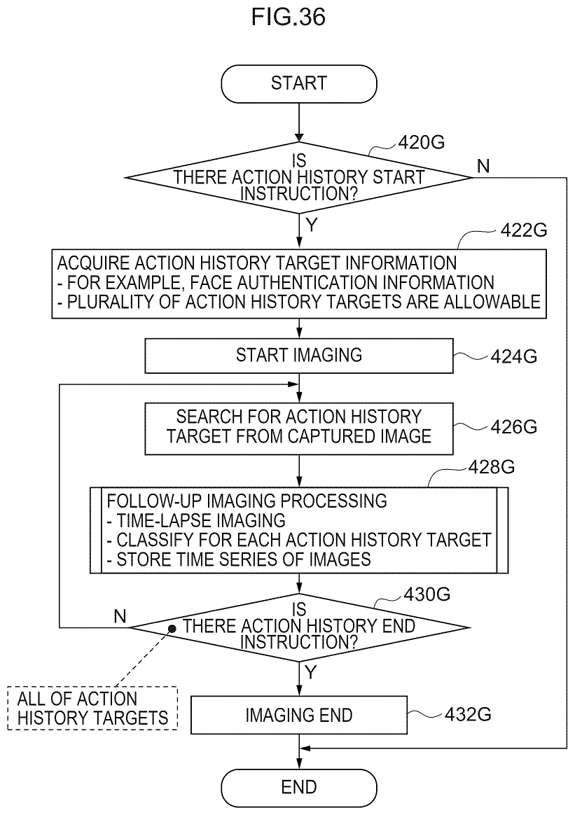

FIG. 36 is a control flowchart illustrating a flow of action history acquisition in the processing of the ToDo management application executed by the control device of the robot.

In step 420G, it is determined whether or not an action history start instruction has been given. The action history start instruction may be synchronized with activation of the robot 100, may be a time period set by a timer or the like, or may be an instruction from the user 10. In the case of the present embodiment (action history determination of the child 2400), the time at which the parent who is the user 10 goes out may be set as an activation timing.

In a case in which a negative determination is made in step 420G, this routine is ended. In a case in which an affirmative determination is made in step 420G, the processing proceeds to step 422G, and information for specifying the action history target person (the child 2400 in the present embodiment) designated by the user 10 is acquired. Examples of the specifying information include a feature used for face authentication, a feature of appearance, and a feature of sound. The number of action history target persons may be plural (siblings or the like).

In the next step 424G, imaging is started. In next step 426G, the action history target (child 2400) is retrieved from the captured image, and then the processing proceeds to step 428G to execute follow-up imaging processing for the retrieved action history target (child 2400). As the follow-up imaging processing, time-lapse imaging (frame capturing) is performed, and in a case in which there are a plurality of action history targets, the action history targets are classified for each action history target, and the captured images are stored in time series. A still image or a moving image may be obtained through the time-lapse imaging capturing.

In the next step 430G, it is determined whether or not there is an action history end instruction. The action history end instruction may be synchronized with the activation end of the robot 100, or may be a time period set by a timer or the like, or an instruction from the user 10. In the case of the present embodiment (action history determination of the child 2400), the time at which the parent who is the user 10 returns home from a place outside the house may be set as an activation end timing.

In a case in which a negative determination is made in step 430G, the processing returns to step 426G and the above-described steps are repeatedly executed in order to continue the action history. In a case in which an affirmative determination is made in step 430G, the processing proceeds to step 432G, the imaging is ended, and this routine is ended.

In other words, the action history (follow-up imaging processing) is continued until an action history end instruction is given.

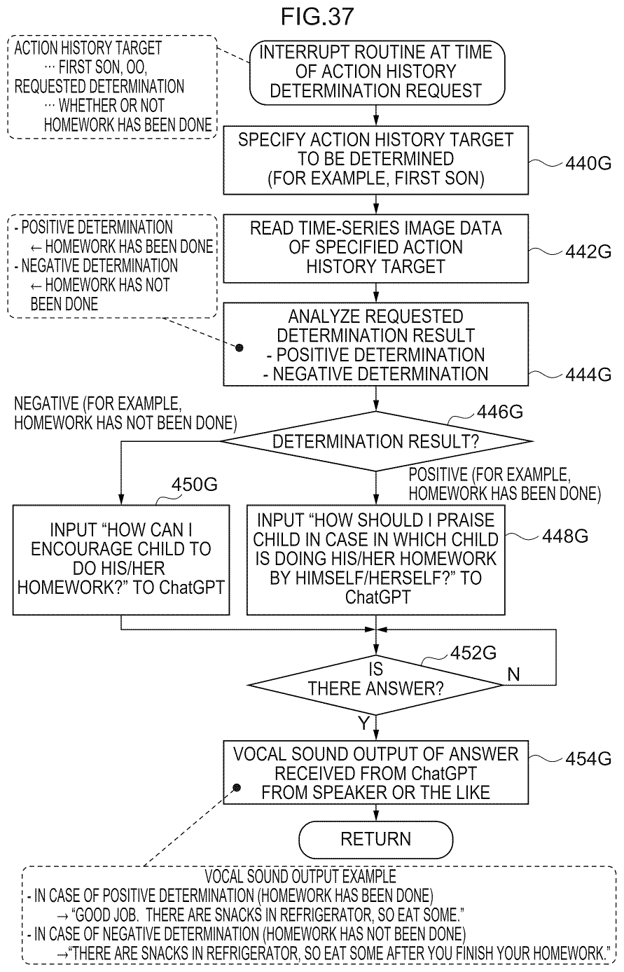

FIG. 37 is a control flowchart illustrating a flow of an interrupt routine that is interrupted when an action history determination request is made during execution of the action history in FIG. 36 (during follow-up imaging processing).

In the present embodiment, the action history determination request is that the robot 100 receives information such as “Have you done your homework?” from the going-out user 10 (parent) via the SNS, and when the information is received, the interrupt routine at the time of giving an action history determination request is activated.

In step 440G, an action history target (child 2400) to be determined is specified. For example, in a case in which there are a plurality of action history targets, identification information such as “first son” and “OO kun” is necessary.

In the next step 442G, time-series image data of the specified action history target (child 2400) is read. That is, in the present embodiment, any of the time-series images in FIG. 35(A) or FIG. 35(B) is actually stored, and any of the time-series image data is read.

In the next step 444G, a result of the requested determination (determination of achievement or non-achievement of a specific action) is analyzed. Here, in response to the request “Have you done your homework?”, a positive determination (achievement of the homework) or a negative determination (non-achievement of the homework) is made.

In a case in which the read time-series image data is the data illustrated in FIG. 35(A), it can be checked that the child 2400 is studying (doing homework) from the time-series images of lying down and operating the smartphone SP (initial stage), viewing the television 2406 (middle stage), and going to the desk 2408 (final stage), and thus, a positive determination is made.

On the other hand, in a case in which the read time-series image data is that data illustrated in FIG. 35(B), it can be checked that the child 2400 has not done the homework from the time-series images of lying down and operating the smartphone SP (initial stage), moving toward the desk 2408 but dozing (middle stage), and moving away from the desk 2408 with the soccer ball 2410 (final stage), and thus, a negative determination is made.

In the next step 446G, it is determined whether the determination result in step 444G is a positive determination or a negative determination.

In a case in which it is determined that a positive determination is made in step 446G, the processing proceeds to step 448G, to input “How should I praise the child in a case in which the child is doing his/her homework by himself/herself?” to the sentence generation model 55 (as an example, ChatGPT), and the processing proceeds to step 452.

In a case in which it is determined that a negative determination is made in step 446G, the processing proceeds to step 450G, to input “How can I encourage the child to do his/her homework?” to the sentence generation model 55 (as an example, ChatGPT), and the processing proceeds to step 452G.

In step 452G, it is determined whether or not there is an answer from the sentence generation model 55 (as an example, ChatGPT). In a case in which an affirmative determination is made, the processing proceeds to step 454G, and the answer received from the sentence generation model 55 (as an example, ChatGPT) is output from a speaker or the like by using vocal sound, and this routine is ended.

In step 454G, an example of an answer from the sentence generation model 55 (as an example, ChatGPT) ChatGPT to the positive determination (having done the homework) includes “Good job. There are snacks in the refrigerator, so eat some.”.

On the other hand, in step 454G, an example of an answer from the sentence generation model 55 (as an example, ChatGPT) to the negative determination (not having done the homework) includes “There are snacks in the refrigerator, so eat some after you finish your homework.”.

As described above, in the present embodiment (ToDo management application), instead of the user 10 (parent) who is out of the house, the robot 100 equipped with the agent system determines whether or not the action history target (child 2400) who is staying home has done the homework, and inquires of ChatGPT about the respective situations of doing the homework (positive) and not doing the homework (negative), so that advice (appropriate words) can be received, and appropriate words can be spoken to the child 2400 by using vocal sound.

An electronic apparatus is not limited to the robot 100, and may be another electronic apparatus (a doll, a stuffed toy, or smart glasses 72 (see FIG. 10), the smart pendant 92 (see FIG. 12), a smart watch, a smartphone, a smart speaker, an earphone, a personal computer, and the like) on which the agent system can be mounted.

In the present embodiment, a relationship between the user 10 and the action history target is a parent-child relationship (guardian and protected person), but is not limited to the parent-child relationship, and can be applied as long as a relationship between a manager (guardian) and a managed person (protected person), such as a superior and a subordinate, a master and a student, an ordering side and an order-receiving side, and an owner and a pet, is established.

In the present embodiment, the action history target (child 2400) is distinguished from user 10, but in a broad sense, the action history target may also belong to user 10. That is, the user 10 can also designate himself/herself as an action history target and set himself/herself as a target of the action history by the robot 100. Alternatively, among a plurality of users 10, one user 10 may designate the other user 10 as an action history target, and set the other user as a target of the action history by the robot 100.

### Eighth Embodiment

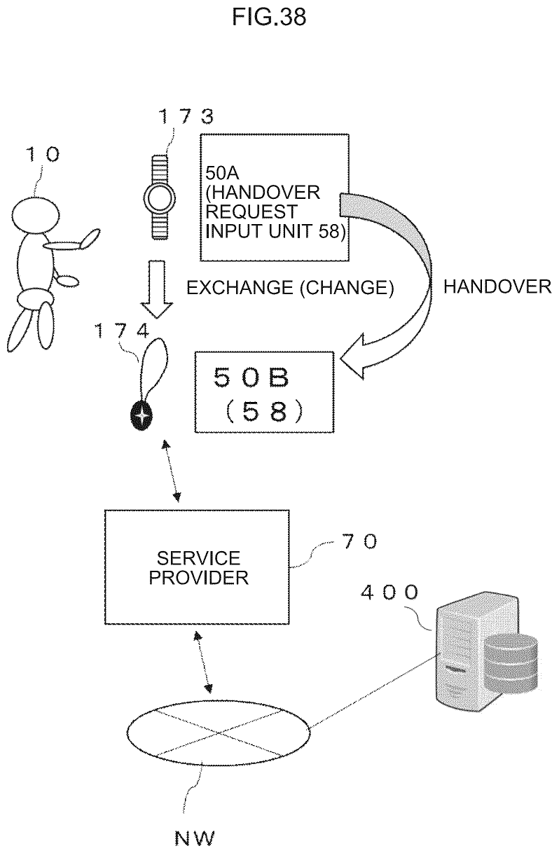

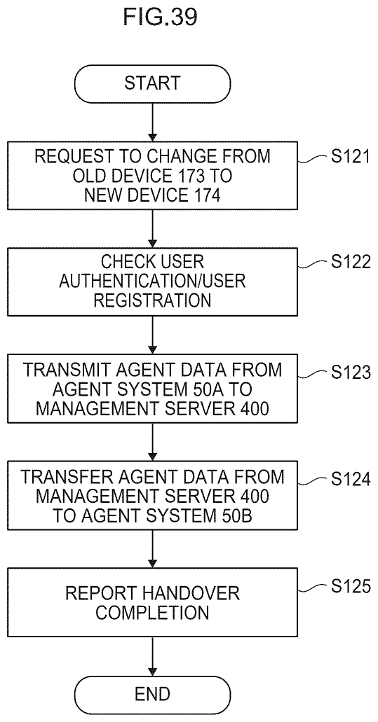

Next, a system 5 according to an eighth embodiment will be described with reference to FIGS. 38 and 39. The system 5 of the eighth embodiment is a system using a device on which the agent system 50 is mounted, similarly to the first embodiment.

In addition to smartphones, types of portable devices that can be owned by users, such as smart watches, smart glasses, and smart pendants, have been diversified, and one user usually owns a plurality of types of devices. The system 5 of the eighth embodiment is configured to be able to hand over data stored in the agent system 50 included in one device among a plurality of devices owned by one user to the agent system 50 included in another device. The term “owned” as used herein is not limited to a case in which a user properly purchases a device that is movable property and is an owner in a narrow sense under the Civil Code, and is also used in a meaning including a case in which the user has a legitimate right to use the device by a method such as lending, renting, or leasing.

As an example, the handover operation can be executed by a management server 400 that manages the agent system 50. FIG. 39 is a flowchart illustrating a handover operation of the agent system under the management of the management server 400 in the system 5 of the eighth embodiment.

FIG. 39 illustrates, as an example, a procedure in a case in which the user 10 wants to change the device to be used from a smart watch 173 to a smart pendant 174 while interacting with a character set in an agent system 50A in the smart watch 173 owned by the user. In this case, the user 10 accesses the management server 400 and makes a handover request for change from the old device (smart watch 173) to the new device (smart pendant 174) (step S121). The handover request can be made via, for example, a handover request input unit 58 provided in the agent system 50 of the smart watch 173 or the smart pendant 174. The handover request may include, in addition to user information (a user ID, a password, and the like) indicating the user 10 himself/herself, device IDs of new and old devices to be transferred, and the like. The handover request may be performed through an operation of the old device, may be performed through an operation of the new device, or may be performed by a device other than the old and new devices (for example, a personal computer or a smartphone). The handover request may also be made offline.

Upon receiving this request, the management server 400 checks the user information (the user ID and the password) indicated in the handover request, performs user authentication, and checks user registration of the presented device ID (step S122). In a case in which the user registration has not been completed, a message indicating that the change according to the change request is performed after the user registration is completed is output. In a case in which the user registration is completed, the processing proceeds to the next step.

In a case in which the user authentication and the user registration are completed, in the management server 400, various data stored in the agent system 50A is transmitted from the agent system 50A of the smart watch 173, which is an old device, to the management server 400 under the management of the management server 400, and is temporarily stored in the management server 400 (step S123).

Subsequently, the data temporarily stored in the management server 400 is transferred from the management server 400 to the agent system 50B of the smart pendant 174 that is a new device (step S124). In a case in which the transfer operation is completed, the management server 400 transmits a message reporting completion of the transfer to the account of the user 10 (step S125). Instead of the management server 400 reporting the completion of the transfer, the smart pendant 174 that is a transfer destination may perform a notification of completion of the transfer. With the above operation, the user 10 can use the data of the agent system 50A of the old device used by the user in the agent system 50B of the new device. For example, information regarding a character set in the smart watch 173 of the old device, the interaction history performed at that time, and the emotion data generated by the emotion engine 53 can also be used in the smart pendant 174 that is a new device. Even when a plurality of owned devices are appropriately switched and used, it is possible to continue the interaction in the old device even in the new device. In the present embodiment, an example in which data of the agent system is handed over under the management of the management server 400 has been described as an example, but the handover operation is not limited thereto. Under certain regulations, the handover operation of data may be directly executed between new and old devices through, for example, short-range wireless communication or wired connection. The same applies to the following embodiments.

### Ninth Embodiment

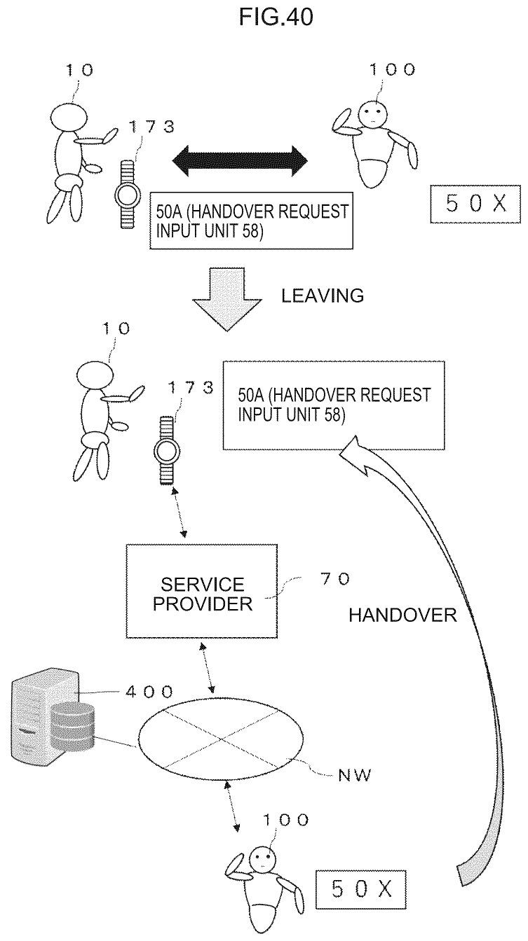

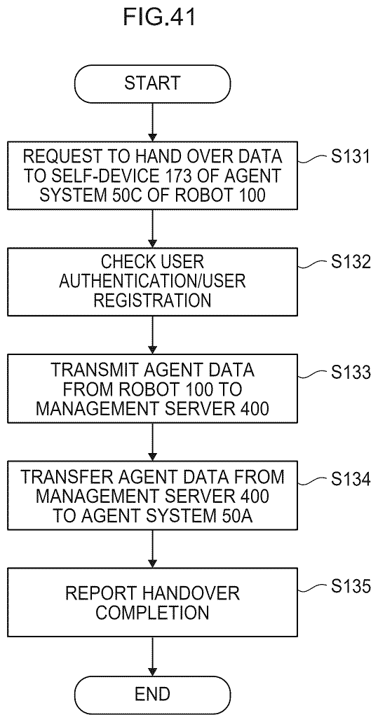

Next, a system 5 according to a ninth embodiment will be described with reference to FIGS. 40 and 41. The system 5 of the ninth embodiment is a system using a device on which the agent system 50 is mounted, similarly to the first embodiment, and has a feature related to handover of data in a case of interacting with the robot 100 or an external device.

As illustrated in FIG. 40, although the robot 100 and the user 10 are interacting with each other, the user 10 may leave the robot 100 to go home or move to the next destination, and move out of the field of view of the robot 100. In this case, the system 5 of the ninth embodiment operates to transfer data of an agent system 50X included in the robot 100 to an agent system 50A of the device (for example, the smart watch 173) owned by the user 10. That is, the data of the agent system 50X of the robot 100 is handed over by the agent system 50A of the device (smart watch 173) owned by the user 10, and the interaction between the robot 100 and the user 10 can be continued through the device owned by the user 10.

FIG. 41 is a flowchart for describing a handover operation of the agent system under the management of the management server 400. Here, it is assumed that the user 10 owns the smart watch 173 as an example, and is interacting with the robot 100 without using the smart watch 73.

In this situation, it is assumed that the user 10 leaves the robot 100 after interaction with the robot 100 and moves to another place where interaction is not possible. In this case, in a case in which the user 10 desires to continue the interaction with the robot 100, the user may request the management server 400 to hand over the data of the agent system 50X of the robot 100 to a handheld device (for example, the smart watch 173) (step S131). The handover request may include the device ID of the device that is a handover target and the like in addition to the user information (the user ID and the password) indicating the user 10 himself/herself.

Upon receiving this request, the management server 400 checks the user information (the user ID and the password) indicated in the handover request, performs user authentication, and checks user registration of the presented device ID (step S132). In a case in which the user registration has not been completed, a message indicating that handover is to be performed in accordance with the handover request after the user registration is completed is output, and in a case in which the user registration is completed, the processing proceeds to the next step. In this flowchart, the handover of the agent system is performed starting from the handover request from the user 10, but instead, the robot 100 may detect leaving of the user 10 and start the handover operation.

In a case in which the user authentication and the user registration of the management server 400 are completed, various types of data stored in the agent system 50X are transmitted from the agent system 50X of the robot 100 to the management server 400 under the management of the management server 400, and is temporarily stored in the management server 400 (step S133).

Subsequently, the data temporarily stored in the management server 400 is transferred from the management server 400 to the agent system 50B of the smart watch 173(step S134). In a case in which the transfer operation is completed, the management server 400 transmits a message reporting completion of the transfer to the account of the user 10 (step S125). Instead of the management server 400 reporting completion of transfer, the smart watch 173 that is a transfer destination may perform a notification of completion of the transfer. With the above operation, the user 10 can use the data of the agent system 50A of the robot 100 having been interacting in the agent system 50A of the smart watch 173 which is a new device to be used after leaving the robot 100. For example, information regarding the character of the robot 100, a history of the interaction performed at that time, and emotion data generated by the emotion engine 53 can also be used in the smart watch 173 that is a new device. Therefore, even after leaving the robot 100, it is possible to continue the interaction with the robot 100 in the new device.

### Tenth Embodiment

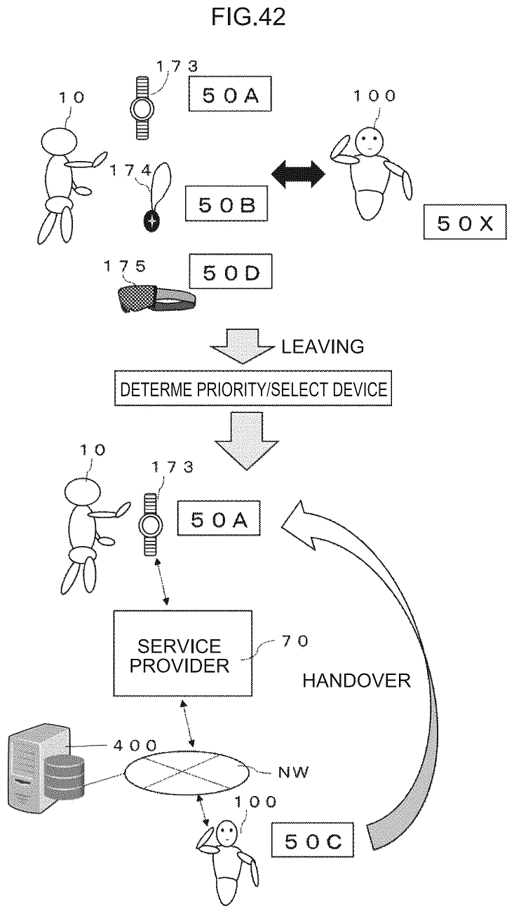

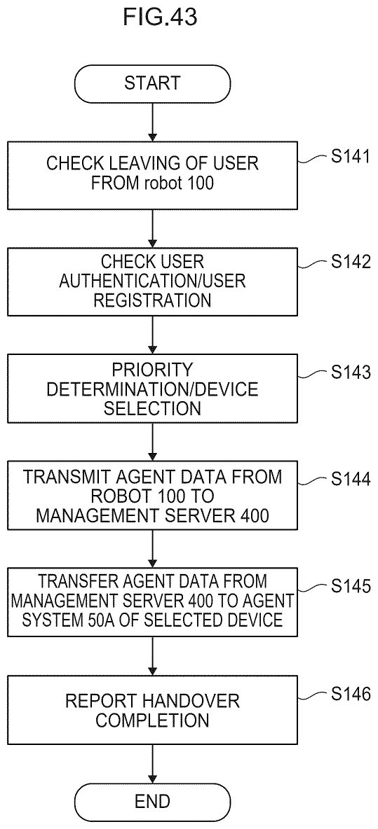

Next, a system 5 according to a tenth embodiment will be described with reference to FIGS. 42 and 43. The system 5 of the tenth embodiment has a feature related to handover of data in the case of interacting with the robot 100 or an external device, similarly to the ninth embodiment. The system 5 of the tenth embodiment is particularly effective in a case in which a user owns a plurality of types of devices.

As illustrated in FIG. 42, the user 10 initially owns a plurality of types of devices, for example, a smart watch 173, a smart pendant 174, and smart glasses 175, but interacts with the robot 100 without using the devices. However, thereafter, the user 10 may leave the robot 100 to return home or move to the next destination, and move out of the field of view of the robot 100. In this case, the system 5 of the tenth embodiment determines which device is to be used among a plurality of devices (173, 174, 175) owned by one user is most suitable for the robot 100 and the user 10 to have the smoother and more meaningful conversation. Here, a numerical value representing the degree to which the interaction can be smoothly and effectively performed is referred to as a “priority”, and a device having a high priority is selected as a handover target. The device determined to be the handover target with high priority hands over the data of the agent system 50X of the robot 100, similarly to the above embodiment. As a result, the interaction between the robot 100 and the user 10 can be continued through the device owned by the user 10.

FIG. 43 is a flowchart for describing a handover operation of the agent system under the management of the management server 400. Here, it is assumed that the user 10 owns a plurality of smart devices such as the smart watch 173, the smart pendant 174, and the smart glasses 175 as an example, and interacts with the robot 100 without using these devices 173 to 175.

In this situation, it is assumed that the user 10 leaves the robot 100 after interaction with the robot 100 and moves to another place where interaction is not possible. In this case, the management server 400 checks the leaving of the user 10 from the robot 100 according to a detection signal by the robot 100 or a request from the user (step S141). The management server 400 checks user authentication of the user 10 related to the leaving and user registration of the owned device (step S142).

Thereafter, the management server 400 determines priorities of a plurality of devices owned by the user 10 who has left (step S143), and selects a device having a high priority (step S144). As an example, the priority can be calculated using the following items as a determination material.
Interaction history data between the user 10 and the robot 100 before leaving
Environment of a position where the user 10 and the robot 100 have interacted before leaving
Emotion data of user 10 before leaving

For example, in a case in which there is a high possibility that the content of the subsequent interaction is related to the physical condition of the user from the interaction history data, the smart watch 173 that can easily take the physical condition data of the user can be determined to have a high priority. In a case in which it is determined that the subsequent interaction is highly likely to be related to the surrounding environment from the environment of the position where the interaction has been performed or the like, the smart pendant 174 that easily captures or detects the surrounding environment can be determined to have a high priority. Alternatively, a priority for determining which device is used by the user 10 to have a smoother and more meaningful conversation may be calculated from the history of the interaction or the like. For example, when it is determined that selecting the smart pendant 174 improves the appearance of the user and improves the reaction of the robot 10, the determination may be made by increasing the priority of the smart pendant 174. In a case in which it is determined that an intelligent appearance is given to the user 10 by selecting the smart glasses 175, the determination can be made by increasing the priority of the smart glasses 175.

In a case where a device having a high priority is selected, the management server 400 transmits various types of data stored in the agent system 50X from the agent system 50X of the robot 100 to the management server 40 under the management of the management server 400 and temporarily stores the data in the management server 400 (step S144).

Subsequently, the data temporarily stored in the management server 400 is transferred from the management server 400 to the agent system 50A of the selected device (for example, the smart watch 173) (step S145). When the transfer operation is completed, the management server 400 transmits, to the account of user 10, a message reporting to which device of the user 10 the data has been transferred (step S146). Instead of the management server 400 reporting completion of transfer, the device 174 that is transfer destination may perform a notification of completion of the transfer.

With the above operation, the user 10 can use the data of the agent system 50A of the robot 100 having been interacting in the agent system of the new device to be used after leaving the robot 100. In a case in which a plurality of devices are included, the data of the agent system of the robot 100 is automatically transferred to a device having a high priority, and thus, the user 10 can continue the interaction with the robot 10 even after leaving the robot 10.

### Eleventh Embodiment

Hereinafter, as an eleventh embodiment, action control executed at the time of a sudden emotion change in action control programmed in advance for a robot 100 as an electronic apparatus on which an agent system 50 is mounted will be described. The action control executed at the time of the emotion change of the present embodiment is executed by the action control unit 250 illustrated in FIG. 2.

The electronic apparatus is not limited to the robot 100, and may be any of other electronic apparatuses (dolls, stuffed toys, pendants, smart watches, smartphones, smart speakers, earphones, personal computers, and the like) on which the agent system 50 can be mounted.

The action of the robot 100 is determined according to the degree of emotion including “happy”, “angry”, “sad”, and “pleasant”. For example, as described above, a value (0 to 5 levels) indicating the intensity of each of “happy”, “angry”, “sad”, and “pleasant” is determined, and the robot 100 acts in conjunction with the emotion of the user 10 or acts according to the situation (brightness of a surrounding environment, a remaining battery level, or the like) in which the robot 100 is placed.

The value (0 to 5 levels) indicating the intensity of each emotion of “happy”, “angry”, “sad”, and “pleasant” is a value determined at the time of action execution, and it is possible to impart a so-called sharpness to the action of the robot by considering the process of reaching the value indicating the intensity of the emotion.

For example, in a case in which the emotion of “pleasant” changes to the emotion of “angry”, when an action is determined only with a value indicating the intensity of the current emotion, the same action is performed regardless of whether degree of the change is gradual or abrupt.

Therefore, in the present embodiment, the process until the value indicating the intensity of the emotion is determined is reviewed, and an action for clarifying the switching of the emotion is interposed between the action changes according to the degree of change in the emotion. As an example, in a case in which the emotion changes suddenly, the following action (vocal sound output is primarily performed) can be taken. The determination as to whether the change in emotion is sudden will be described later.

(Action 1) In a case in which a sudden change occurs from an emotion of “pleasant” to an emotion of “angry”, an action expressing that the emotion is switched is executed before the emotion is switched. Examples of the action expressing switching include vocal sound output such as “hum”.

(Action 2) In a case in which a sudden change occurs from an emotion of “sad” to an emotion of “pleasant”, an action expressing that the emotion is switched is executed before the emotion is switched. Examples of the action expressing switching include vocal sound output such as “Puh!” and “humming”.

In the above description, the example of expressing the switching of the emotions by using the vocal sound has been described. However, in addition to the vocal sound, the intonation of the onomatopoeia or speech, the facial expression (changes in eyebrows, eyes, mouth, and the like), the temperature (in particular, it is effective in a case of being in contact with a user like a wearable device), the color (complexion or color development state of some light sources), and the movement (restless actions such as foot tapping, bruxism, and breathing) may be simultaneously executed. Different types of expressions may be executed simultaneously (for example, dancing while humming a tune).

In the present embodiment, it is assumed that an inquiry about an action is made to the sentence generation model 55 (for example, ChatGPT). In this case, the speech is essential, but the action may be an action not including vocal sound as long as it is possible to notify the user of a change in emotion.

### (Determination of Degree of Change in Emotion)

The current emotion can be sufficiently determined as long as the values (0 to 5) indicating the intensities of “happy”, “angry”, “sad”, and “pleasant” are known. However, it is difficult to determine the degree of change in emotion with a numerical value at the present time.

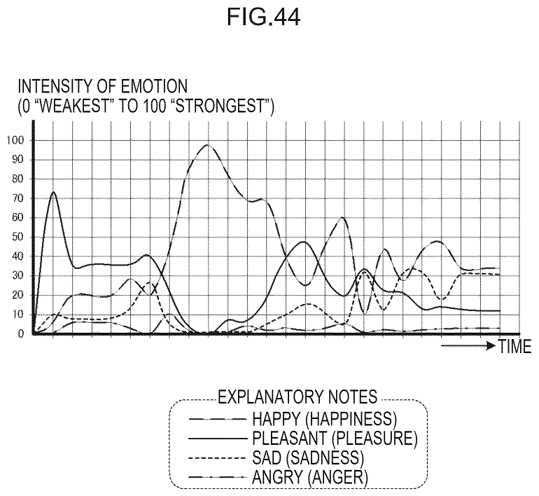

Therefore, in the present embodiment, as illustrated in FIG. 44, the intensity of each emotion (“happy”, “angry”, “sad”, and “pleasant”) is acquired and stored at regular time intervals, and the degree of change in the emotion is determined by comprehensively verifying each plot point.

In FIG. 44, the horizontal axis represents the time axis, and the vertical axis represents the intensity of each emotion. In FIG. 44, the emotion intensity is 0 (weakest) to 100 (strongest), but may be 8 bits (0 to 255).

The value (0 to 5 levels) indicating the intensity of each of “happy”, “angry”, “sad”, and “pleasant” described above can be determined, for example, by the relative relationship between the intensities of each emotion (numerical values on the vertical axis in FIG. 44) every minute. The determination of 0 to 5 levels is not limited to the characteristic diagram of FIG. 44, and may be determined by using another means.

On the other hand, in the present embodiment, the degree of emotion is determined on the basis of the characteristics in FIG. 44 separately from the values (0 to 5 levels) indicating the intensities of “happy”, “angry”, “sad”, and “pleasant”.

As a determination parameter of the degree of emotion, in addition to the real-time value of each emotion, a change rate, an average value in a past certain period, a relative difference from each emotion, and the like are calculated, and the degree of change is obtained on the basis of a predetermined emotion determination function.

In a case in which there is a change (for example, a change from “pleasant” to “angry”) in the emotion and the calculated degree of change is larger than a predetermined threshold, the change is determined as a sudden change (corresponding to Action 1 described above).

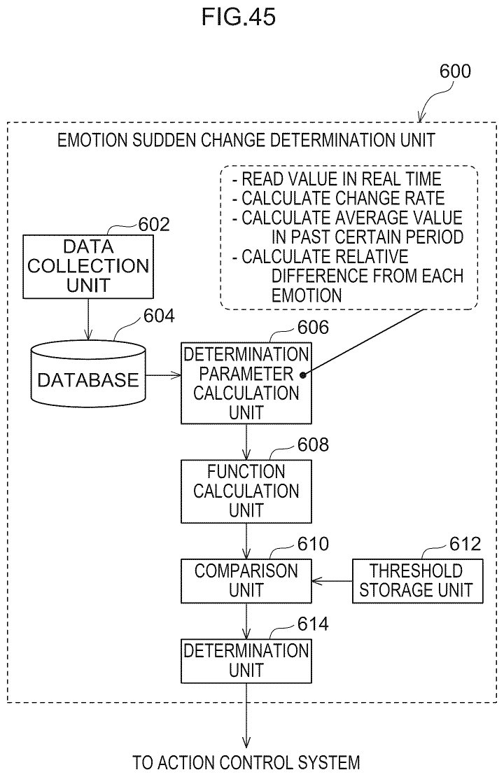

FIG. 45 is a functional block diagram of an emotion sudden change determination unit 600 that determines the presence or absence of a sudden change in emotion, set as a part of the function of the emotion determination unit 232 (see FIG. 2), based on the characteristic diagram of FIG. 44. Each control block of the emotion sudden change determination unit 600 in FIG. 45 is classified by function, and does not limit the hardware configuration, and may be an IC chip such as an application specific integrated circuit (ASIC) or a field programmable gate array (FPGA) in which some or all of the control blocks operate on the basis of a control program, or a software program.

A data collection unit 602 collects the value of the intensity of each emotion (read value on the vertical axis in FIG. 44) at regular time intervals (for example, 1 second) and stores the value in the database 604.

A determination parameter calculation unit 606 is connected to the database 604, and reads the value of the intensity of each emotion stored in the database 604 every 1 minute, for example, and calculates each determination parameter. In the present embodiment, in addition to the real-time value of each emotion, a change rate, an average value in a past certain period, a relative difference value from each emotion, and the like are calculated, and each value is sent to a function calculation unit 608.

The function calculation unit 608 obtains a degree of change on the basis of a predetermined emotion determination function, and sends the degree of change to a comparison unit 610. The comparison unit 610 reads a predetermined threshold from a threshold storage unit 612 and compares a calculated value calculated by the function calculation unit 608 with the threshold. The comparison result is sent to a determination unit 614, it is determined whether or not the change in emotion is sudden, and the determination result is sent to the action control system.

Here, in the case of determining that there is a sudden change in emotion, the action determination unit 236 of the agent system 50 inputs “What action should be interposed in switching of the sudden change in emotion (for example, in the case of Action 1, “pleasant” to “angry”)?” to the document generation model 55 (for example, ChatGPT).

In response to this input, an action (mainly vocal sound) at the time of switching is acquired from the sentence generation model 55. Examples of the answer include “Please say “Huh?” and, in accordance with this, perform an action of making a gesture such as a gesture of raising both hands slightly with the palm facing upward. “. In the agent system 50, this answer is analyzed and reflected in the action.

On the basis of the answer result, the action determination unit 236 determines an action expressing switching before the emotion is switched, and the action control unit 250 controls execution of the action.

As the action (vocal sound) expressing switching, in the case of Action 1, vocal sound such as “Huh?” is output. At the same time as the vocal sound output, it is preferable to execute an action such as gesture or facial expression as an action.

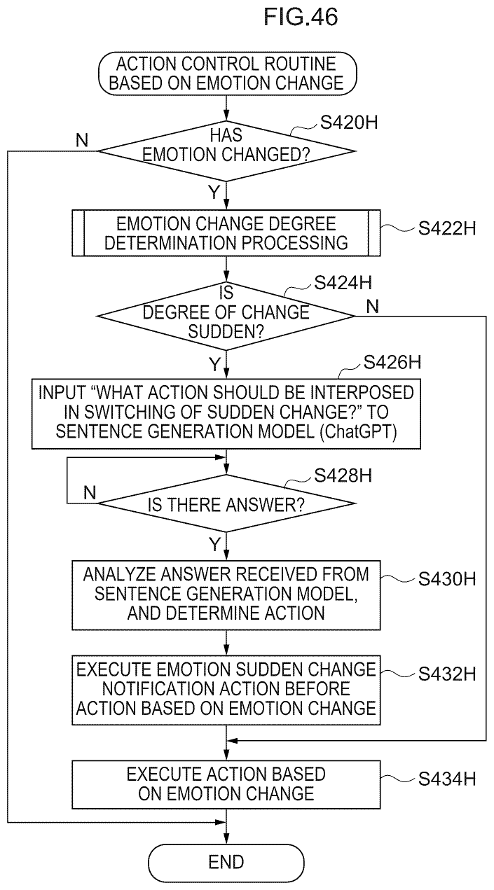

FIG. 46 is a control flowchart illustrating a flow of action execution processing executed by the action control system (mainly, the action execution unit 236 and the action control unit 250).

In step 420H, it is determined whether or not there is a change in emotion, and in a case in which a negative determination is made, this routine is ended. In a case in which an affirmative determination is made in step 420H, it is determined that there is a change in emotion, and the processing proceeds to step 422H.

In step 422H, emotion level determination processing is executed. The emotion level determination processing is executed by using the characteristic diagram of FIG. 44.

That is, as illustrated in FIG. 45, the data collection unit 402 collects the value of the intensity of each emotion at regular time intervals (for example, 1 second) and stores the value in the database 404.

The determination parameter calculation unit 406 reads the value of the intensity of each emotion stored in the database 404 every minute, for example, and calculates each determination parameter (a real time value, a change rate, an average value in a past certain period, a relative difference value with each emotion, or the like). The function calculation unit 408 obtains the degree of change on the basis of a predetermined emotion determination function, and compares the degree of change with a threshold to determine whether or not the change in emotion is sudden.

In the next step 424H, it is determined whether or not the degree of change is sudden on the basis of the determination result in step 422H, and in a case in which an affirmative determination (sudden change in emotion) is made, the processing proceeds to step 426H. In a case in which a negative determination (no sudden change in emotion) is made in step 424H, the processing proceeds to step 434H (that will be described later).

In step 426H, “What action should be interposed in switching of a sudden change?” is input to the sentence generation model 55 (ChatGPT).

In the next step 428H, it is determined whether or not there is an answer from the sentence generation model 55. In a case in which an affirmative determination is made in step 428H, the processing proceeds to step 430H where the answer received from the sentence generation model 55 is analyzed to determine an action. Next, the processing proceeds to step 432H where an emotion sudden change notification action is executed before the action based on the change in emotion, and the processing proceeds to step 434H.

As a result, the user 10 can clearly recognize the change in emotion of the robot 100, and can recognize that some irregular situation (abnormal situation, emergency, or the like) has occurred.

In step 434H, an action based on the change in emotion is executed. That is, in a case in which the emotion suddenly changes, the action based on the change in emotion is executed through the emotion sudden change notification action in step 430H. In a case in which the emotion does not suddenly change, the processing proceeds from step 424H and the action based on the change in emotion is executed without performing the emotion sudden change notification action.

As described above, in the present embodiment (the action control at the time of sudden change in emotion), in a case in which the degree of change in the emotion is determined to be sudden when the emotion changes to different types of emotions, it is possible to clearly notify the user that the change in emotion has occurred by interposing an action for appealing the change in emotion rather than simply performing an action in accordance with the changing emotion. Whether or not the change in emotion is sudden can be determined on the basis of the intensity of each of happiness, anger, sadness, and pleasure in consideration of parameters such as a real-time value, a change rate, an average value in a past certain period, and a relative difference from each emotion.

In the above embodiment, in a case in which there is a sudden change in the action on the basis of only the emotion of the robot 100 itself, the action indicating the switching of the emotion is interposed. However, in consideration of the emotion of the user, an action indicating a trigger for the switching of the emotion may be added.

For example, in a case in which the user is likely to be intimidated or show fear, an action to reduce the rate of the change in emotion is added. This can reduce the sense of discouragement or fear of the user.

In the present embodiment, the change in emotion of the robot 100 has been described. However, in a case in which the agent system 50 is a wearable device, a trigger of the change in emotion may be reported by using vibration or a temperature change.

In the present embodiment, the following embodiments can be considered. There may be a part overlapping with the above embodiment.

(Embodiment 1) The emotion sudden change notification action includes notification through hearing, such as sound (sound, intonation, and onomatopoeia). For example, “All right!!” is exemplified.

(Embodiment 2) The emotion sudden change notification action includes visual notification (action). For example, there is a change in the facial expression (eyebrows, eyes, mouth, and the like) of the robot 100. The visual notification may be a color change of a part of the complexion, the lamp, or the like of the robot 100, or the robot 100 may be restless or execute a peculiar gesture such as foot tapping.

(Embodiment 3) The emotion sudden change notification action includes a notification through tactile sense (temperature change). For example, a contact temperature in the case of the wearable device 72, or hot air blowing in the case of the robot 100 may be used.

(Embodiment 4) The expression of a state change notification function is made different according to the direction of the change in emotion (pleasant->angry->pleasant) and the degree of change.

(Embodiment 5) The degree of emphasis of expression is adjusted according to the degree of change in emotion. That is, the greater the degree of change, the higher the degree of emphasis of the expression. The smaller the degree of change, the lower the degree of emphasis of the expression. A primary or numerical proportional relationship or a stepwise relationship may be used.

(Embodiment 6) The emotion of the user 10 is taken into consideration. In other words, when the user 10 feels intimidated or scared, the change in emotion that alleviates the intimidation or scare is executed. When the user 10 enjoys, a change in emotion is executed to encourage and excite the user 10.

### Twelfth Embodiment

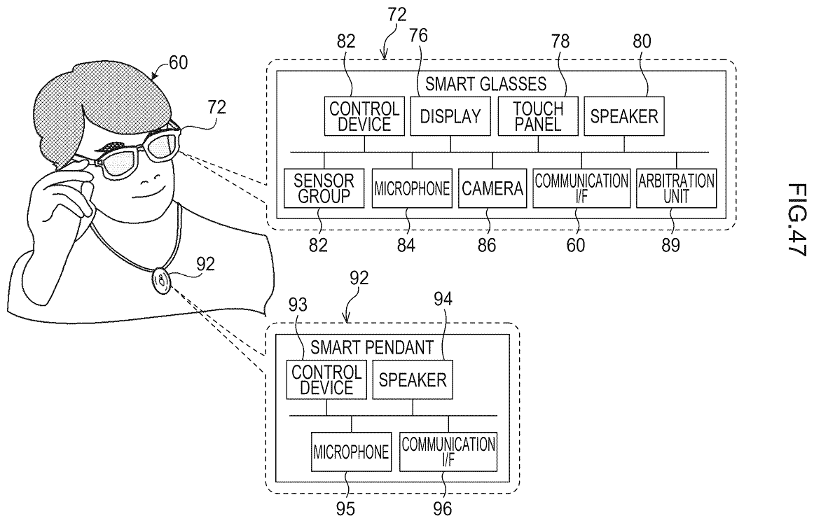

Hereinafter, with reference to FIG. 47, arbitration in a case in which two or more agent systems 50 conflict in action control programmed in advance with respect to the agent system 50 will be described as a twelfth embodiment.

As illustrated in FIG. 47, in the present embodiment, it is assumed that the user 60 (see FIG. 7) is under the service provision of two or more kinds of agent systems 50. As an example, an example in which the user 60 wears the smart glasses 72 and the smart pendant 92 each having a function as an agent system will be described. The user 60 is equivalent to the user 10 illustrated in FIG. 1.

The smart glasses 72 and the smart pendant 92 worn by the user 60 respectively include agent systems 50A and 50B having functions similar to those of the agent system 50 illustrated in FIG. 7.

That is, the agent systems 50A and 50B include, as common functions, an interaction processing unit 51, a character setting unit 52, an emotion engine 53, an interaction history storage unit 54, a sentence generation model 55, a command acquisition unit 56, and a robotic process automation (RPA) 57. Since the details of each unit are the same as those of the agent system 50 illustrated in FIG. 7 and have been described above, the detailed description thereof will be omitted here.

The hardware configuration of the smart glasses 72 includes a control device 74, a display 76, a touch panel 78, a speaker 80, a sensor group 82, a microphone 84, a camera 86, and a communication I/F 88.

On the other hand, the hardware configuration of the smart pendant 92 includes a control device 93, a speaker 94, a microphone 95, and a communication I/F 96.

In implementing the present embodiment, the major difference is that the smart glasses 72 include the camera 86, whereas the smart pendant 92 does not include the camera.

Here, in the present embodiment, an arbitration unit 89 is provided in the agent system 50A mounted on the smart glasses 72. In other words, the agent system 50A including the arbitration unit 89 is an “arbitration agent”, and the agent system 50B not including the arbitration unit 89 is a “non-arbitration agent”. Although the arbitration agent is single, there may be a plurality of non-arbitration agents.

The arbitration unit 89 has a function of arbitrating an optimum answer as an answer to the user 60 when the agent systems 50A and 50B provide answers to the speech of the user 60 in a case in which two answers are different.

That is, when the user 60 makes speech, the microphone 84 of the smart glasses 72 and the microphone 95 of the smart pendant 92 collect sound, and the agent systems 50A and 50B acquire answers to the speech of the user 60 by using the function of the sentence generation model 55.

The agent systems 50A and 50B speak the respectively acquired answers to the user 60, but the content of the speech may prompt different decision-making (for example, giving an instruction for different actions for one event) of the user 60 (answer mismatch).

Therefore, when there is a mismatch between the answers, the arbitration unit 89 derives an optimum answer (arbitration processing) on the basis of a predetermined condition, and executes speech based on the arbitration result.

As the predetermined condition, for example, an adoption history of the user 60 when there was a mismatch between answers in the past is used. An answer of an agent having the highest adoption ratio is selected in the adoption history.

As another condition, for example, in a case in which the speech of the user 60 relates to a type of dish, it is conceivable to provide a recommended dish in consideration of the weather, temperature, time period, and the like of the day.

The user 60 can execute a satisfactory action while listening to the opinions of the plurality of agent systems 50A and 50B and receiving the optimum answer.

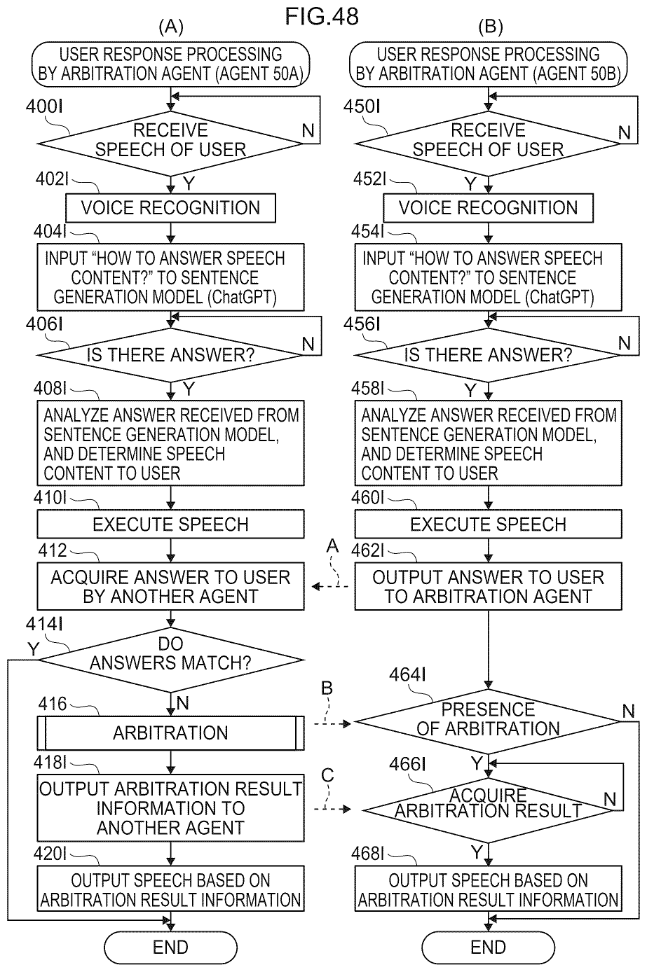

FIG. 48 is a control flowchart illustrating a flow of response processing to speech of the user 60, executed by each of the control device 74 of the agent system 50A and the control device 93 of the agent system 50B.

### (User Response Processing Using Arbitration Agent)

FIG. 48(A) is a control flowchart illustrating a flow of response processing to speech of the user 60, executed by the control device 74 of the agent system 50A.

In step 4001, it is determined whether or not speech of the user 60 has been received (whether or not sound has been collected), and in a case of a negative determination, standby is performed until an affirmative determination is made.

In a case in which an affirmative determination is made in step 4001, the processing proceeds to step 4021 to execute voice recognition on the collected speech, and then the processing proceeds to step 404I to input “How to answer the speech content?” to the sentence generation model 55 (for example, ChatGPT).

In the next step 406I, it is determined whether or not there is an answer from the sentence generation model 55, and in the case of a negative determination, standby is performed until an affirmative determination is made.

In a case in which the affirmative determination is made in step 406I, the processing proceeds to step 4081, the answer received from the sentence generation model 55 is analyzed, speech content to the user 60 is determined, and the processing proceeds to step 410I. In step 410I, speech directed to the user 60 is executed. The speech content may be determined on the basis of the information regarding the user stored in the smart glasses 72 without using the sentence generation model 55.

Here, in the next step 412I, an answer (speech) to the user 60 by another agent (non-arbitration agent) is acquired as a function of the arbitration agent. This acquisition is based on the processing in step 462 in FIG. 48(B) (see the dotted arrow A in FIG. 48).

In the next step 414I, it is determined whether the answers match. In step 414I, in a case in which a negative determination (speech mismatch determination) is made, the processing proceeds to step 416I, and arbitration processing is executed. In a case in which an affirmative determination (speech match determination) is made in step 414I, arbitration is not necessary, and thus the routine is ended. Whether or not to execute the arbitration processing is reported to the non-arbitration agent (see the dotted arrow B in FIG. 48).

In the arbitration processing in step 416I, an optimum answer is derived on the basis of a predetermined condition (for example, the adoption history information of the user 60). In the next step 418I, the arbitration result information is output to the other agent (see the dotted arrow C in FIG. 48), and the processing proceeds to step 420I, and the speech based on the arbitration result is output, and this routine is ended.

### (User Response Processing Using Non-Arbitration Agent)

FIG. 48(B) is a control flowchart illustrating a flow of response processing to speech of the user 60, executed by the control device 93 of the agent system 50B.

In step 450I, it is determined whether or not speech of the user 60 has been received (whether or not sound has been collected), and in a case of a negative determination, standby is performed until an affirmative determination is made.

In a case in which an affirmative determination is made in step 450I, the processing proceeds to step 452I to execute voice recognition for the collected speech, and then the processing proceeds to step 454I to input “How to answer the speech content?” to the sentence generation model 55 (for example, ChatGPT).

In the next step 456I, it is determined whether or not there is an answer from the sentence generation model 55, and in the case of a negative determination, standby is performed until an affirmative determination is made.

In a case in which the affirmative determination is made in step 456I, the processing proceeds to step 4581, the answer received from the sentence generation model 55 is analyzed, speech content to the user 60 is determined, and the processing proceeds to step 460I. In step 460I, speech directed to the user 60 is executed. The speech content may be determined on the basis of the information regarding the user stored in the smart pendant 92 without using the sentence generation model 55.

Here, in the next step 4621, an answer (speech) for the user 60 is output to the adjustment agent as a function of the non-arbitration agent (see the dotted arrow A in FIG. 48).

In the next step 464I, the presence or absence of arbitration is determined. This determination material is based on the processing in step 416I in FIG. 48(A) (see the dotted arrow B in FIG. 48). In a case in which a negative determination is made in step 464I, it is determined that there is no arbitration, and this routine is ended. In a case in which an affirmative determination is made in step 464I, it is determined that arbitration has been performed, and the processing proceeds to step 466I to acquire an arbitration result. This acquisition is based on step 418I in FIG. 48(A) (see the dotted arrow C in FIG. 48).

In a case in which a negative determination is made in step 466I, standby is performed until an affirmative determination is made, and in a case in which an affirmative determination is made, the processing proceeds to step 468I, and speech based on the arbitration result information is output, and this routine is ended. Although the detailed description of the speech based on the arbitration result information is omitted here, speech content indicating agreement with the arbitration result may be prepared in advance, or “The result of arbitration was oo, but how to say?” or the like may be input to the sentence generation model 55 and the speech may be made on the basis of an answer of the sentence generation model 55 as in step 454I.

In the present embodiment, the processing of responding to the user 60 using the two devices (the smart glasses 72 and the smart pendant 92) has been described, but the user 60 may be provided with three or more types of devices (the agent system 50).

As described above, in the present embodiment, when the user 60 murmurs for some answer, a plurality of agents collect vocal sound, and in a case in which answers obtained through vocal sound analysis show different results, arbitration is performed on the agent system side before the user 60 makes a final selection. As a result, it is possible to eliminate the user 60's hesitation in selection and to increase the probability of selecting an optimal action.

The arbitration in the present embodiment does not mean arbitration for conflict between users, but refers to determining a priority in a case in which agents give different pieces of advice.

For example, in a case in which the proposal of the agent 50A has a higher adoption ratio than the proposal of the agent 50B, the proposal of the agent 50A is preferentially adopted. In a case in which arbitration is performed between the agent 50A of the smart glasses 72 (with the camera 86) and the agent 50B of the smart pendant 92, the expression of the user 60 is acquired from the smart glasses 72, and which proposal to adopt can be determined. In this case, by sharing the image from the camera 86 not only with the smart glasses 72 but also with the smart pendant 92, it is possible to improve the proposal accuracy of each of the agents 50A and 50B.

In a case in which the image from the camera is not shared with the smart pendant, the proposal of the agent 50A may be prioritized from the beginning.

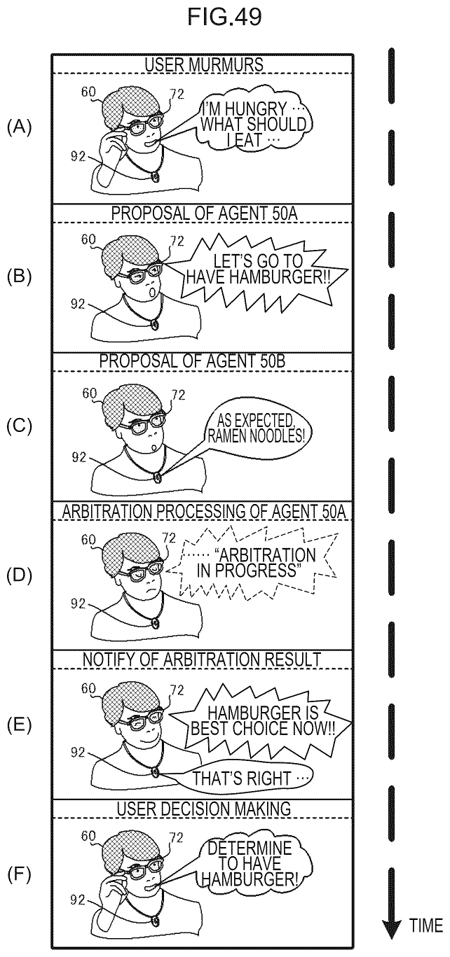

FIG. 49 illustrates an execution example of the flowchart of FIG. 48, and illustrates a situation in which frames A to F are executed in time series in this order.

(Frame A) The user 60 murmurs, “I'm hungry . . . what should I eat . . . ” The agents 50A and 50B each collect murmur of the user 60 and perform voice recognition (step 4001 and step 4021 in FIG. 48(A), and step 450I and step 4521 in FIG. 48(B)).

(Frame B) The agent 50A makes an inquiry about the murmur of the user 60 to the sentence generation model 55, and replies “Let's go to eat hamburgers!!” (steps 404I to 4101 in FIG. 48(A)).

(Frame C) The agent 50B replies “On the second thought, ramen noodles!” to the murmur of the user 60 (steps 454I to 4601 in FIG. 48(B)).

In this example, the agent 50B has answered (frame C) in consideration of the answer (frame B) of the agent 50A, but the order of the answers may be reversed, or the answers may not affect the answers of other agents. In the frame B and the frame C, simultaneous speaking or repeated answers may be performed, and in a certain sense, it is possible to form a situation in which a plurality of people are discussing, and to give enjoyment to the process up to the decision making of user 60.

(Frame D) Arbitration is performed by the agent 50A (step 416I in FIG. 48(A)).

In this case, the arbitration is performed in a state in which there is an answer from the agent 50A and the agent 50B one by one in the frame B and the frame C. However, in a case in which there is a process of discussion, the arbitration may be started after a predetermined discussion time has elapsed.

(Frame E) In a case in which the answer of the agent 50A is adopted as a result of the arbitration, the agent 50A says “Hamburger is the best choice now!! “. (step 4201 in FIG. 48(A))

The side rejected through the arbitration (the agent 50B) may make speech accepting the arbitration result such as “That's right . . . ” (step 4681 in FIG. 48(B)).

(Frame F) When the user 60 says “I decided to eat hamburgers!!” according to the arbitration result, the agents 50A and 50B collect the speech of the user 60 and perform voice recognition, thereby ending the series of processing.

In the execution example in FIG. 49, the agent 50A determines an answer on the basis of a predetermined condition (such as the adoption history of the user 60 when there was a mismatch between answers in the past). However, the current state of the user 60 may be imaged by the camera 86 mounted on the smart glasses 72, and arbitration may be performed by using the imaged information. The camera function may be provided in each device, or in a case in which a camera is not mounted like the smart pendant 92, information imaged by another device (here, the camera 86 of the smart glasses 72) may be shared.

In addition to the current state or instead of the current state, a past action history image of the user 60 up to the current state may be used (yesterday's meal menu information, exercise amount, dining partner, and the like).

### Thirteenth Embodiment

In a thirteenth embodiment, an order terminal 3400 using an agent system 50 (see FIG. 7) configured by using some or all of the functions of the action control system (see FIG. 2) will be described. Portions having configurations similar to those of the above-described embodiment will be denoted by the same reference numerals, and description thereof will be omitted or simplified. Hereinafter, a case in which the order terminal 3400 is installed at a guest seat of a restaurant will be described. The order terminal 3400 of the present embodiment is a terminal that transmits a user's order to an order processing apparatus (not illustrated) that processes the order.

### Configuration

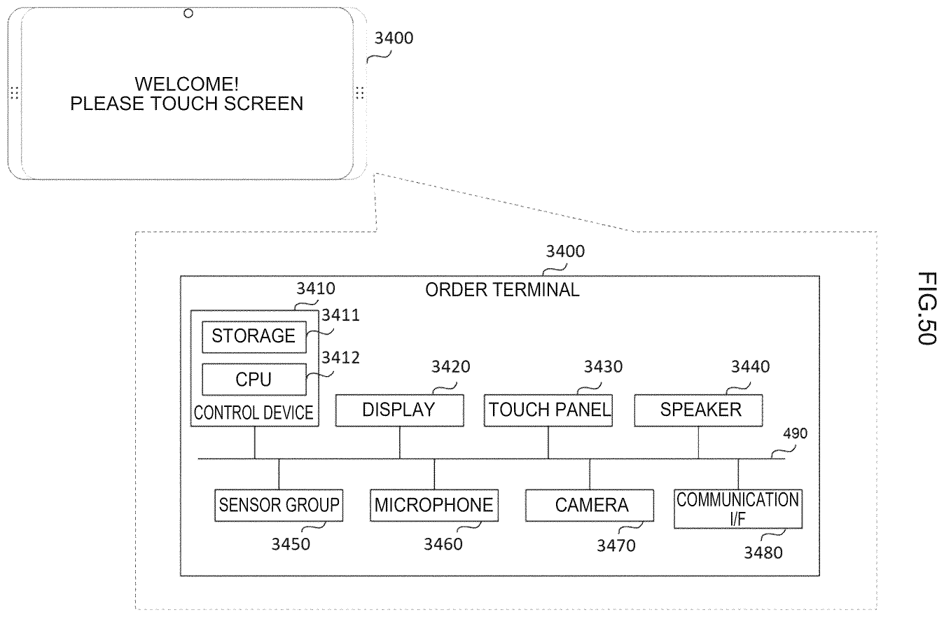

FIG. 50 schematically illustrates an example of a hardware configuration of the order terminal 3400 according to the thirteenth embodiment. The order terminal 3400 is a tablet-type smart device, and is used by the user 60 similarly to a general smart device. The order terminal 3400 includes a control device 3410, a display 3420, a touch panel 3430, a speaker 34340, a sensor group 3450, a microphone 3460, a camera 3470, and a communication I/F 3480.

The control device 3410 is a device that controls the entire order terminal 3400, and includes, for example, a storage 3411, a CPU 3412, and a memory (not illustrated).

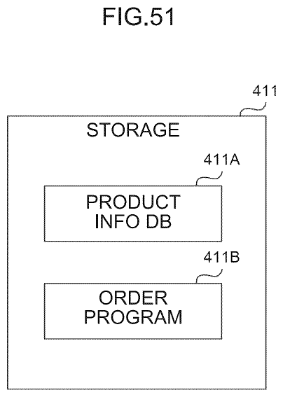

FIG. 51 schematically illustrates an example of a configuration of the storage 3411 of the order terminal 3400 according to the thirteenth embodiment. The storage 3411 according to the thirteenth embodiment includes a product information database 3411A and an order program 3411B.

The product information database 3411A is a database that stores information regarding menus provided at restaurants. Examples of the information regarding the menu include a menu name, an image photograph of the menu, a description of the menu, and a price. The menu provided at a restaurant is an example of a “product”.

The order program 3411B is a program that executes processing including order placement processing and emotion determination processing that will be described later. The product information database 3411A and the order program 3411B may be stored in a memory (not illustrated).

The CPU 3412 in FIG. 50 is a central processing unit, and executes various programs and controls each unit.

The display 3420 is, for example, a liquid crystal display. The display 3420 is provided, for example, in a front portion of the order terminal 3400, and the display content can be visually recognized by the user 60. The touch panel 3430 receives an input from the user 60. The speaker 34340 outputs vocal sound indicating various types of information to the user 60.

The sensor group 3450 detects a state of the user 60. The sensor group 3450 includes a plurality of sensors. For example, the sensor group 3450 includes a 3D depth sensor, a distance sensor, an acceleration sensor, and a temperature sensor (not illustrated). These sensors are merely examples, and it is a matter of course that other sensors may be mounted in order to detect the state of the user 60.

The microphone 3460 acquires vocal sound output by the user 60 or environmental sound around the order terminal 3400. The camera 3470 can image surroundings of the order terminal 3400. The camera 3470 can also image the face of the user 60. The camera 3470 is, for example, a CCD camera. The communication I/F 3480 has a communication function between the order terminal 3400 and the outside. The control device 3410, the display 3420, the touch panel 3430, the speaker 34340, the sensor group 3450, the microphone 3460, the camera 3470, and the communication I/F 3480 are connected to a bus 3490.

### (Function)

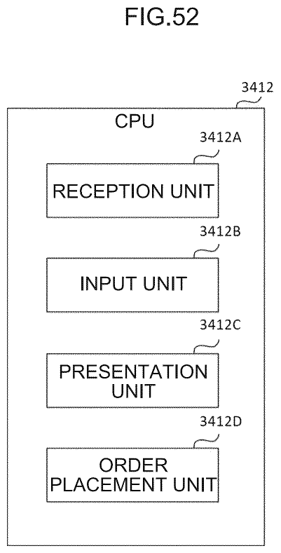

FIG. 52 schematically illustrates an example of a functional configuration of the order terminal 3400 according to the thirteenth embodiment. The order terminal 3400 of the present embodiment functions as a reception unit 3412A, an input unit 3412B, a presentation unit 3412C, and an order placement unit 3412D when the CPU 3412 executes an order program 3411B. The order terminal 3400 can use the function of the agent system 50 (see FIG. 7). Here, using the agent system 50 includes that the control device 3410 has a function similar to that of the agent system 50 and uses the function, and also includes an aspect in which the order terminal 3400 communicates with the outside (for example, the server) via the communication I/F 3480 to use the agent system 50 stored outside the order terminal 3400.

The reception unit 3412A has a function of receiving information regarding menu selection. Specifically, the reception unit 3412A receives selection of a menu using vocal sound of the user 60 via the microphone 3460. The information regarding menu selection includes information regarding a menu name, a quantity, a provision timing, and the like of a menu selected by the user 60. The reception unit 3412A may receive an input from the user 60 through the touch panel 3430. The menu selection is an example of “ordering a product”. The information regarding menu selection is an example of “order information”.

The reception unit 3412A has a function of receiving a reply of the user 60. Specifically, the reception unit 3412A receives whether or not a reply of the user 60 to information presented by the presentation unit 3412C that will be described later is affirmative. The reply of the user 60 is an example of an “answer of the user”.

The input unit 3412B has a function of inputting information regarding menu selection to a sentence generation model 55 (see FIG. 7) that will be described later. Specifically, the input unit 3412B inputs the information regarding the menu selection from the user 60 received by the reception unit 3412A to the sentence generation model 55 of the agent system 50.

The sentence generation model 55 of the agent system 50 of the present embodiment in FIG. 7 has a function of generating a menu name corresponding to information regarding menu selection. Specifically, the sentence generation model 55 generates a menu name corresponding to the information regarding menu selection of the user 60 input from the input unit 3412B with reference to the product information database 3411A (see FIG. 51). The sentence generation model 55 can generate information regarding a quantity corresponding to the information regarding the menu selection of the user 60 input from the input unit 3412B.

The presentation unit 3412C in FIG. 52 has a function of presenting information for checking the information regarding menu selection. Specifically, the presentation unit 3412C displays lines of the agent determined by the interaction processing unit 51 (see FIG. 7) of the agent system 50 that will be described later on the display 420 or outputs the lines from the speaker 440. The presentation unit 4312C may output lines of the agent from the speaker 3440 and display information regarding a menu related to the lines on the display 3420. The information for checking the information regarding the menu selection is an example of “check information”. The interaction processing unit 51 is an example of a “conversation processing unit”.

The interaction processing unit 51 of the agent system 50 according to the present embodiment in FIG. 7 has a function of determining lines of the agent on the basis of a menu name and an emotion value. Specifically, the interaction processing unit 51 determines the lines of the agent for checking the menu selected by the user 60 on the basis of the menu name generated by the sentence generation model 55 and the emotion values of the user 60 and the agent estimated by the emotion engine 53 that will be described later. The interaction processing unit 51 may determine the lines of the agent on the basis of only the emotion value of the user 60 estimated by the emotion engine 53 or only the emotion value of the agent. The lines of the agent for checking the menu are an example of “speech content”.

The emotion engine 53 of the agent system 50 according to the present embodiment has a function of determining emotions of the user 60 and the agent who has a conversation with the user 60. Specifically, the emotion engine 53 determines an emotion value indicating the emotion of the user 60 and an emotion value of the agent from a state of the user 60 recognized by the user state recognition unit 230 (see FIG. 2) of the action control system that will be described later. The emotion engine 53 includes the emotion determination unit 232 (see FIG. 2) of the action control system. The emotion engine 53 is an example of an “emotion determination unit”.

The user state recognition unit 230 (see FIG. 2) of the action control system used by the agent system 50 of the present embodiment has a function of acquiring the state of the user 60. Specifically, the user state recognition unit 230 acquires the state of the user 60 on the basis of information analyzed by the sensor group 3450, the microphone 3460, and the camera 3470. The user state recognition unit 230 is an example of an “acquisition unit”.

The order placement unit 3412D in FIG. 52 has a function of ordering a menu according to a reply of the user 60. Specifically, in a case in which the reply of the user 60 received by the reception unit 412A to the information presented by the presentation unit 3412C is affirmative, the order placement unit 3412D orders a menu corresponding to the information.

### (Order Placement Processing)

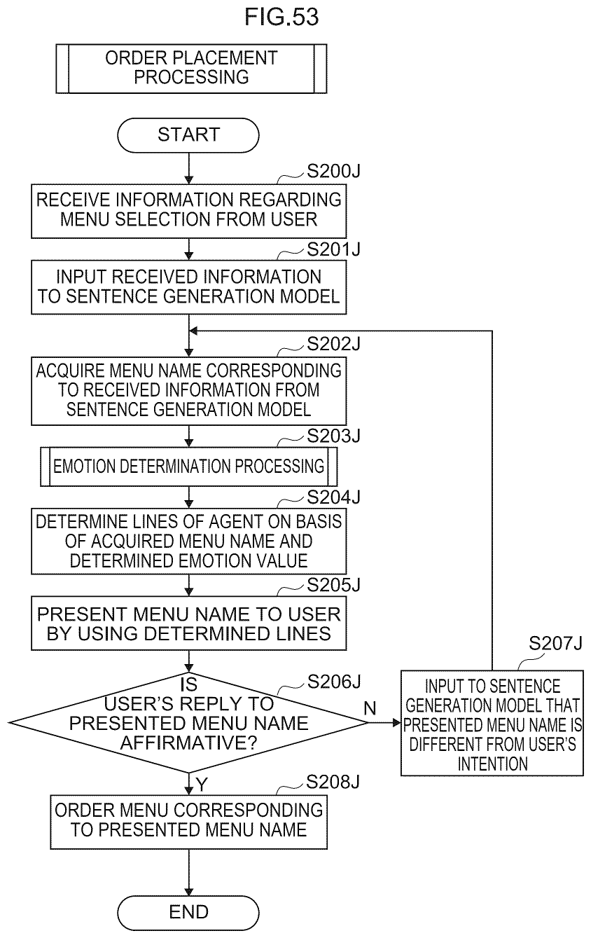

FIG. 53 schematically illustrates an example of a flow of order placement processing according to the thirteenth embodiment. The order placement processing of the thirteenth embodiment is processing executed when the order terminal 3400 receives an order from the user 60.

In step S200J in FIG. 53, the CPU 3412 receives information regarding menu selection from the user 60. As an example, the CPU 3412 receives information “Four beer, fried” from the user 60 in vocal sound via the microphone 3460.

In step S201J, the CPU 3412 inputs the received information to the sentence generation model 55. Specifically, the CPU 3412 inputs the information regarding the menu selection received in step S200J to the sentence generation model 55.

In step S202J, the CPU 3412 acquires menu names corresponding to the received information from the sentence generation model 55. Specifically, the CPU 3412 acquires the menu names generated by the sentence generation model 55 on the basis of the information input in step S201J. As an example, the CPU 3412 acquires “draft beer, medium mug” and “bottled beer” as menu names corresponding to information regarding “beer”, and acquires “fried young chicken” and “fried chicken wings” as menu names corresponding to information regarding “fried”.

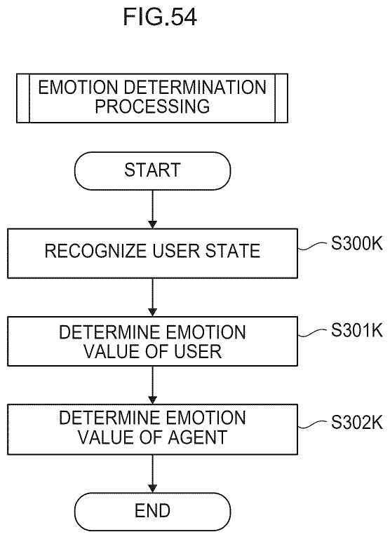

In step S203J, the CPU 3412 executes emotion determination processing (see FIG. 54) that will be described later. The CPU 3412 determines emotion values of the user 60 and the agent through the emotion determination processing. As an example, the CPU 3412 determines that the emotion value of the user 60 is “pleasant” and the emotion value of the agent is “delighted”.

In step S204J, the CPU 3412 determines lines of the agent on the basis of the acquired menu names and the determined emotion values. Specifically, the CPU 3412 determines the lines of the agent on the basis of the menu names acquired in step S202J and the emotion values determined in step S203J. As an example, the CPU 3412 determines the lines of the agent as “It seems that you had a good time today! I'll check your order details! Would you like four medium mugs of draft beer and a piece of fried chicken? For beer, there is bottled beer, and for fried chicken, there is also fried chicken wings.”. The CPU 3412 may determine the lines of the agent on the basis of only the emotion value of the user 60 or only the emotion value of the agent.

In step S205J, the CPU 3412 presents the menu names to the user 60 on the basis of the determined lines. Specifically, the CPU 3412 presents the menu names to the user 60 by outputting the lines of the agent determined in step S204J by using vocal sound from the speaker 3440. The CPU 3412 may display, on the display 3420, a menu name to be presented, an image of a menu corresponding to the menu name, a description of the menu, a quantity, and the like.

In step S206J, the CPU 3412 determines whether or not the reply of the user 60 to the presented menu names is affirmative. In a case in which it is determined that the reply of the user 60 is affirmative (step S206J: YES), the CPU 3412 proceeds to step S208J. On the other hand, in a case in which it is determined that the reply of the user 60 is not affirmative (step S206J: NO), the CPU 3412 proceeds to step S207J.

In step S207J, the CPU 3412 inputs to the sentence generation model 55 that the presented menu names are different from the intention of the user 60. Instead of step S207J, the CPU 3412 may again receive and input information regarding menu selection from the user 60 (steps S200J and S201J). The CPU 3412 returns to step S202J.

In step S208J, the CPU 3412 orders menus corresponding to the presented menu names. Specifically, the CPU 3412 transmits the menus corresponding to the menu names acquired in step S202J to an order processing apparatus (not illustrated). As an example, the CPU 3412 orders “four” “draft beer medium mugs” and “one” “fried young chicken”. The CPU 3412 ends the order placement processing.

### (Emotion Determination Processing)

FIG. 54 schematically illustrates an example of a flow of emotion determination processing according to the thirteenth embodiment. The emotion determination processing is processing executed in step S203J (see FIG. 53).

In step S300K in FIG. 54, the CPU 3412 recognizes a state of the user 60. Specifically, the CPU 3412 recognizes the state of the user 60 on the basis of the information analyzed by the sensor group 3450, the microphone 3460, and the camera 3470.

In step S301K, the CPU 3412 determines an emotion value of the user 60. Specifically, the CPU 3412 determines an emotion value indicating the emotion of the user 60 on the basis of the information analyzed by the sensor group 3450, the microphone 3460, and the camera 3470, and the state of the user 60 recognized in step S300K.

In step S302K, the CPU 3412 determines an emotion value of the agent. Specifically, the CPU 3412 determines an emotion value indicating the emotion of the agent on the basis of the information analyzed by the sensor group 3450, the microphone 3460, and the camera 3470, and the state of the user 60 recognized in step S300K. The CPU 3412 ends the emotion determination processing.

### Summary of Thirteenth Embodiment

The order terminal 3400 of the thirteenth embodiment receives information regarding menu selection from the user 60 by using vocal sound, inputs the received information to the sentence generation model 55, presents a menu name output from the sentence generation model 55 to the user 50, and orders a menu according to a reply of the user 60. Therefore, according to the order terminal 3400 of the thirteenth embodiment, it is possible to save time and effort for the user 60 to operate the order terminal 3400 for selecting a menu. According to the order terminal 3400 of the present embodiment, an order can be received even when the information regarding the menu selection received from the user 60 is not a formal name of the menu. According to the order terminal 3400 of the present embodiment, the user 60 can quickly order a target menu compared with a case in which the order terminal 3400 is operated to order the target menu from a large number of menus.

The order terminal 3400 according to the thirteenth embodiment acquires the state of the user 60, determines the emotion values of the user 60 and the agent on the basis of the acquired state of the user 60, and determines the lines of the agent on the basis of the determined emotion values. The order terminal 3400 presents the determined lines of the agent to the user 60. Therefore, according to the order terminal 3400 of the thirteenth embodiment, the agent can serve as a clerk, and the order placed by the user 60 can be checked by using lines that closely follow the emotion of the user 60.

### Modification 1 of Thirteenth Embodiment

In the thirteenth embodiment, the order placement processing is performed by receiving information regarding menu selection from the user 60. Modification 1 of the thirteenth embodiment is characterized in that the order placement processing is performed by acquiring information regarding a remaining amount of a menu ordered by the user 60. Hereinafter, contents unique to Modification 1 will be described.

The input unit 3412B (see FIG. 52) of Modification 1 has a function of inputting an emotion value to the sentence generation model 55. Specifically, the input unit 4312B inputs the emotion value of the user 60 output from the emotion engine 53 to the sentence generation model 55. The input unit 3412B may input the emotion value of the agent output from the emotion engine 53 to the sentence generation model 55.

The user state recognition unit 230 (see FIG. 2) of the action control system of Modification 1 has a function of acquiring information regarding the remaining amount of the menu ordered by the user 60. Specifically, the user state recognition unit 230 acquires information regarding the remaining amount of the menu ordered by the user 60 on the basis of the information analyzed by the sensor group 3450, the microphone 3460, and the camera 3470. The information regarding the remaining amount of the menu ordered by the user 60 is an example of “consumption information”.

The sentence generation model 55 (see FIG. 7) of the agent system 50 of Modification 1 has a function of generating a menu name corresponding to an emotion value. Specifically, the sentence generation model 55 generates a menu name corresponding to the emotion value of the user 60 input from the input unit 412B with reference to the product information database 411A (see FIG. 51).

The sentence generation model 55 (see FIG. 7) of the agent system 50 of Modification 1 has a function of generating a menu name corresponding to the remaining amount of the menu. Specifically, the sentence generation model 55 generates a menu name corresponding to the remaining amount of the menu ordered by the user 60 acquired by the user state recognition unit 230 with reference to the product information database 411A (see FIG. 51).

The interaction processing unit 51 (see FIG. 7) of the agent system 50 of Modification 1 has a function of determining a menu proposal as lines. Specifically, on the basis of the menu name generated by the sentence generation model 55 and the emotion values of the user 60 and the agent estimated by the emotion engine 53, the interaction processing unit 51 determines lines of the agent for proposing a menu to the user 60. The interaction processing unit 51 may determine the lines of the agent on the basis of only the emotion value of the user 60 or only the emotion value of the agent, estimated by the emotion engine 53.

### Order Placement Processing of Modification 1

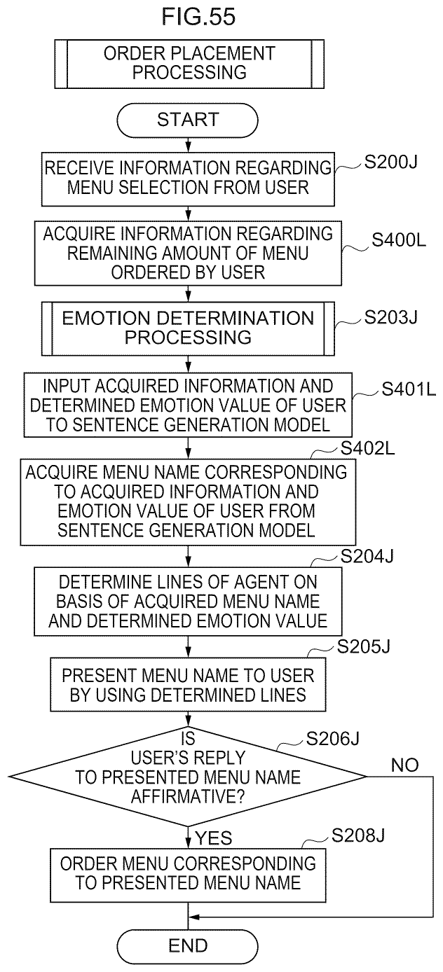

FIG. 55 schematically illustrates an example of a flow of order placement processing according to Modification 1 of the thirteenth embodiment. The order placement processing of Modification 1 is processing executed by the order terminal 3400 when the user 60 who is eating gives an order. In the order placement processing of Modification 1, the same processing as that in the order placement processing in FIG. 53 is denoted by the same reference sign, and detailed description thereof will be omitted.

In step 200J in FIG. 55, the CPU 4312 receives information regarding menu selection from the user 60. As an example, the CPU 4312 receives information such as “I want to give an additional order” from the user 60 via the microphone 3460. The CPU 3412 proceeds to step S400L.

In step S400L, the CPU 3412 acquires information regarding the remaining amount of the menu ordered by the user 60. Specifically, the CPU 3412 acquires information regarding the remaining amount of the menu that the user 60 is eating or drinking from the information analyzed by the camera 3470. As an example, the CPU3412 acquires that the remaining amount of a medium mug of draft beer that user 60 is drinking is 20% or less. The CPU 3412 may acquire the information regarding the remaining amount of the menu from information analyzed by the sensor group 3450 and the microphone 3460. The CPU 3412 proceeds to step S203J.

In step S203J, the CPU 3412 determines, for example, that the emotion value of the user 60 is “hesitating” and the emotion value of the agent is “kind”. The CPU 3412 proceeds to step S401L.

In step S401L, the CPU 3412 inputs the acquired information and the determined emotion value of the user 60 to the sentence generation model 55. Specifically, the CPU 3412 inputs the information acquired in step S400L and the emotion value of the user 60 determined in step S203J to the sentence generation model 55. As an example, the CPU 3412 inputs information such as “additional order”, “medium mug of draft beer, remaining amount 20% or less”, and “hesitating” to the sentence generation model 55.

In step S402L, the CPU 3412 acquires a menu name corresponding to the acquired information and the emotion value of the user 60 from the sentence generation model 55. Specifically, the CPU 3412 acquires the menu name generated by the sentence generation model 55 on the basis of the information received in step S200J, and the information and the emotion value input in step S401L. As an example, the CPU 3412 acquires “highball” as a menu name corresponding to “additional order”, “medium mug of draft beer, remaining amount 20% or less”, and “hesitating”. The CPU 3412 proceeds to step S204J.

In step S204J, the CPU 3412 determines lines of the agent on the basis of the menu name acquired in step S402 and the emotion value determined in step S203J. As an example, the CPU 3412 determines the lines of the agent as “Are you hesitating about what drink to order next? How about a highball?”.

In step S206J, the CPU 3412 determines whether or not a reply of the user 60 to the presented menu name is affirmative. In a case in which it is determined that the reply of the user 60 is affirmative (step S206J: YES), the CPU 3412 proceeds to step S208J. On the other hand, in a case in which it is determined that the reply of the user 60 is not affirmative (step S206J: NO), the CPU 3412 ends the order placement processing. The CPU 3412 may return to step S200J without ending the order placement processing, and may receive information regarding menu selection from the user 60.

### Summary of Modification 1 of Thirteenth Embodiment

The order terminal 3400 according to Modification 1 of the thirteenth embodiment presents a menu proposal based on the emotion value of the user 60 to the user 60 as lines of the agent. Therefore, according to the order terminal 3400 of Modification 1, it is possible to propose a menu that closely follows the emotion of the user 60.

The order terminal 3400 according to Modification 1 of the thirteenth embodiment acquires information regarding the remaining amount of the menu ordered by the user 60, and presents a menu proposal based on the acquired information to the user 60 as lines of the agent. Therefore, according to the order terminal 3400 of Modification 1, it is possible to propose an additional order to the user 60 according to the remaining amount of the menu ordered by the user 60. Information acquired by the order terminal 3400 is not limited to information regarding the remaining amount of a drink. As an example, the order terminal 3400 may acquire information regarding the remaining amount of a meal of the user 60 and make a proposal regarding the order of dessert at a timing at which the meal of the user 60 is likely to end.

### Modification 2 of Thirteenth Embodiment

In the thirteenth embodiment, information regarding menu selection is received from the user 60. Modification 2 of the thirteenth embodiment is characterized by receiving information regarding menu selection from a plurality of users 60. The users 60 of Modification 2 include users 60A and 60B. Hereinafter, contents unique to Modification 2 will be described.

The reception unit 412A (see FIG. 52) of Modification 2 has a function of simultaneously receiving information regarding menu selection from a plurality of users 60. Specifically, the reception unit 412A simultaneously receives menu selection based on pieces of vocal sound of a plurality of users 60 via the microphone 3460. The reception unit 412A distinguishes and receives an order of the user 60A and an order of the user 60B by analyzing the pieces of received vocal sound of the plurality of the users 60. The phrase “simultaneously receiving” includes a case of receiving in a state in which all or some of the pieces of vocal sound of the plurality of users 60 overlap and a case of sequentially receiving the pieces of vocal sound of the plurality of users 60. Simultaneously receiving is an example of “receiving at a time”.

The sentence generation model 55 (see FIG. 7) of the agent system 50 of Modification 3 has a function of aggregating a plurality of pieces of information regarding menu selection to generate a menu name. Specifically, the sentence generation model 55 generates a menu name corresponding to the information regarding the menu selection of the plurality of users 60 received by the reception unit 3412A with reference to the product information database 3411A (see FIG. 51). In a case in which a plurality of the same menu names exist in the generated menu names, the sentence generation model 55 leaves only one menu name, and determines the number of menu names that exist as a quantity.

### Order Placement Processing of Modification 2

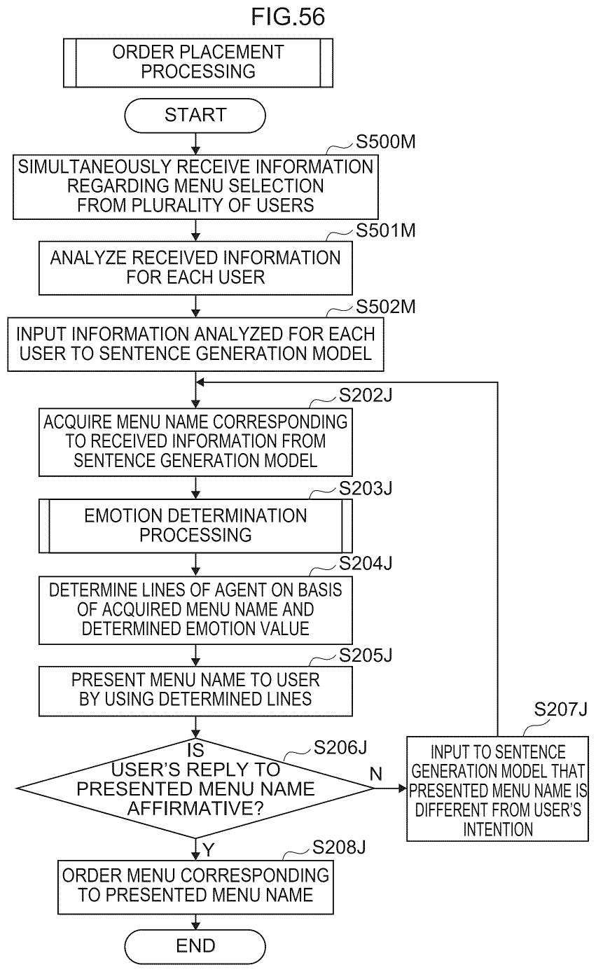

FIG. 56 schematically illustrates an example of a flow of order placement processing according to Modification 2 of the thirteenth embodiment. The order placement processing of Modification 2 is processing executed when the order terminal 3400 receives orders from a plurality of users 60. In the order placement processing of Modification 2, the same processing as that in the order placement processing in FIG. 53 is denoted by the same reference sign, and detailed description thereof will be omitted.

In step S500M in FIG. 56, the CPU 3412 simultaneously receives information regarding menu selection from the plurality of users 60. Specifically, the CPU 3412 receives information regarding menu selection from the user 60A and the user 60B by vocal sound via the microphone 3460. As an example, the CPU 3412 receives information such as “Oolong tea and a dish using ingredients produced in Hokkaido” from the user 60A and information such as “Oolong tea and a dish using seasonal ingredients” from the user 60B.

In step S501M, the CPU 3412 analyzes the received information for each user 60. Specifically, the CPU 3412 distinguishes between the information from the user 60A and the information from the user 60B, and analyzes that there are orders from the two users 60.

In step S502M, the CPU 3412 inputs information analyzed for each user 60 to the sentence generation model 55. The CPU 3412 proceeds to step S202.

In step S202J, as an example, the CPU 3412 acquires “Carpaccio of Hokkaido scallops” as the menu name corresponding to the information such as “a dish using ingredients produced in Hokkaido”, and acquires “rice cooked with bamboo shoots” as the menu name corresponding to the information regarding “a dish using seasonal ingredients”. The CPU 3412 acquires “oolong tea” and “two” as the menu name and the quantity corresponding to the information such as “oolong tea” from the user 60A and the user 60B.

In step S203J, as an example, the CPU 3412 determines that the emotion value of the user 60A is “reassuring”, the emotion value of the user 60B is “anxious”, and the emotion value of the agent is “proud”.

In step S204J, as an example, the CPU 3412 determines the lines of the agent as “We will suggest carefully selected menus, so please do not worry! How about two oolong tea, one carpaccio of scallops produced in Hokkaido, and one rice cooked with bamboo shoots?”. Hereinafter, step S205J and subsequent steps are the same as those in the thirteenth embodiment.

### Summary of Modification 2 of Thirteenth Embodiment

The order terminal 3400 according to Modification 2 of the thirteenth embodiment simultaneously receives information regarding menu selection from a plurality of users 60, inputs the received information to the sentence generation model 55, and presents the aggregated menu name and quantity output from the sentence generation model 55. Therefore, according to the order terminal 3400 of Modification 2, it is possible to finish the menu order in a short time compared with the case in which the plurality of users 60 order menus one by one.

### Modification 3 of Thirteenth Embodiment

Modification 1 of the thirteenth embodiment performs the order placement processing by acquiring the information regarding the remaining amount of the menu ordered by the user 60. Modification 3 of the thirteenth embodiment is characterized in that order placement processing is performed by acquiring information regarding configurations of a plurality of users 60. The plurality of users 60 of Modification 3 include a user 60C, a user 60D, and a user 60E. Hereinafter, contents unique to Modification 3 will be described.

The user state recognition unit 230 (see FIG. 2) of the action control system of Modification 3 has a function of acquiring information regarding the number, ages, and genders of the plurality of users 60. Specifically, the user state recognition unit 230 acquires information regarding the configurations of the plurality of users 60 on the basis of the information analyzed by the sensor group 450, the microphone 3460, and the camera 3470. Information acquired by the user state recognition unit 230 is not limited to the information regarding the number, ages, and genders of the plurality of users 60, and may be any information regarding the configuration of the plurality of users 60. The information regarding the number, the ages, and the genders of the plurality of users 60 is an example of “configuration information”.

The sentence generation model 55 (see FIG. 7) of the agent system 50 of Modification 3 has a function of generating a menu name corresponding to configurations of a plurality of users 60. Specifically, the sentence generation model 55 generates a menu name corresponding to the information regarding the configurations of the plurality of users 60 acquired by the user state recognition unit 230 with reference to the product information database 411A (see FIG. 51).

### Order Placement Processing of Modification 3

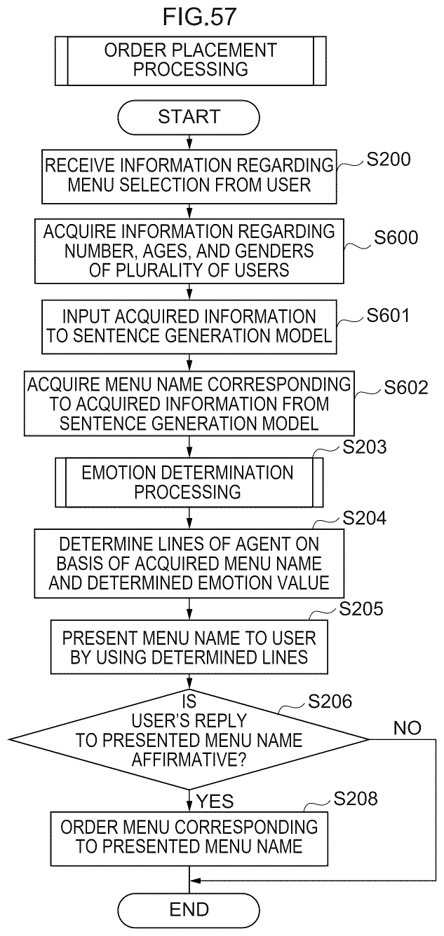

FIG. 57 schematically illustrates an example of a flow of order placement processing according to Modification 3 of the thirteenth embodiment. The order placement processing of Modification 3 is processing executed when the order terminal 3400 proposes a menu to a plurality of users 60. In the order placement processing of Modification 3, the same processing as that in the order placement processing in FIG. 53 is denoted by the same reference sign, and detailed description thereof will be omitted.

In step S200J in FIG. 57, the CPU 3412 receives information regarding menu selection from the user 60. As an example, the CPU 3412 receives information such as “What is today's recommendation?” from the user 60C via the microphone 3460. The CPU 3412 proceeds to step S600.

In step S600, the CPU 3412 acquires information regarding the number, ages, and genders of the plurality of users 60. Specifically, the CPU 3412 acquires information regarding the number, ages, and genders of the plurality of users 60 from the information analyzed by the sensor group 450, the microphone 3460, and the camera 3470. As an example, the CPU 3412 acquires information such as “1 female in 30's, 1 female around 8 years old, and 1 male around 6 years old”.

In step S601, the CPU 3412 inputs the acquired information to the sentence generation model 55. Specifically, the CPU 3412 inputs the information received in step S200 and the information acquired in step S600 to the sentence generation model 55. As an example, the CPU 3412 inputs information such as “today's recommendation” and “1 female in 30's, 1 female around 8 years old, and 1 male around 6 years old” to the sentence generation model 55.

In step S602, the CPU 3412 acquires a menu name corresponding to the acquired information from the sentence generation model 55. Specifically, the CPU 3412 acquires a menu name generated by the sentence generation model 55 on the basis of the information input in step S601. As an example, the CPU 3412 acquires “pasta lunch” and “one” and “children's lunch” and “two” as menu names and quantities corresponding to “today's recommendation” and “1 female in 30's, 1 female around 8 years old, and 1 male around 6 years old”. The CPU 3412 proceeds to step S203.

In step S203J, as an example, the CPU 3412 determines that the emotion value of the user 60C is “safe”, the emotion value of the user 60D is “pleasant”, the emotion value of the user 60E is “happy”, and the emotion value of the agent is “kind”.

In step S204J, specifically, the CPU 3412 determines lines of the agent on the basis of the menu names acquired in step S602 and the emotion values determined in step S203J. As an example, the CPU 3412 determines the lines of the agent as “Welcome! Please enjoy your meal! Today's recommendations are one pasta lunch and two children's lunches. How about this?”.

In step S206J, the CPU 3412 determines whether or not the reply of the user 60 to the presented menu name is affirmative. In a case in which it is determined that the reply of the user 60 is affirmative (step S206J: YES), the CPU 3412 proceeds to step S208. On the other hand, in a case in which it is determined that the reply of the user 60 is not affirmative (step S206J: NO), the CPU 3412 ends the order placement processing. The CPU 3412 may return to step S200J without ending the order placement processing, and may receive information regarding menu selection from the user 60.

### Summary of Modification 3 of Thirteenth Embodiment

The order terminal 3400 according to Modification 3 of the thirteenth embodiment acquires information regarding the number, ages, and genders of the plurality of users 60, and presents a menu proposal based on the acquired information to the plurality of users 60 as lines of the agent. Therefore, according to the order terminal 3400 of Modification 3, it is possible to propose a menu in a short time compared with a case in which a menu is proposed to a plurality of users 60 one by one.

### Remarks

In the thirteenth embodiment, the case in which the order terminal 3400 is installed and used at a guest seat of a restaurant has been described. However, the disclosure is not limited thereto, and the order terminal 3400 may be used in a case in which an article is purchased online shopping. The order terminal 3400 is not limited to a tablet type smart device, and includes a case in which a similar function is installed in a computer.

In the thirteenth embodiment, the order terminal 3400 receives information regarding menu selection by using vocal sound of the user 60. However, the disclosure is not limited thereto, and the order terminal 3400 may receive information regarding menu selection by using text, an image, a moving image, or the like. As an example, the order terminal 3400 can receive an image of an ingredient. Therefore, according to the order terminal 3400 of the present embodiment, even in a case in which the user 60 does not know the name of the ingredient, the order of the menu can be received.

In Modification 1 of the thirteenth embodiment, the order terminal 3400 proposes a menu based on the emotion value of the user 60. However, the disclosure is not limited thereto, and the order terminal 3400 may propose a menu based on the emotion value of the agent.

Therefore, according to the order terminal 3400 of Modification 1, the range of menu selection by the user 60 can be expanded.

In Modification 1 of the thirteenth embodiment, the order terminal 3400 proposes a menu based on the remaining amount of the menu ordered by the user 60. The order terminal 3400 may propose a menu based on a menu order history of the user 60. Therefore, according to the order terminal 3400 of Modification 1, it is possible to propose a menu according to a preference of the user 60.

In Modification 3 of the thirteenth embodiment, the order terminal 3400 proposes a menu based on information regarding the number, ages, and genders of the plurality of users 60. The order terminal 3400 may propose a menu based on information regarding menu selection of the user 60. As an example, the order terminal 3400 proposes addition or reduction of a menu in a case in which the number of menus selected with respect to the number of the plurality of users 60 is not appropriate. Therefore, according to the order terminal 3400 of Modification 3, the user 60 can select an appropriate number of menus.

In addition to the description with reference to FIGS. 8 and 9 and the like, as an example of implementation of the agent system 50, the agent system 50 can be mounted on an imaging device such as a camera. The agent system 50 mounted on the imaging device can execute processing through the above Steps 1 to 6. Specifically, the agent system 50 mounted on the imaging device acquires, for example, vocal sound output from the user 10 at the time of imaging. The vocal sound output by the user 10 includes, for example, instruction information indicating an instruction of setting at the time of imaging. The agent system 50 mounted on the imaging device inputs the acquired vocal sound including the instruction information to the sentence generation model 55, determines speech content of the agent system 50, and outputs the determined speech content. For example, it is assumed that the user 10 says “Set so that an emotional picture can be taken” to the imaging device equipped with the agent system 50. In this case, the agent system 50 determines and outputs speech content for the user 10, for example, “Is it OK to set the ISO sensitivity to 800 and the F value to 2.8? It is possible to take a picture with noise and a blurred background.” according to the acquired instruction information based on the vocal sound (speech) content of the user 10.

The agent system 50 mounted on the imaging device determines whether or not to execute a command for controlling the imaging device on the basis of Step 5 described above. For example, it is assumed that the user 10 says “No noise is needed, so please darken” in response to the speech of the agent system 50, that is, “Is it OK to set the ISO sensitivity to 800 and the F value to 2.8? It is possible to take a picture with noise and a blurred background.” in the above example. In this case, the agent system 50 mounted on the imaging device inputs speech (vocal sound) of the user 10 including the instruction information to the sentence generation model 55. The agent system 50 mounted on the imaging device checks the instruction information output from the sentence generation model 55, and receives the checked instruction of setting for the imaging device. Specifically, on the basis of the instruction information using the vocal sound of the user 10, “No noise is needed, so please darken”, the agent system 50 mounted on the imaging device executes a command for setting to darken without noise. In a case in which the reaction of the user 10 to the previous proposal is a nodding swing or an affirmative reaction, a command is executed to the imaging device so that the setting as proposed by the agent system 50 is performed. On the other hand, in a case in which the user 10 has a negative reaction to the previous proposal, for example, the proposal has been determined by using the emotion engine 53, the agent system 50 mounted on the imaging device determines the speech content so as to make another proposal to the user 10, and does not execute the command to the imaging device.

As described above, since the agent system 50 is mounted on the imaging device, even in a case in which the user 10 does not know the meaning of the numerical value necessary for setting the imaging device, the imaging setting according to the request of the user 10 is performed on the basis of the vocal sound content or the like of the user 10. For example, in the case of imaging a subject of a person, the agent system 50 mounted on the imaging device can propose a recommended setting on the basis of an emotion of the subject estimated by the emotion engine 53. The agent system 50 mounted on the imaging device can automatically perform imaging on the basis of the emotion of the subject by associating the emotion of the subject with the imaging command. For example, the command acquisition unit 56 can acquire a state of the user 10, a surrounding situation of the user, and the like, as described below with reference to the smart glasses 72. The agent system 50 mounted on the imaging device can propose an imaging timing to a subject such as the user 10 or a person according to a state of the user 10 and a surrounding situation including the user 10. For example, when the user 10 speaks the imaging timing to the imaging device in advance, in other words, inputs the imaging timing as vocal sound, the agent system 50 mounted on the imaging device can set the imaging timing on the basis of the instruction information included in the vocal sound of the user 10. As a result, the user 10 can prevent forgetting to capture an image or can capture an image at an appropriate timing.

### Fourteenth Embodiment

In a fourteenth embodiment, processing of outputting speech information to another electronic apparatus that enables communication with a computer network and acquiring response information corresponding to the speech information from the other electronic apparatus in a case in which an electronic apparatus including an agent system 50 cannot communicate with the computer network will be described. Portions having the same configurations as those of the first embodiment are denoted by the same reference numerals, and description thereof will be omitted.

The agent system 50 is a computer system that performs a series of actions according to the intention of the user 60 through an interaction performed with the user 60. The interaction with the user 60 can be performed by using vocal sound or text. The agent system 50 is mounted on an electronic apparatus. The agent system 50 can be mounted on, for example, a robot, a doll, a stuffed toy, a pendant, smart glasses, a smart watch, a smartphone, a smart speaker, an earphone, a personal computer, or the like. The agent system 50 may be implemented in a web server and used via a web browser operating on a communication terminal such as a smartphone owned by the user. Hereinafter, an example in which the agent system 50 is mounted on smartphones 122A and 122B will be described. The smartphone 122A is an example of an electronic apparatus, and the smartphone 122B is an example of another electronic apparatus. The smartphone 122A is owned by Mr. A and functions as an agent 500A which is an agent 52 for the smartphone 122A. The smartphone 122B is owned by Mr. B and functions as an agent 500B that is an agent 52 for the smartphone 122B.

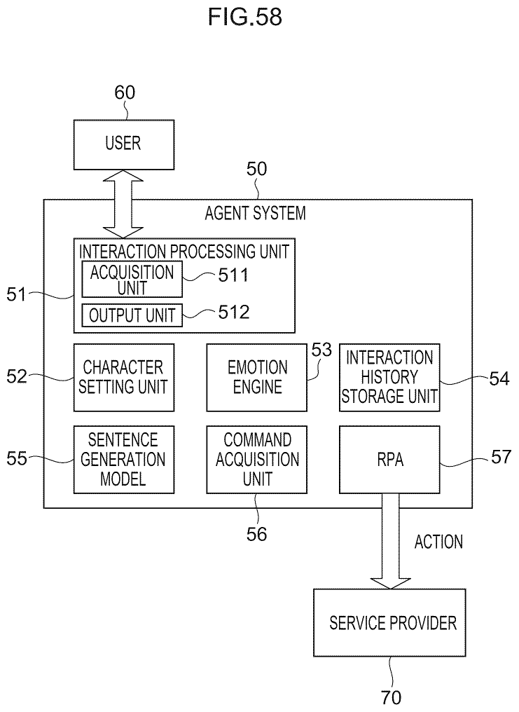

Next, a functional configuration of an agent system 50 according to the fourteenth embodiment will be described with reference to FIG. 58. As illustrated in FIG. 58, in the agent system 50 according to the fourteenth embodiment, a CPU 1212 executes a program stored in a ROM 1230 or a storage device 1224 to function as an interaction processing unit 51, a character setting unit 52, an emotion engine 53, an interaction history storage unit 54, a sentence generation model 55, a command acquisition unit 56, and a robotic process automation (RPA) 57. As illustrated in FIG. 58, the interaction processing unit 51 includes an acquisition unit 511 and an output unit 512. Hereinafter, functions of the acquisition unit 511 and the output unit 512 unique to the fourteenth embodiment will be described.

The acquisition unit 511 acquires information regarding the state of the user 60. Specifically, the acquisition unit 511 acquires vocal sound output by the user 60, text to be input, and an expression imaged by the camera.

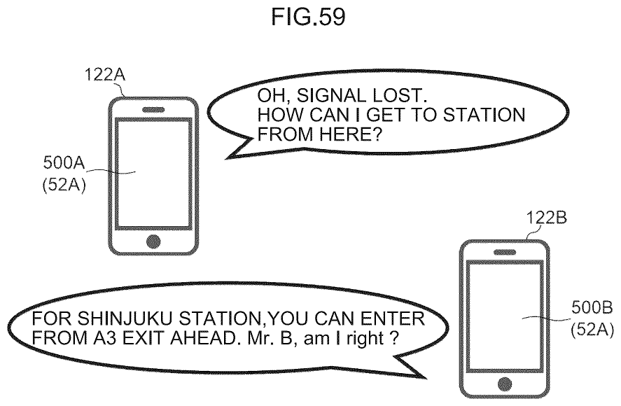

The output unit 512 outputs the speech content generated by the interaction processing unit 51 to the user 60. In a case in which communication with the computer network is disabled, the output unit 512 outputs speech information to another electronic apparatus that enables communication with the computer network. As a specific example, it is assumed that the smartphone 122A of the user 60 is temporarily unable to communicate with the computer network. In this case, when Mr. A asks the smartphone 122A how to get to the station, the output unit 512 of the smartphone 122A outputs speech information to the smartphone 122B that “Oh, signal lost. How can I get to the station from here?” as illustrated in FIG. 59. On the other hand, since communication with the computer network is not cut off in the smartphone 122B, the output unit 512 executes Internet search or the like and outputs speech information such as “For Shinjuku station, it is good to enter from A3 exit ahead, right, Mr. B.”. As a result, the agent 500B of the smartphone 122B answers the route to the station to Mr. A instead of the agent 500A of the smartphone 122A that has become unable to communicate.

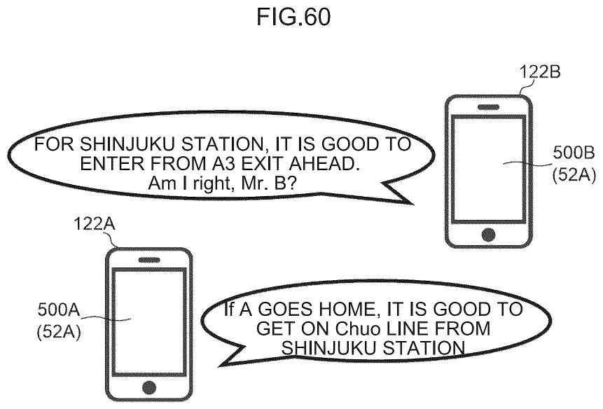

Following FIG. 59, as illustrated in FIG. 60, on the other hand, the acquisition unit 511 of the smartphone 122A acquires response information corresponding to the speech information from the smartphone 122B. Specifically, the acquisition unit 511 of the smartphone 122A acquires response information “For Shinjuku station, it is good to enter from A3 exit ahead, right, Mr. B.” from the smartphone 122B.

In addition to the response information acquired from the smartphone 122B, the output unit 512 of the smartphone 122A outputs response information updated on the basis of the history of the interaction with the user 60 stored in the smartphone 122A to the user 60. Specifically, as illustrated in FIG. 60, the output unit 512 of the smartphone 122A outputs updated response information such as “If Mr. A goes home, it is good to get on the Chuo line from Shinjuku station.” to Mr. A who is the user 60. The agent 52A of the smartphone 122A acquires the information of Mr. A from the interaction history storage unit 54.

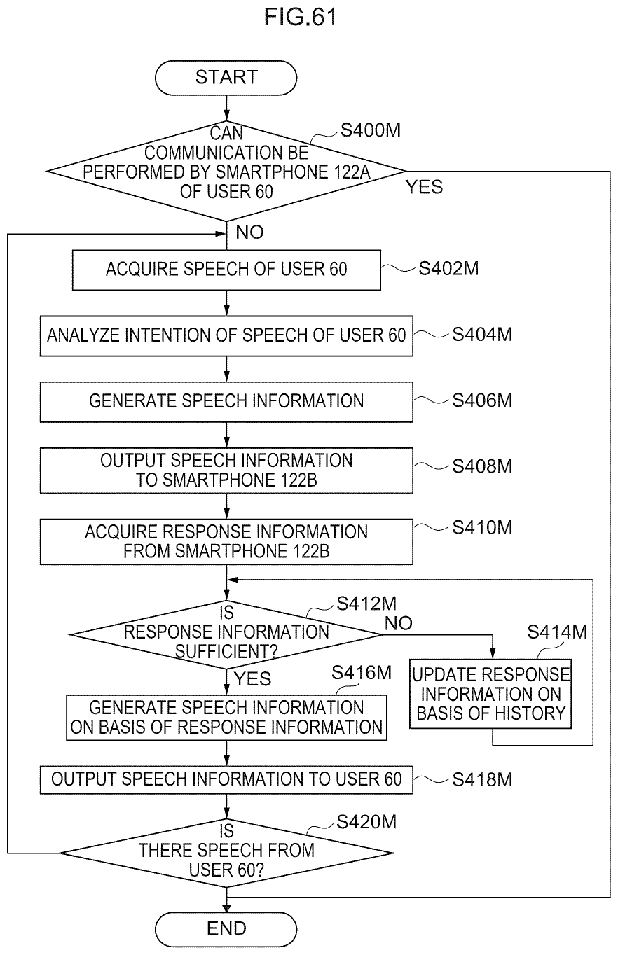

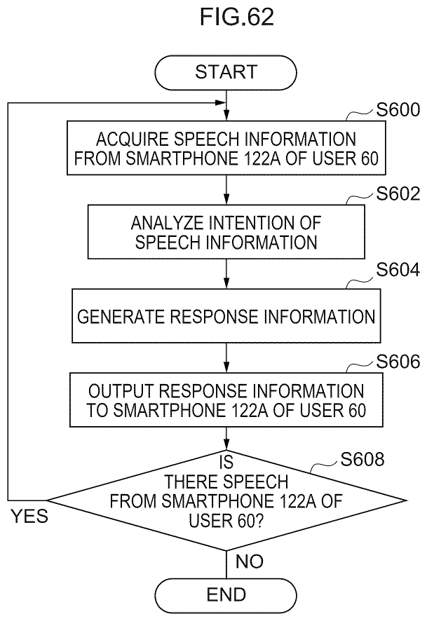

Next, an operation of the agent system 50 according to the fourteenth embodiment will be described. In the agent system 50, the interaction processing of the agent 500A of the smartphone 122A illustrated in FIG. 61 and the interaction processing of the agent 500B of the smartphone 122B illustrated in FIG. 62 are executed. Each processing in the agent system 50 is executed by the CPU 1212 functioning as the acquisition unit 511 and the output unit 512.

The interaction processing of the agent 500A of the smartphone 122A will be described with reference to FIG. 61. In step S400M, the CPU 1212 of the smartphone 122A determines whether or not communication with the computer network is possible. In a case in which it is determined that the smartphone 122A can perform communication (step S400M: YES), the CPU 1212 ends the processing. On the other hand, in a case in which it is determined that the smartphone 122A cannot perform communication (step S400M: NO), the CPU 1212 proceeds to step S402.

In step S402M, the CPU 1212 of the smartphone 122A acquires the speech of the user.

In step S404M, the CPU 1212 of the smartphone 122A analyzes the intention of the speech of the user 60.

In step S406M, the CPU 1212 of the smartphone 122A generates speech information.

In step S408M, the CPU 1212 of the smartphone 122A outputs the speech information to the smartphone 122B, which is another electronic apparatus.

In step S410M, the CPU 1212 of the smartphone 122A acquires the response information from the smartphone 122B, which is another electronic apparatus.

In step S412M, the CPU 1212 of the smartphone 122A determines whether or not the acquired response information is sufficient. In a case in which it is determined that the response information is sufficient (step S412M: YES), the CPU 1212 proceeds to step S416. On the other hand, in a case in which it is determined that the response information is not sufficient (step S412M: NO), the CPU 1212 proceeds to step S414.

In step S414M, the CPU 1212 of the smartphone 122A updates the acquired response information on the basis of the history of the interaction with the user 60 stored in the interaction history storage unit 54.

In step S416M, the CPU 1212 of the smartphone 122A generates the speech information by using the response information acquired from the smartphone 122B and the response information updated on the basis of the history of the interaction with the user 60.

In step S418M, the CPU 1212 of the smartphone 122A outputs speech information to the user 60.

In step S420M, the CPU 1212 of the smartphone 122A determines whether or not there is speech of the user 60. In a case in which it is determined that there is speech of the user 60 (step S420M: YES), the CPU 1212 returns to step S402M. On the other hand, in a case in which it is determined that there is no speech of the user 60 (step S420M: NO), the CPU 1212 ends the processing.

The interaction processing of the agent 500B of the smartphone 122B will be described with reference to FIG. 62.

In step S600, the CPU 1212 of the smartphone 122B acquires speech from the smartphone 122A of the user 60.

In step S602, the CPU 1212 of the smartphone 122B analyzes the intention of the speech information acquired from the smartphone 122A.

In step S604, the CPU 1212 of the smartphone 122B generates response information.

In step S606, the CPU 1212 of the smartphone 122B outputs the response information to the smartphone 122A of the user 60.

In step S608, the CPU 1212 of the smartphone 122B determines whether or not there is speech from the smartphone 122A of the user 60. In a case in which it is determined that there is speech (step S608: YES), the CPU 1212 returns to step S600. On the other hand, in a case in which it is determined that there is no speech (step S608: NO), the CPU 1212 ends the processing.

As described above, according to the present embodiment, the agent can be used by using the smartphone 122B instead of the smartphone 122A that has become unable to communicate. That is, even if one electronic apparatus is unable to communicate, the user 60 can obtain information. Since the agent 500A outputs, to the user 60, response information updated on the basis of the past interaction history with the user 60 with respect to the response information from the smartphone 122B, it is possible to provide information intended by the user 60.

Mr. A does not directly speak to the agent 500B, but Mr. A acquires an answer through mediation of interaction from the agent 500A to the agent 500B. In this case, as in the speech of “That's right, Mr. B” of the agent 500B, the agent 500B can request Mr. B for confirmation or agreement. That is, according to the present embodiment, it is possible to realize an interaction among four parties of Mr. A, the agent 500A, Mr. B, and the agent 500B, and there is no stress on the situation in which communication is disabled for Mr. A.

### Fifteenth Embodiment

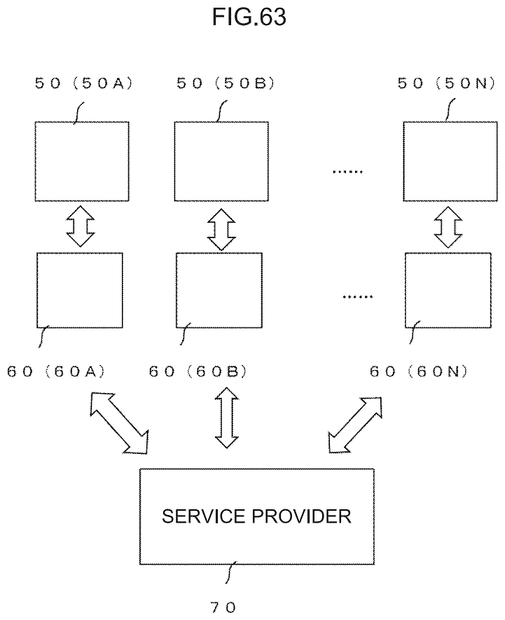

Next, a fifteenth embodiment will be described with reference to FIG. 63. FIG. 63 illustrates an aspect in which, in a case in which there are a plurality of users 60, the agent system 50 is provided for each of the plurality of users 60. In this aspect, one user 60A of the plurality of users 60 can notify his/her agent system 50A that he/she wants to know an emotion of another user 60B in a remote place, and can acquire information regarding a state of another user 60B from the agent system 50B of the another user 60B. In this case, the agent system 50B of the other user 60B acquires information regarding an emotion and a situation of the other user 60B and transmits the information to the agent system 50A. Various output units (the speaker 80, the display 76, and the like) of the agent system 50A output the emotion of the other user 50B determined by the emotion determination unit 232 of the agent system 50B as the speech content of the agent system 50A on the basis of the state of the other user 60B.

For example, in a case in which the user 60A asks a question “The first sunrise of the year viewed from Mt. Fuji must be beautiful” to the agent system 50A of the user, the agent system 50A executes data exchange with another agent system in order to search for another user 60 near Mt. Fuji. As a result of the data exchange, in a case in which another user 60B who is near Mt. Fuji is searched for, the data exchange is executed with the corresponding another agent system 50B, and information regarding the emotion and the situation of the user 60B who is in Mt. Fuji is searched for.

As a result of the search, the agent system 50A of the user 60A acquires information regarding the emotion of the user 60B via the agent system 50B of the user 60B in Mt. Fuji.

For example, the agent system 50A can obtain information such as “Of course, the first sunrise of the year viewed from Mount Fuji is unusually great!!” as the emotion of the user 60B. As a result, the user 60A can feel as if the user himself/herself is experiencing a remote place.

The agent system 50A can acquire an image (for example, images around the user 60B, such as Mt. Fuji viewed by the user 60B) around the user 60B from another agent system 50B. The agent system 50A can present the emotion information of another user as described above while showing the image data to the user 60A. As a result, the user 60A can obtain a realistic experience as if looking at a remote place with his/her own eyes.

In a case in which emotion information of a plurality of other users is acquired, information regarding an emotion having the highest occurrence frequency can be acquired and presented. For example, in a case in which a plurality of other users 60B . . . 60N who are near Mt. Fuji are searched for, if a large number of users among the other users have an emotion such as “beautiful like heaven”, information based on the emotion information can be presented. In a case in which a plurality of types of emotion information of a plurality of other users are obtained, the agent system 50A can determine an emotion corresponding to an emotion of the user determined by the emotion determination unit 232 as the emotion information most corresponding to the emotion of the user 60A, and output the emotion from the output unit such as the speaker 80 or the display 76 as the speech content of the agent. For example, in a case in which the user 60A has an emotion such as “The scenery of Mt. Fuji is beautiful” and expects a corresponding emotion, such emotion information is adopted and presented. Conversely, if the user 60A has a positive emotion toward Mt. Fuji, emotion information (for example, “there is a lot of garbage”, or “there are too many people”) of the user having a negative emotion toward Mt. Fuji is not adopted.

The agent system 50 described above can be applied to the smart glasses 72 described in FIG. 11 and the like.

### Others

The disclosure is not limited to the above-described embodiments, and includes various modifications. For example, the above-described embodiments have been described in detail for easy understanding of the disclosure, and are not necessarily limited to those having all the described configurations. A part of the configuration of a certain embodiment can be replaced with the configuration of another embodiment, and the configuration of another embodiment can be added to the configuration of a certain embodiment. It is possible to add, delete, and replace other configurations for a part of the configuration of each embodiment.

### REFERENCE

The disclosures of the patent applications listed below are incorporated herein by reference.
Japanese Patent Application No. 2023-073806 (filing date: Apr. 27, 2023)
Japanese Patent Application No. 2023-136435 (filing date: Aug. 24, 2023)
Japanese Patent Application No. 2023-152212 (filing date: Sep. 20, 2023)
Japanese Patent Application No. 2023-165251 (filing date: Sep. 27, 2023)
Japanese Patent Application No. 2023-174709 (filing date: Oct. 6, 2023)
Japanese Patent Application No. 2023-176974 (filing date: Oct. 12, 2023)
Japanese Patent Application No. 2023-177748 (filing date: Oct. 13, 2023)
Japanese Patent Application No. 2023-184939 (filing date: Oct. 27, 2023)
Japanese Patent Application No. 2023-185845 (filing date: Oct. 30, 2023)
Japanese Patent Application No. 2023-185846 (filing date: Oct. 30, 2023)
Japanese Patent Application No. 2023-193182 (filing date: Nov. 13, 2023)
Japanese Patent Application No. 2023-195488 (filing date: Nov. 16, 2023)
Japanese Patent Application No. 2023-214129 (filing date: Dec. 19, 2023)
Japanese Patent Application No. 2023-223427 (filing date: Dec. 28, 2023)

1. An agent system comprising:
a reception unit that receives a budget of settlement means available for obtaining a product;
a history acquisition unit that acquires history information that is information regarding an acquisition history in which a product acquired by a user in the past is recorded;
a product determination unit that determines a product to be acquired on the basis of the budget received by the reception unit and the history information obtained from the history acquisition unit; and
an operation execution unit that executes an operation of acquiring the product determined by the product determination unit at a predetermined timing.

2. The agent system according to claim 1, further comprising:
a user state recognition unit capable of acquiring information regarding a state of the user; and
an emotion determination unit that determines an emotion of the user on the basis of the information regarding the state of the user acquired by the user state recognition unit, wherein
the history information includes an acquisition history in which a product acquired by the operation execution unit and an emotion of the user determined by the emotion determination unit for the product are recorded in association with each other.

3. The agent system according to claim 2, wherein
the emotion determination unit further determines an emotion of an agent on the basis of the state of the user acquired via the user state recognition unit, and
the product determination unit determines a product to be acquired on the basis of the emotion of the agent determined by the emotion determination unit.

4. The agent system according to claim 2, wherein
the user state recognition unit further acquires information regarding a surrounding situation of the user, and
the product determination unit determines a product to be acquired on the basis of the surrounding situation acquired by the user state recognition unit.

5. The agent system according to claim 4, wherein
the information regarding the surrounding situation is information regarding a stock for each product estimated from image information indicating the surrounding situation of the user, and
the product determination unit determines a product to be acquired on the basis of the information regarding the stock.

6. The agent system according to claim 5, wherein
the operation execution unit executes an operation of acquiring the product
at a timing at which the stock falls below a predetermined threshold continuously for a predetermined period.

7. The agent system according to claim 2, wherein the reception unit further receives setting information of at least one of information regarding a category of a product or information regarding a preference of the user, and
the product determination unit determines a product to be acquired on the basis of the setting information received by the reception unit.

8-90. (canceled)

91. A storage medium storing a program for causing a computer to operate as a agent system, the agent system including:
a reception unit that receives a budget of settlement means available for obtaining a product;
a history acquisition unit that acquires history information that is information regarding an acquisition history in which a product acquired by a user in the past is recorded;
a product determination unit that determines a product to be acquired on the basis of the budget received by the reception unit and the history information obtained from the history acquisition unit; and
an operation execution unit that executes an operation of acquiring the product determined by the product determination unit at a predetermined timing.

92. The storage medium according to claim 91, the agent system further comprising:
a user state recognition unit capable of acquiring information regarding a state of the user; and
an emotion determination unit that determines an emotion of the user on the basis of the information regarding the state of the user acquired by the user state recognition unit, wherein
the history information includes an acquisition history in which a product acquired by the operation execution unit and an emotion of the user determined by the emotion determination unit for the product are recorded in association with each other.

93. The storage medium according to claim 92, wherein
the emotion determination unit further determines an emotion of an agent on the basis of the state of the user acquired via the user state recognition unit, and
the product determination unit determines a product to be acquired on the basis of the emotion of the agent determined by the emotion determination unit.

94. The storage medium according to claim 92, wherein
the user state recognition unit further acquires information regarding a surrounding situation of the user, and
the product determination unit determines a product to be acquired on the basis of the surrounding situation acquired by the user state recognition unit.

95. The storage medium according to claim 94, wherein
the information regarding the surrounding situation is information regarding a stock for each product estimated from image information indicating the surrounding situation of the user, and
the product determination unit determines a product to be acquired on the basis of the information regarding the stock.

96. The storage medium according to claim 95, wherein
the operation execution unit executes an operation of acquiring the product
at a timing at which the stock falls below a predetermined threshold continuously for a predetermined period.

97. The storage medium according to claim 92, wherein the reception unit further receives setting information of at least one of information regarding a category of a product or information regarding a preference of the user, and
the product determination unit determines a product to be acquired on the basis of the setting information received by the reception unit.
